(19) United States
(12) Patent Application Publication
(10) Pub. No.: US 2022/0402100 A1
(43) Pub. Date: Dec. 22, 2022

(54) BAR CLAMP SYSTEM

(71) Applicant: Kreg Enterprises, Inc., Ankeny, IA (US)

(72) Inventors: Andrew Lyons, Grimes, IA (US); Kyong Choi, Ames, IA (US)

(21) Appl. No.: 17/839,890

(22) Filed: Jun. 14, 2022

Related U.S. Application Data
(60) Provisional application No. 63/212,466, filed on Jun. 18, 2021.

(51) Int. Cl. B25B 5/06

(52) U.S. Cl. CPC B25B 5/068

(57) ABSTRACT

In one or more arrangements, a bar clamp system is presented. The system includes an elongated bar, an end stop assembly operably connected to and moveable along the elongated bar, and a handle assembly operably connected to and moveable along the elongated bar. The end stop assembly includes an actuator, a first locking mechanism, and a second locking mechanism. The handle assembly includes a clamp actuator, a release actuator, and a clamp mechanism operably connected to the clamp actuator and the release actuator. In one or more arrangements, the end stop assembly and handle assembly each have a clamp plate having a clamping surface. To facilitate clamping, the end stop assembly and handle assembly can be repositioned on the elongated bar with the clamping surfaces facing toward each other. To facilitate spreading, the clamping surfaces can be positioned facing away from each other.

### CROSS REFERENCE TO RELATED APPLICATION

This application claims the benefit of U.S. Provisional Application No. 63/212,466 titled “BAR CLAMP SYSTEM” and filed on Jun. 18, 2021, the entire contents of which is hereby fully incorporated by reference herein.

### FIELD OF THE DISCLOSURE

This disclosure relates generally to clamps. More specifically and without limitation, this disclosure relates to a clamp system that has a number of features that provides new and unique functionality.

### OVERVIEW

Clamps are well known in the art. There are many forms of clamps that are used to hold a workpiece in a stationary position so that an operation may be performed on the workpiece. One well-known clamp design is known as a C-clamp. C-clamps include an upper arm and a lower arm that are connected to an operating mechanism, such as a handle that is used to tighten the upper arm and the lower arm against one another. In use, the upper arm is placed on an upper surface of the workpiece and the lower arm is placed on the lower surface of a benchtop, work bench or support surface that supports the workpiece (hereinafter “support surface”). Once in place, the operating mechanism is used to tighten the upper arm against the lower arm thereby holding the workpiece in a stationary position on the support surface.

While C-clamps are effective, they suffer from many disadvantages. One such disadvantage is that the conventional C-clamps have a limited reach which restricts their use to be near the edge of a support surface. As such, C-clamps cannot be used for many applications. Another disadvantage is that C-clamps are relatively difficult and time consuming to operate. As such, C-clamps are undesirable in many applications and for many users. Another disadvantage to C-clamps is that the upper arm covers a portion of the surface of the workpiece when the workpiece is clamped in place. This prevents certain operations such as sanding the entire upper surface of the workpiece. As such, C-clamps suffer from many disadvantages and are not suitable in many applications.

Another well-known clamp design is known as a bar clamp. Bar clamps, like C-clamps, include an upper arm and a lower arm that are connected to an operating mechanism, such as a handle, that is used to tighten the upper arm and the lower arm against one another. Unlike C-clamps, bar clamps include an elongated bar that allows for increased travel between the upper arm and the lower arm. The elongated bar allows the bar clamp to clamp longer items.

While bar clamps facilitate clamping longer items, bar clamps suffer from some disadvantages. As one example, because upper and lower arms are configured to be movable, the amount of clamping force that may be applied before clamp arms slip and move along the bar may be limited. Some bar clamps may include a lock screw that may be tightened to secure clamp arms in place and prevent slipping when clamping with large clamping forces. However, setting and unsetting lock screws can be time consuming when a bar clamp is used for clamping workpieces of different sizes during a project. As such, bar clamps suffer from many disadvantages and are not suitable in many applications.

Therefore, for all the reasons stated above, and the reasons stated below, there is a need in the art for a bar clamp system that improves upon the state of the art.

Another object of the disclosure is to provide a bar clamp system that provides improved functionality over prior art clamps.

Yet another object of the disclosure is to provide a bar clamp system that is easy to use. Another object of the disclosure is to provide a bar clamp system that is intuitive to use. Yet another object of the disclosure is to provide a bar clamp system that is strong and robust.

Another object of the disclosure is to provide a bar clamp system that can be used in many applications.

Yet another object of the disclosure is to provide a bar clamp system that provides unique functionality.

Another object of the disclosure is to provide a bar clamp system that can be used as a spreader.

Yet another object of the disclosure is to provide a bar clamp system that provides easy positioning of end stop and handle assemblies.

Another object of the disclosure is to provide a bar clamp system that is safe to use.

Yet another object of the disclosure is to provide a bar clamp system that is fast to use.

Another object of the disclosure is to provide a bar clamp system that has a long useful life.

Yet another object of the disclosure is to provide a bar clamp system that is high quality.

Another object of the disclosure is to provide a bar clamp system that is relatively inexpensive.

Yet another object of the disclosure is to provide a bar clamp system that improves efficiencies.

Another object of the disclosure is to provide a bar clamp system that is fun to use.

Yet another object of the disclosure is to provide a bar clamp system that provides improved features over prior art clamps.

These and other objects, features, or advantages of the disclosure will become apparent from the specification, figures, and claims.

### BRIEF DESCRIPTION OF THE DRAWINGS

FIG. 1 is a perspective view of a bar clamp system; the view showing an end stop assembly positioned on an elongated arm and a handle assembly positioned on the elongated arm; wherein clamping pads located on the handle assembly and the end stop assembly are positioned to be facing each other; the view showing the handle assembly having a handle, a clamp actuator, and a clamp arm.

FIG. 2 is an elevation view of a bar clamp system of FIG. 1; the view showing an end stop assembly positioned on an elongated arm and a handle assembly positioned on the elongated arm; wherein clamping pads located on the handle assembly and the end stop assembly are positioned to be facing each other; the view showing the handle assembly having a handle, a clamp actuator, and a clamp arm.

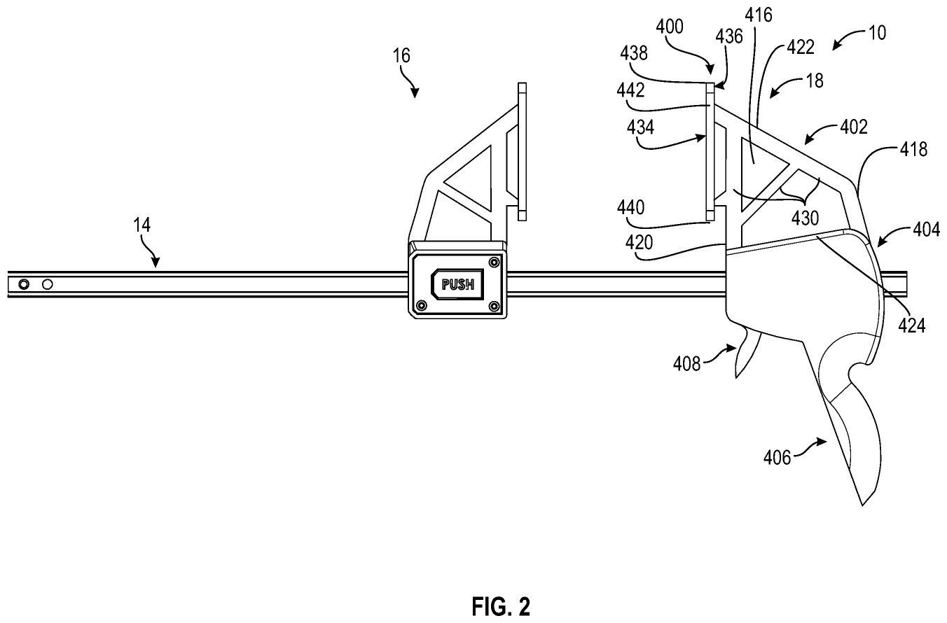

FIG. 3 is an elevation view of the side of an end stop assembly; the view showing the end stop assembly having a main body, the main body having an actuator and a clamp arm; the view showing the clamp arm having a clamping surface.

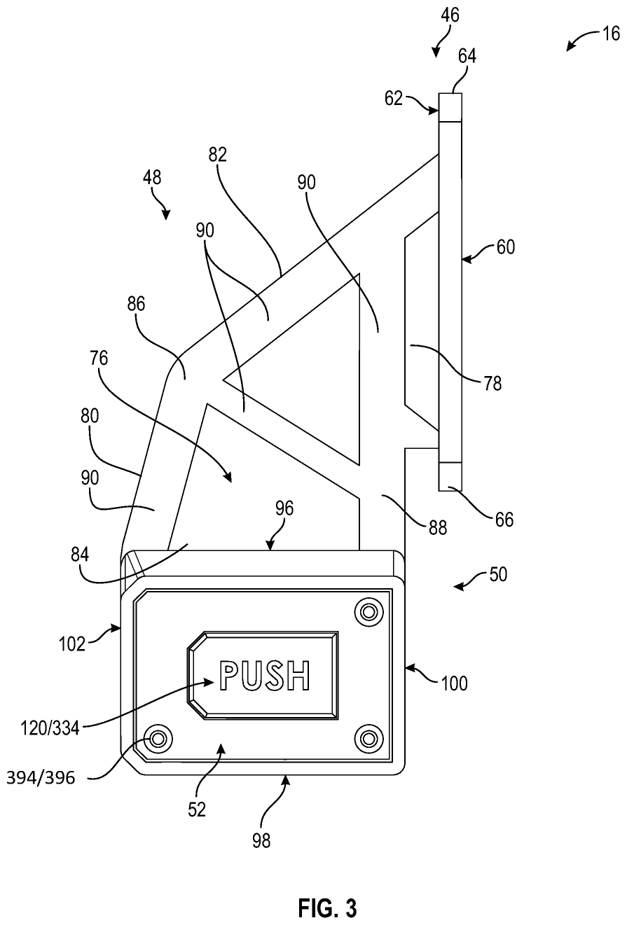

FIG. 4 is an elevation view of an alternative side of an end stop assembly of FIG. 3; the view showing a main body, a clamp arm, and a clamp plate.

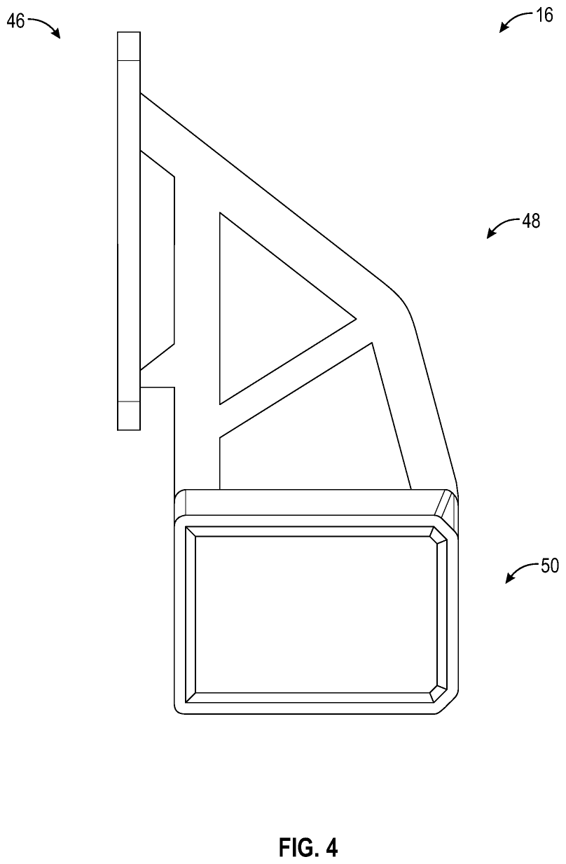

FIG. 5 is a perspective view of an end stop assembly of FIG. 3; the view showing the end stop assembly having a main body, a clamp arm, and a clamp plate; the main body having an actuator and an opening for an elongated bar to pass through; the clamp plate having a clamping surface.

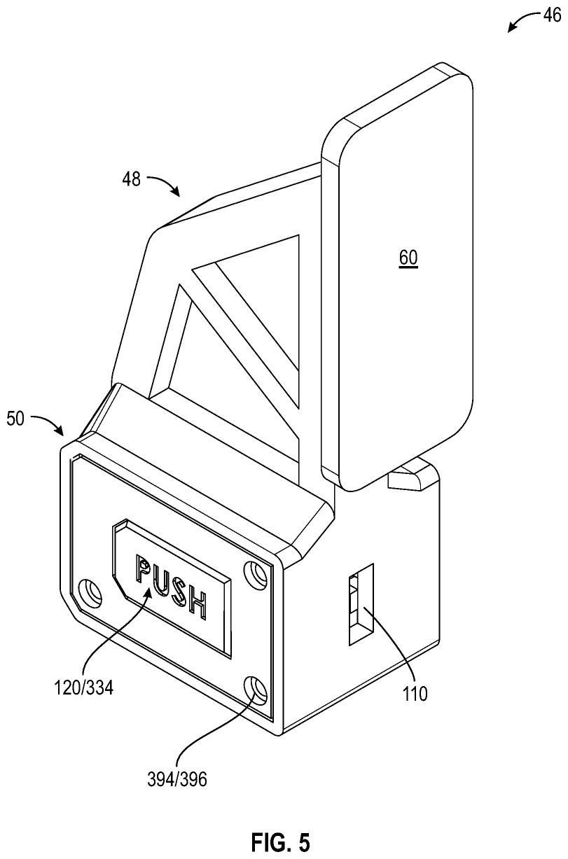

FIG. 6 is a perspective view of an end stop assembly of FIG. 3; the view showing the end stop assembly having a main body, a clamp arm, and a clamp plate; the main body having an actuator and an opening for an elongated bar to pass through; the clamp plate having a clamping surface.

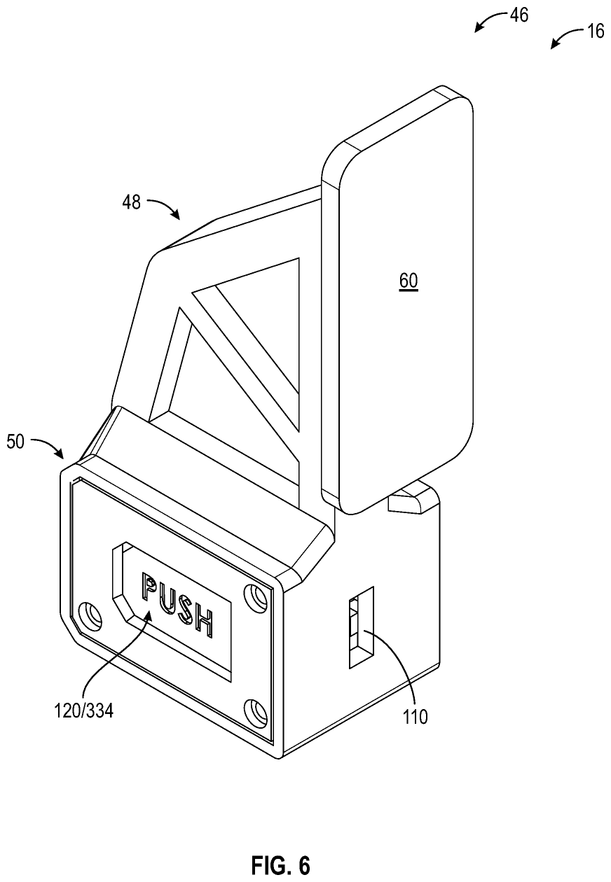

FIG. 7 is an alternative perspective view of the end stop assembly of FIG. 3, the view showing the end stop assembly having a main body, a clamp arm, and a clamp plate; the main body having an actuator and an opening for an elongated bar to pass through.

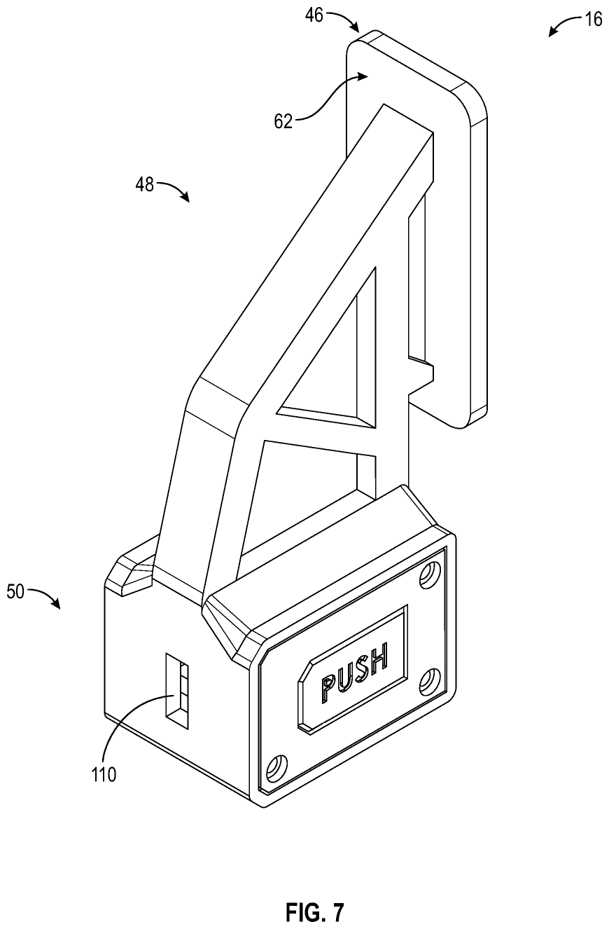

FIG. 8 is an additional perspective view of the end stop assembly shown in FIG. 3.

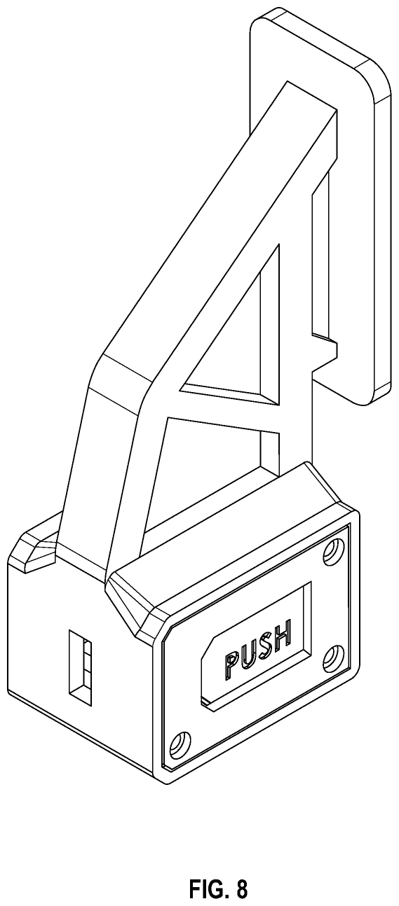

FIG. 9 is an alternative perspective view of the end stop assembly of FIG. 3; the view showing a main body, a clamp arm, and a clamp plate.

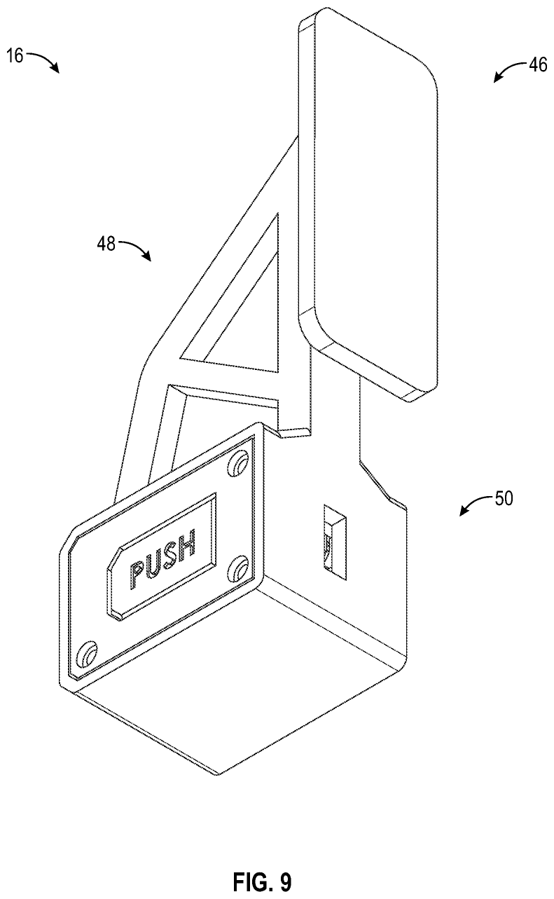

FIG. 10 is an additional, alternative perspective view of the end stop assembly of FIG. 3; the view showing a main body, a clamp arm, and a clamp plate.

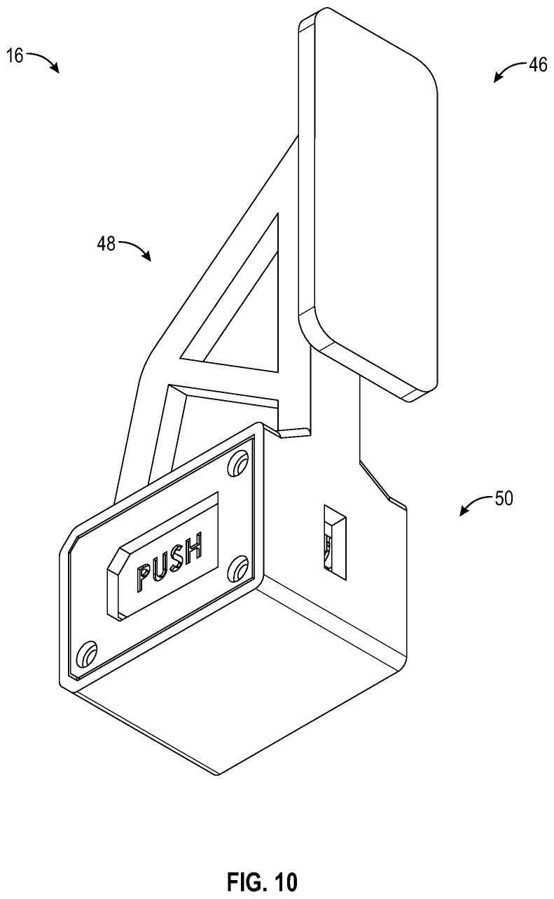

FIG. 11 is an alternative perspective view of the end stop assembly of FIG. 3; the view showing a main body, a clamp arm, and a clamp plate.

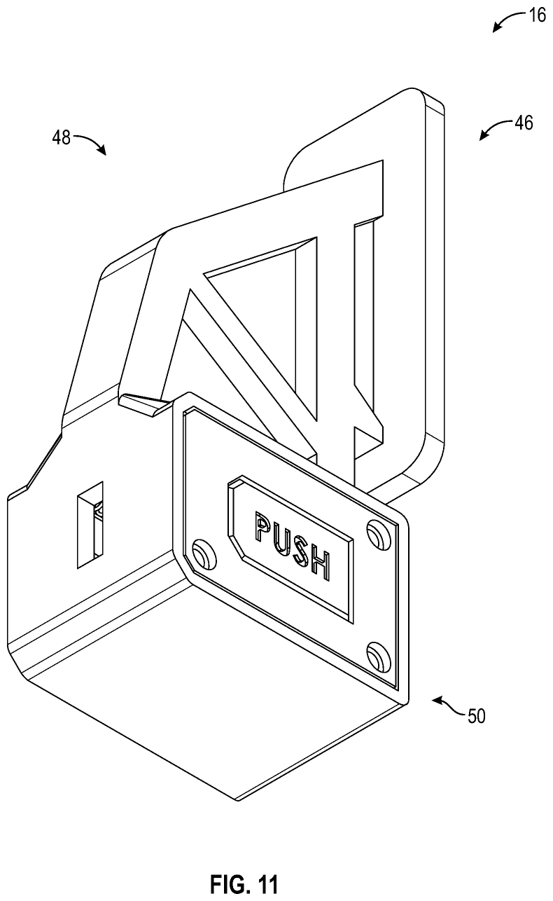

FIG. 12 is an additional, alternative perspective view of the end stop assembly of FIG. 3; the view showing a main body, a clamp arm, and a clamp plate.

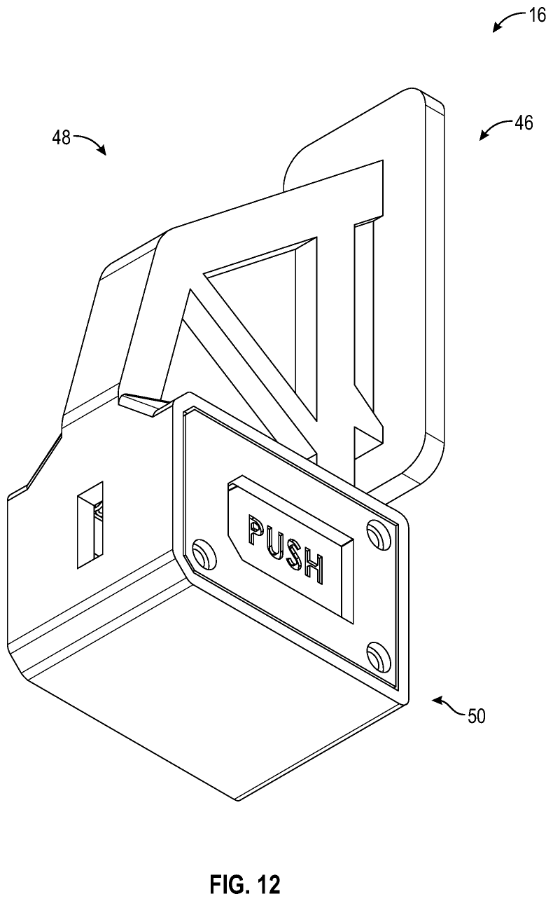

FIG. 13 is an alternative perspective view of the end stop assembly of FIG. 3; the view showing a main body, a clamp arm, and a clamp plate.

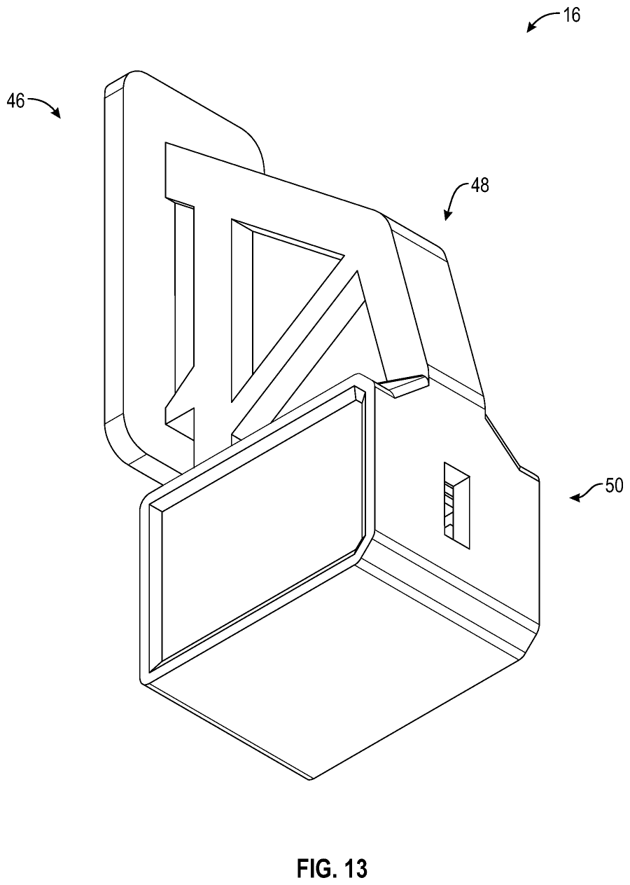

FIG. 14 is an alternative perspective view of the end stop assembly of FIG. 3; the view showing a main body, a clamp arm, and a clamp plate.

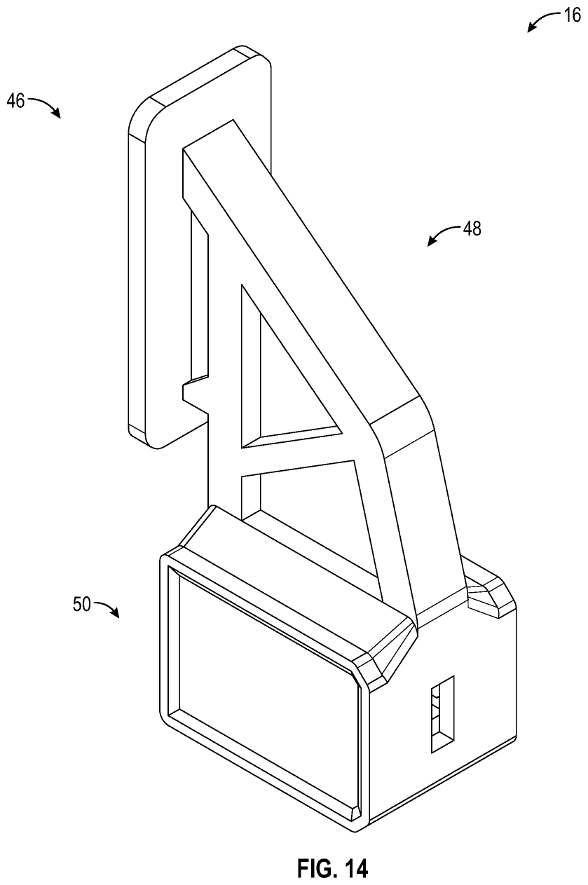

FIG. 15 is an alternative perspective view of the end stop assembly of FIG. 3; the view showing a main body, a clamp arm, and a clamp plate.

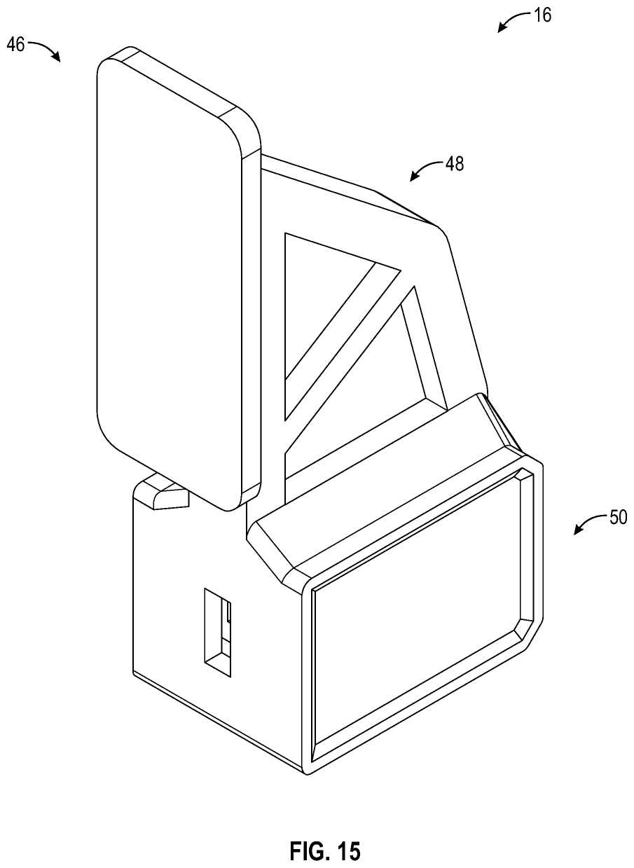

FIG. 16 is an alternative perspective view of the end stop assembly of FIG. 3; the view showing a main body, a clamp arm, and a clamp plate.

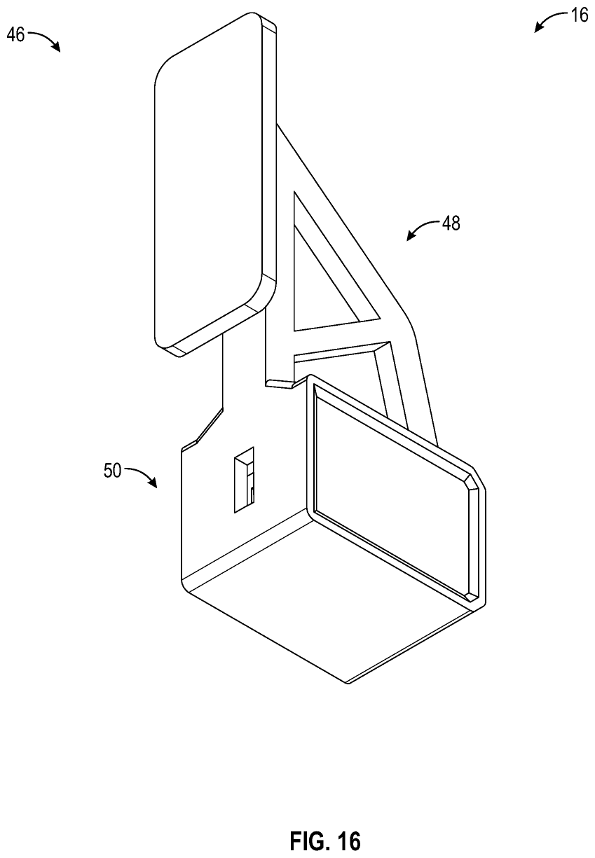

FIG. 17 is a front elevation view of the end stop assembly of FIG. 3; the view showing a main body and a clamping surface; wherein the clamping surface is a clamp plate and wherein the main body has an opening to facilitate the insertion of an elongated bar.

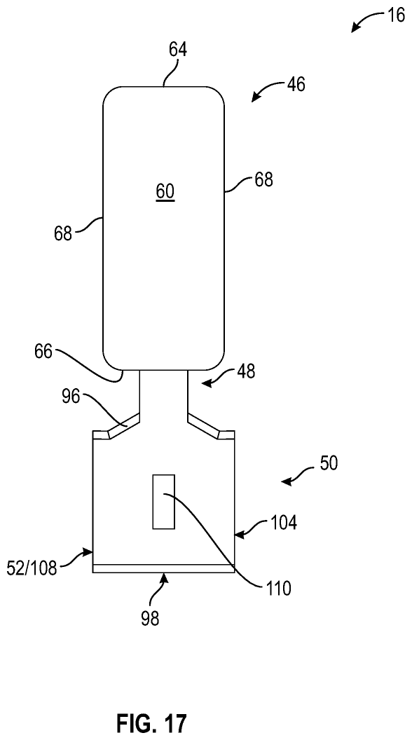

FIG. 18 is a back elevation view of the end stop assembly of FIG. 3; the view showing a main body and a clamp arm; wherein the main body has an opening to facilitate the insertion of an elongated bar.

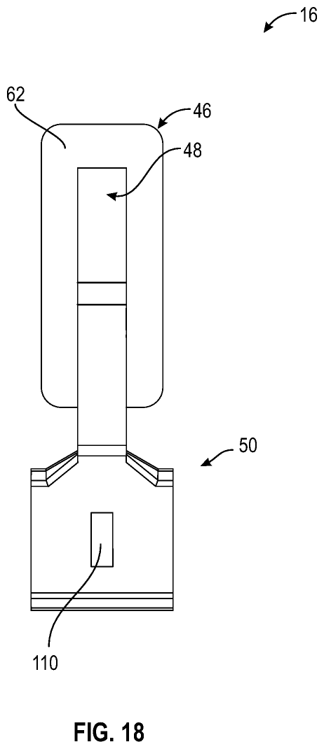

FIG. 19 is an exploded view of the end stop assembly of FIG. 3; the view showing the end stop assembly having a main body, a clamp arm and a clamp plate; the main body having a hollow interior; the hollow interior housing a locking assembly; the locking assembly having an actuator, a first locking mechanism, a second locking mechanism, and a lock pin 18.

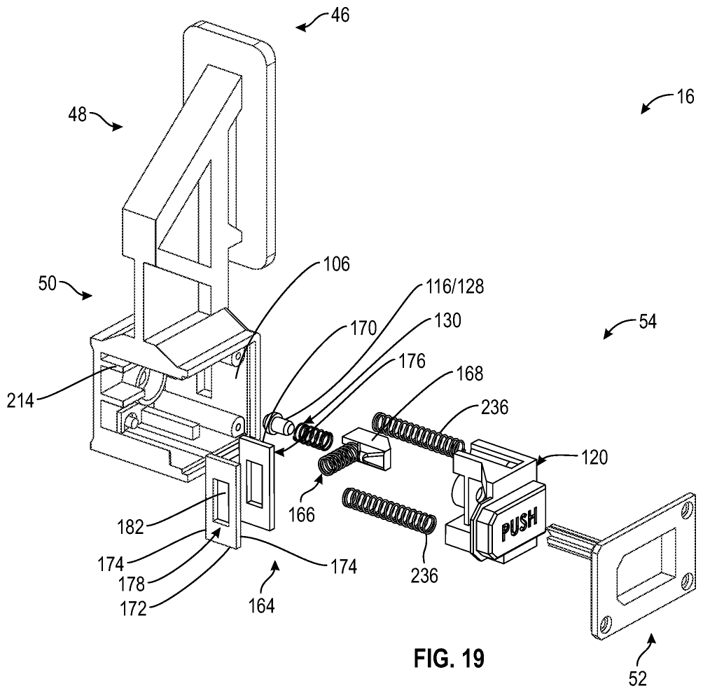

FIG. 20 is a cut away view of the end stop assembly of FIG. 3; the view showing the end stop assembly having a main body, a clamp arm, and a clamp plate; the view showing the main body having a locking assembly.

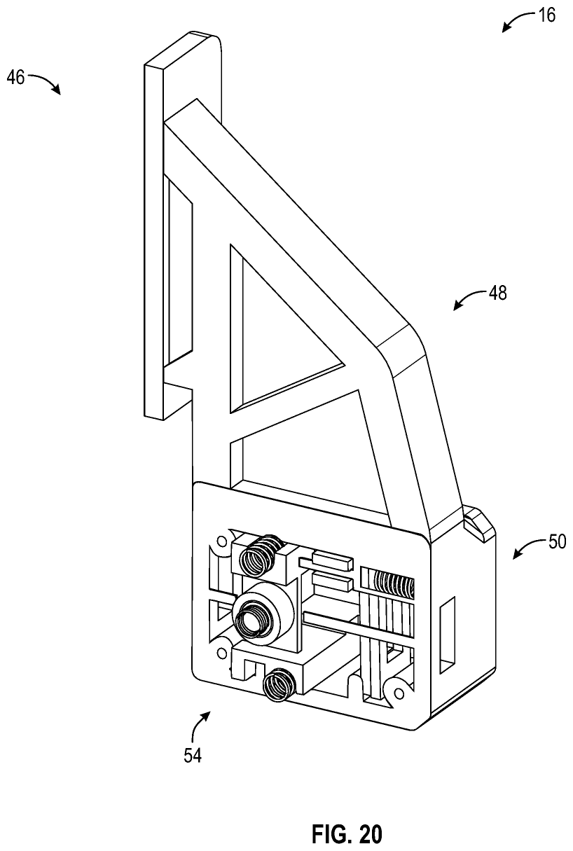

FIG. 21. is an exploded view of the end stop assembly of FIG. 3; the view showing the end stop assembly having a main body, a clamp arm, and a clamp plate; the main body of the end stop assembly having a cover, a locking assembly, and clutch plates.

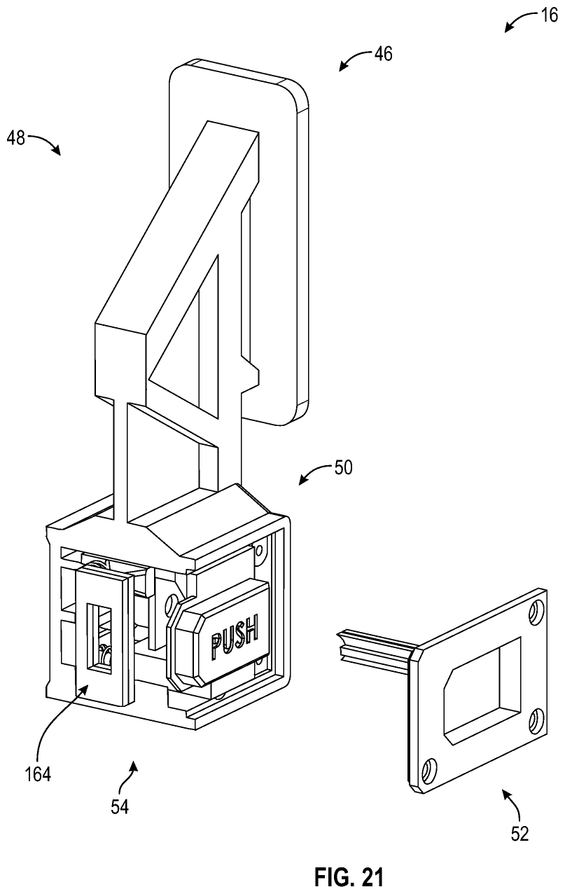

FIG. 22 is a cut away view of the end stop assembly of FIG. 3; the view showing the end stop assembly having a main body and a clamp arm; the main body having a locking assembly.

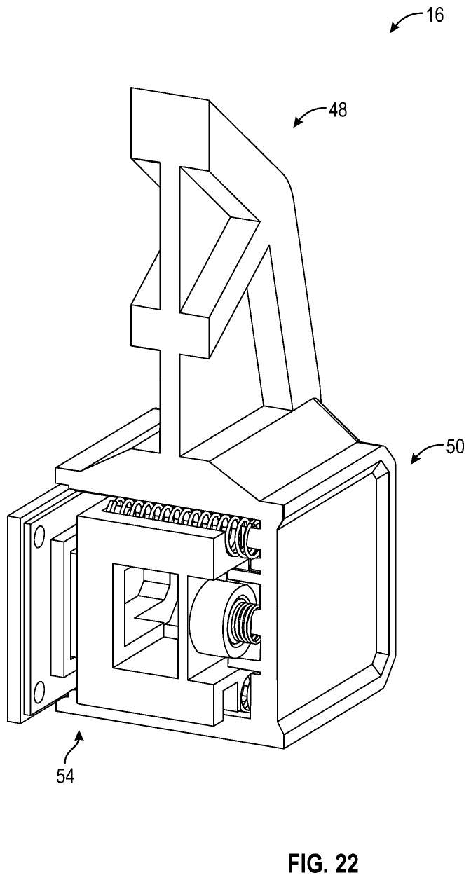

FIG. 23 is an elevation view of a bar clamp system having only an end stop assembly installed; the view showing a cut away view of the end stop assembly and an elongated bar inserted through openings of the end stop assembly.

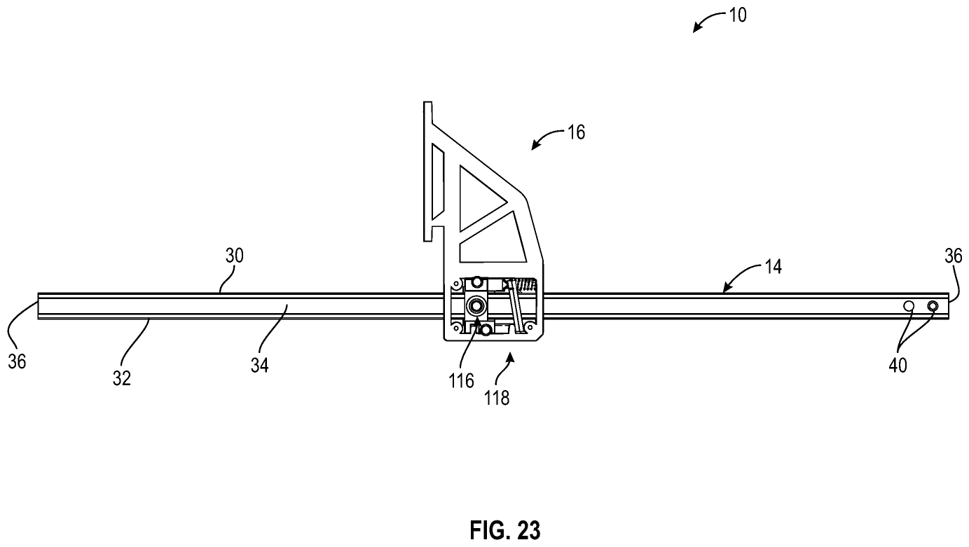

FIG. 24 is an additional elevation view of a bar clamp system having only an end stop assembly installed; the view showing a cut away view of the end stop assembly and an elongated bar inserted through openings of the end stop assembly.

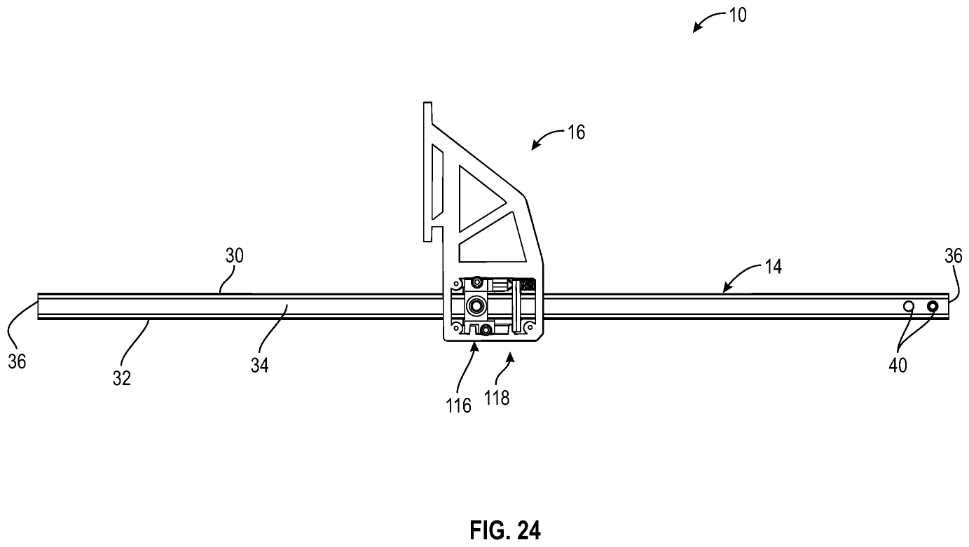

FIG. 25 is an elevation view of an end stop assembly and an elongated bar; the view showing the end stop assembly having a main body, a clamp arm, and a clamp plate; the view showing the main body having an actuator; the view showing the elongated bar inserted through the main body of the end stop assembly.

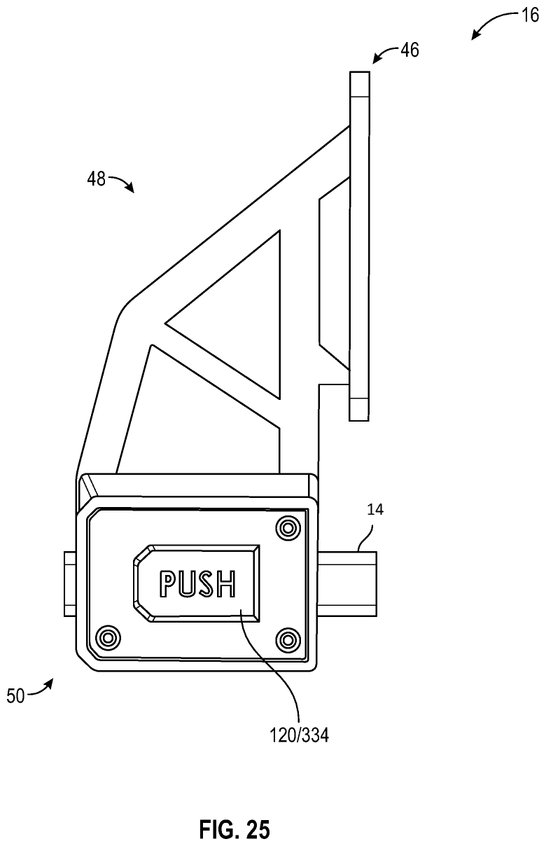

FIG. 26 is an alternative elevation view of an end stop assembly and an elongated bar; the view showing the end stop assembly having a main body, a clamp arm, and a clamp plate; the view showing the elongated bar inserted through the main body of the end stop assembly.

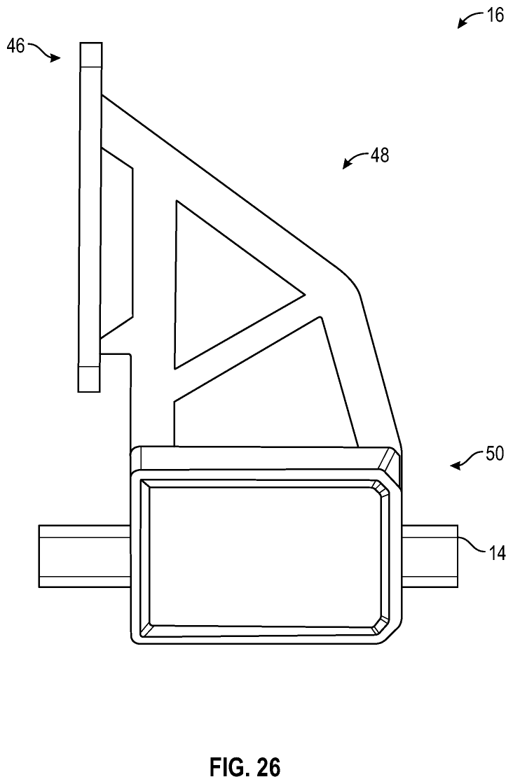

FIG. 27 is a back elevation view of an end stop assembly; the view showing a main body, a clamp arm, and a clamp plate with an elongated bar inserted though the main body of the end stop assembly.

FIG. 28 is a front elevation view of an end stop assembly; the view showing a main body and a clamp plate with an elongated bar inserted though the main body of the end stop assembly.

FIG. 29 is a perspective view of an end stop assembly; the view showing the end stop assembly having a main body, a clamp arm, and a clamp plate; wherein an elongated bar is inserted through the main body of the end stop assembly and the main body also comprises an actuator.

FIG. 30 is an exploded view of an end stop assembly; the view showing the end stop assembly having a main body, a clamp arm, and a clamp plate; wherein the main body houses an actuator.

FIG. 31 is a transparent view of an end stop assembly; the view showing the orientation of the locking assembly and actuator within a hollow interior of a main body of the end stop assembly.

FIG. 32 is an additional transparent view of an end stop assembly; the view showing the orientation of the locking assembly and actuator within a hollow interior of a main body of the end stop assembly.

FIG. 33 is an alternate transparent view of an end stop assembly; the view showing the orientation of the locking assembly and actuator within a hollow interior of a main body of the end stop assembly.

FIG. 34 is a cut away view of a main body of an end stop assembly; the view showing an elongated bar inserted through the hollow interior of the main body.

FIG. 35 is a perspective view of a main body of an end stop assembly; the view showing the orientation of the locking assembly, elongated bar, and actuator within a hollow interior of the main body.

FIG. 36 shows a perspective view of a lock pin of a first locking mechanism of a locking assembly; the view showing the locking pin having a connection feature proximate one side and a tapered narrow portion proximate the opposite side.

FIG. 37 shows a perspective view of a lock pin of a first locking mechanism of a locking assembly; the view showing the locking pin having a connection feature proximate one side and a tapered narrow portion proximate the opposite side.

FIG. 38 shows an elevation view of a lock pin of a first locking mechanism of a locking assembly; the view showing the locking pin having a connection feature proximate one side and a tapered narrow portion proximate the opposite side.

FIG. 39 shows an elevation view of a lock pin of a first locking mechanism of a locking assembly; the view showing the locking pin having a connection feature proximate one side.

FIG. 40 shows a perspective view of a lock pin of a first locking mechanism of a locking assembly; the view showing the locking pin having a tapered narrow portion proximate the one side.

FIG. 41 shows a perspective view of a clutch plate of a locking mechanism; the view showing the clutch plate having an opening.

FIG. 42 shows a back elevation view of a clutch plate of a locking mechanism; the view showing the clutch plate having an opening.

FIG. 43 shows a front elevation view of a clutch plate of a locking mechanism; the view showing the clutch plate having an opening.

FIG. 44 shows a side elevation view of a clutch plate of a locking mechanism.

FIG. 45 shows a top elevation view of a clutch plate of a locking mechanism.

FIG. 46 shows a perspective view of a clutch plate positioning member; the view showing the clutch plate positioning member having a contract protrusion and a recessed track.

FIG. 47 shows an alternate perspective view of a clutch plate positioning member.

FIG. 48 shows a top elevation view of a clutch plate positioning member; the view showing the clutch plate positioning member having a contract protrusion.

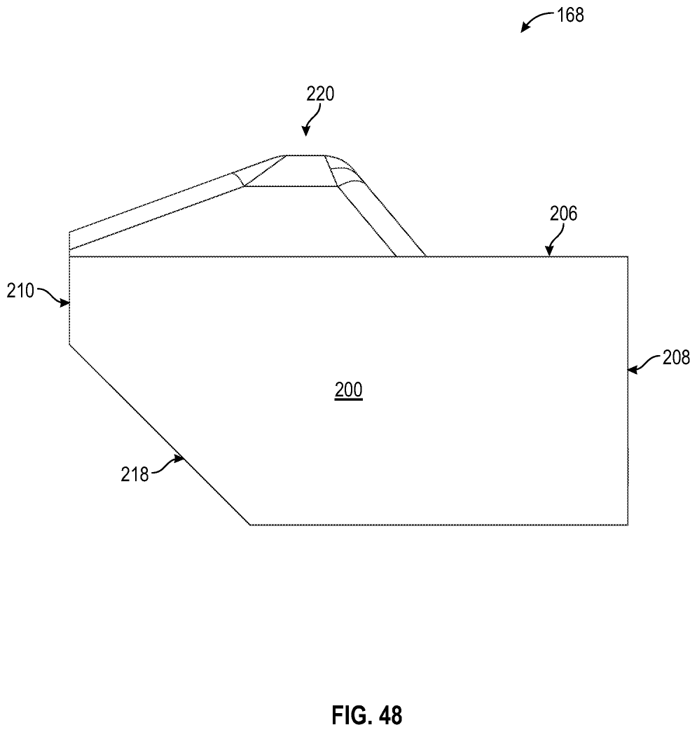

FIG. 49 shows a back elevation view of a clutch plate positioning member; the view showing the clutch plate positioning member having a recessed track.

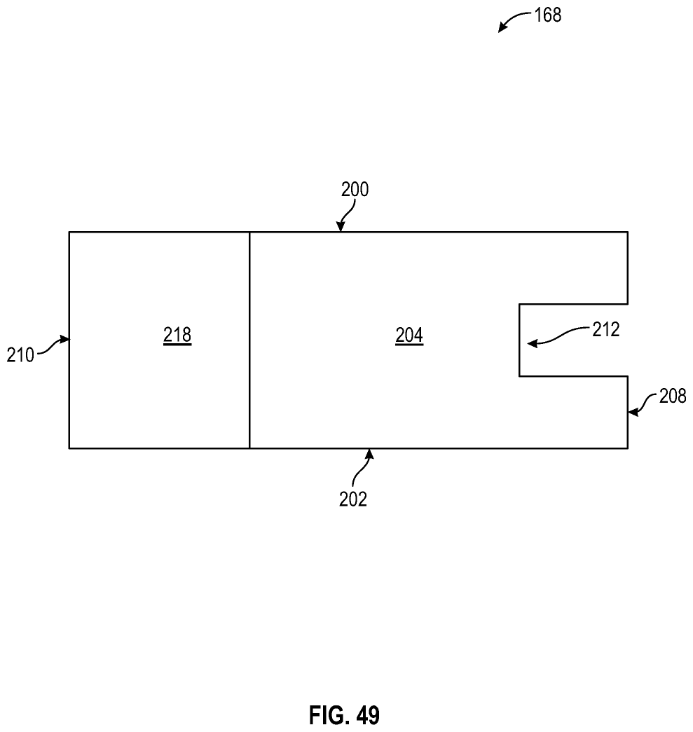

FIG. 50 shows an alternate perspective view of a clutch plate positioning member; the view showing the clutch plate positioning member having a recessed track.

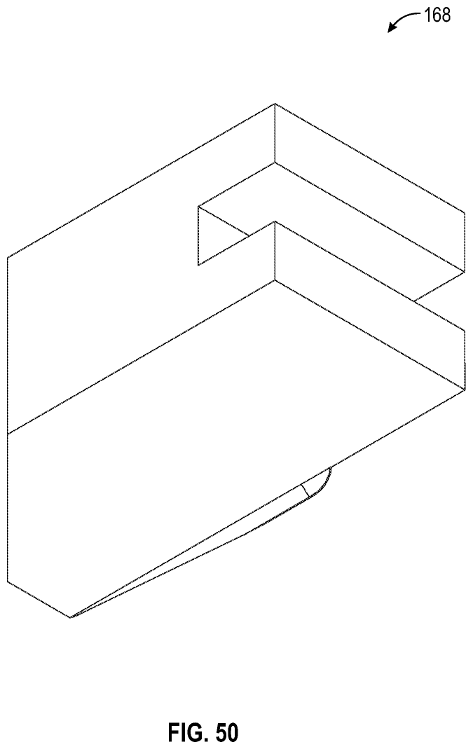

FIG. 51 shows an alternate perspective view of a clutch plate positioning member; the view showing the clutch plate positioning member having a recessed track and a contact protrusion.

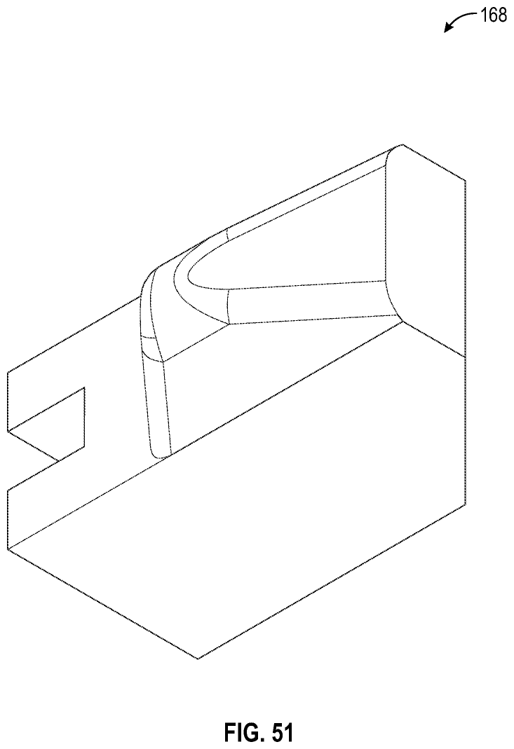

FIG. 52 shows a bottom elevation view of a clutch plate positioning member; the view showing the clutch plate positioning member having a contract protrusion.

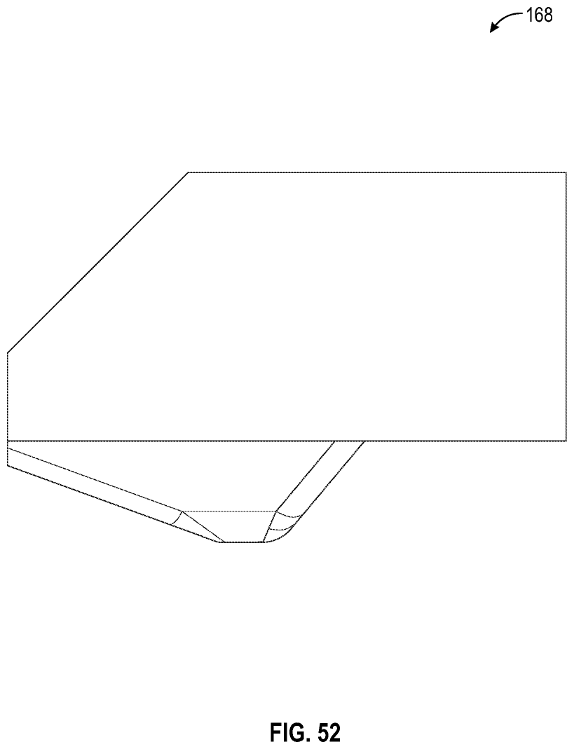

FIG. 53 shows a front elevation view of a clutch plate positioning member; the view showing the clutch plate positioning member having a contract protrusion and a recessed track.

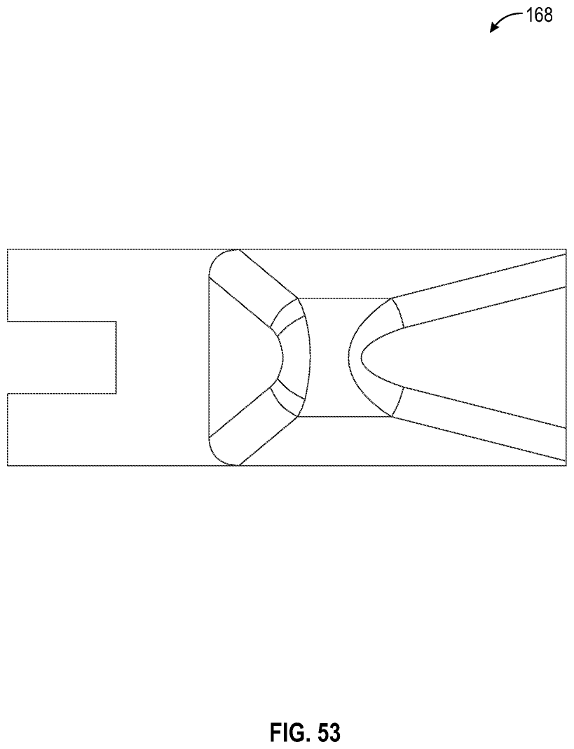

FIG. 54 shows a side elevation view of a clutch plate positioning member; the view showing the clutch plate positioning member having a contract protrusion and a recessed track.

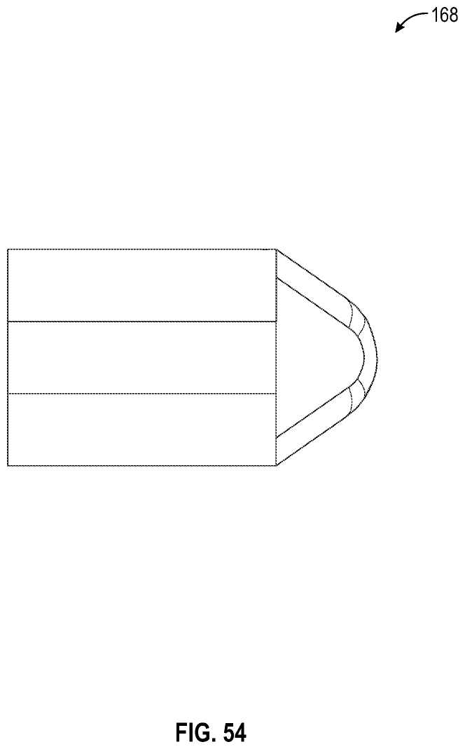

FIG. 55 shows an alternate perspective view of a clutch plate positioning member; the view showing the clutch plate positioning member having a recessed track.

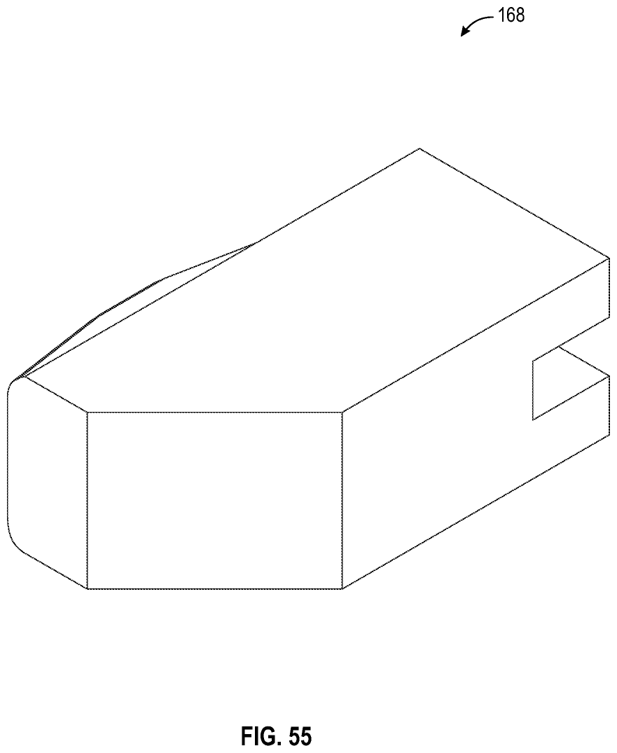

FIG. 56 shows an alternate side elevation view of a clutch plate positioning member; the view showing the clutch plate positioning member having a contract protrusion and a recessed track.

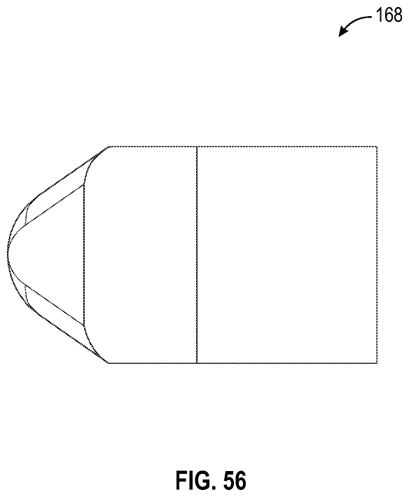

FIG. 57 shows an alternate perspective view of a clutch plate positioning member; the view showing the clutch plate positioning member having a recessed track and a contact protrusion.

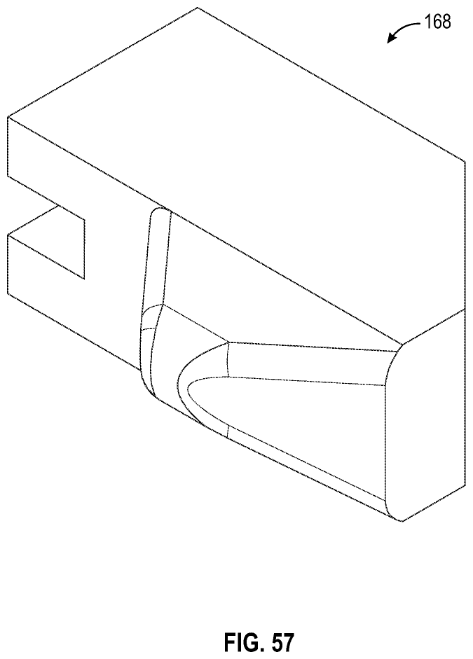

FIG. 58 shows an alternate perspective view of a clutch plate positioning member; the view showing the clutch plate positioning member having a recessed track and a contact protrusion.

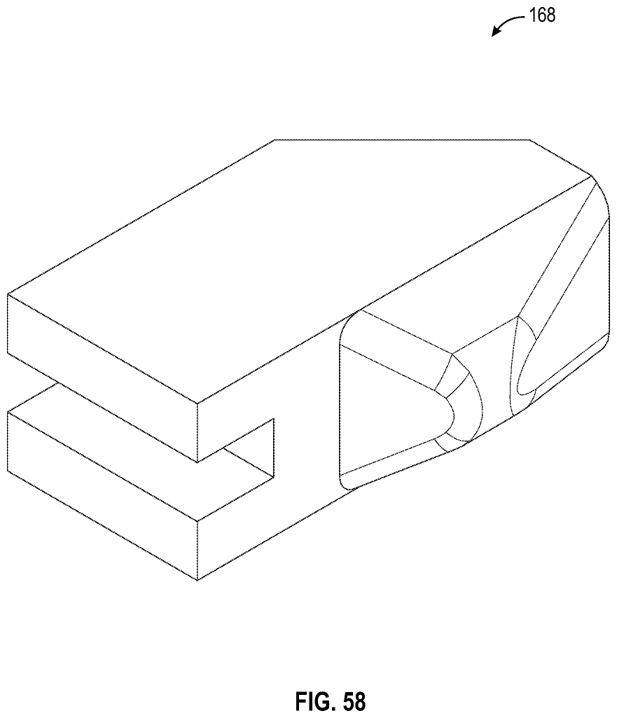

FIG. 59 shows a front elevation view of an actuator; the view showing the actuator having a button and a flange extending outward from the button; the view also showing the actuator having a top member and a bottom member.

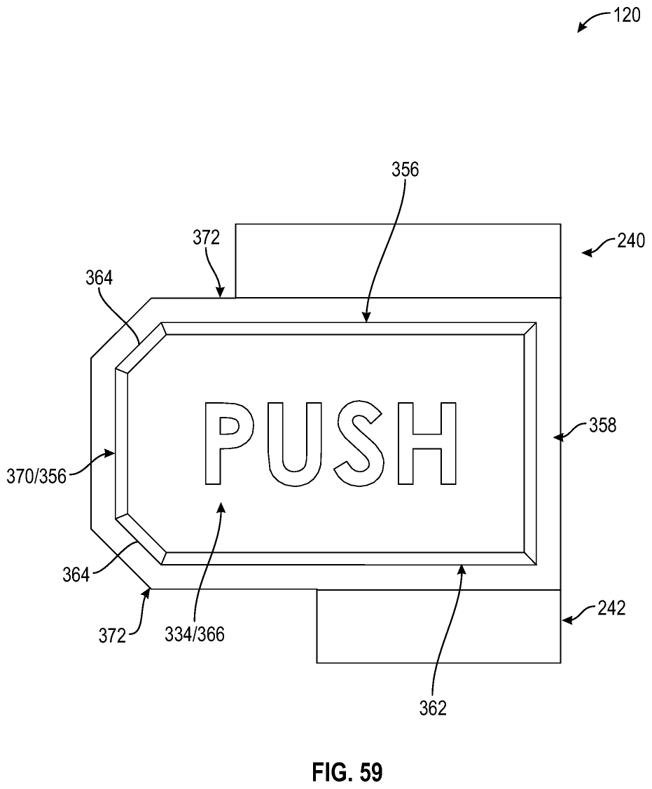

FIG. 60 shows a perspective view of an actuator; the view showing the actuator having a button and an inner portion extending away from the button.

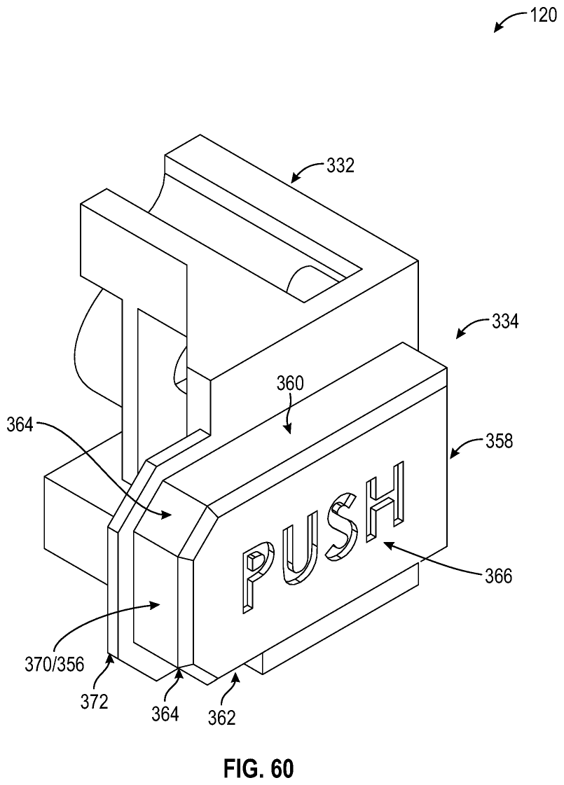

FIG. 61 shows a perspective view of an actuator; the view showing the actuator having a button and an inner portion extending away from the button; the inner portion of the actuator having a top member and a bottom member; the view showing the bottom member of the inner portion having a recessed channel and a recessed track; the view showing the actuator having a lock-side side wall with an opening.

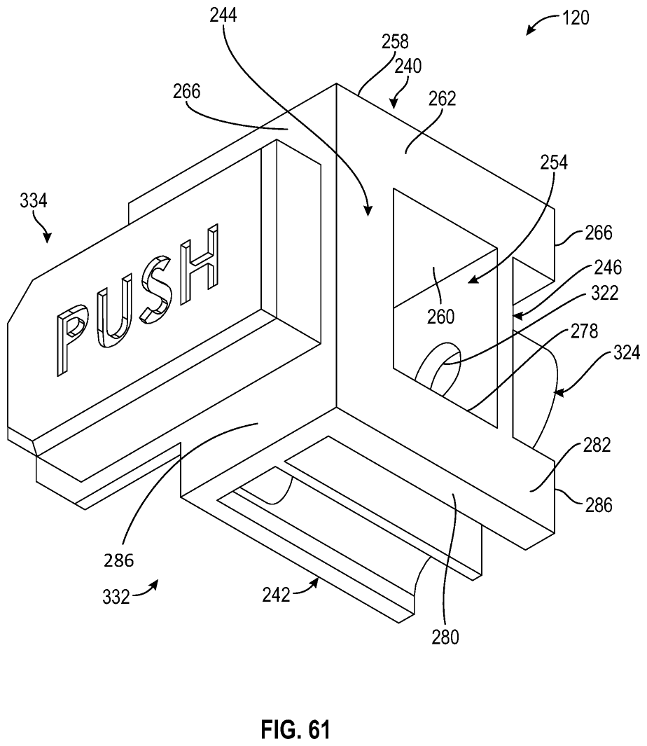

FIG. 62 shows a perspective view of an actuator; the view showing the actuator having a button and an inner portion extending away from the button; the view showing the inner portion comprises a recessed channel and a recessed track.

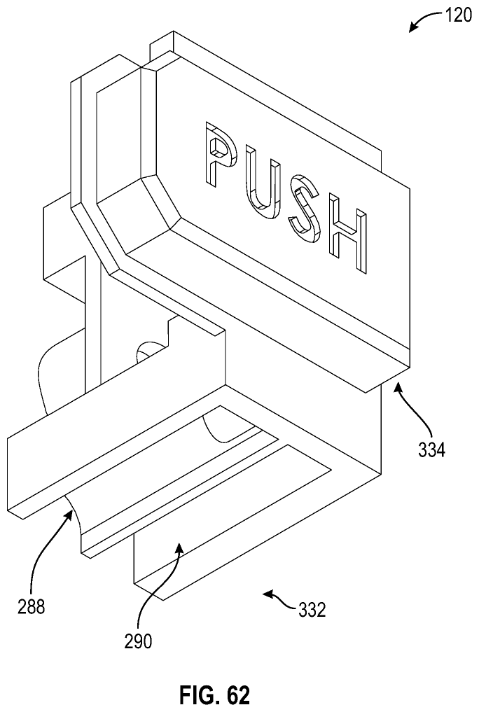

FIG. 63 shows a perspective view of an actuator; the view showing the actuator having a button and an inner portion extending away from the button; the inner portion having a top member with a recessed channel.

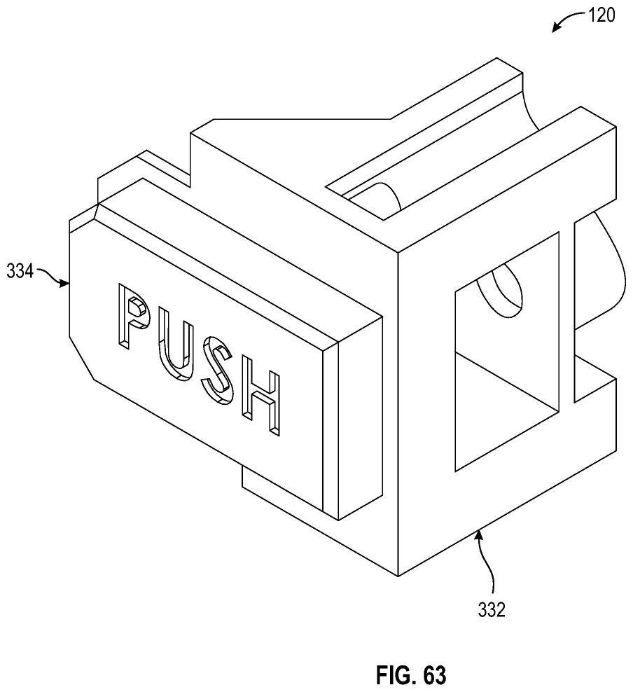

FIG. 64 shows a perspective view of an actuator; the view showing the actuator having an inner portion and a button; the inner portion comprising a bottom member, a top member, and an opening; the top member of the inner portion having a recessed channel and the bottom member of the inner portion having a recessed channel and a recessed track.

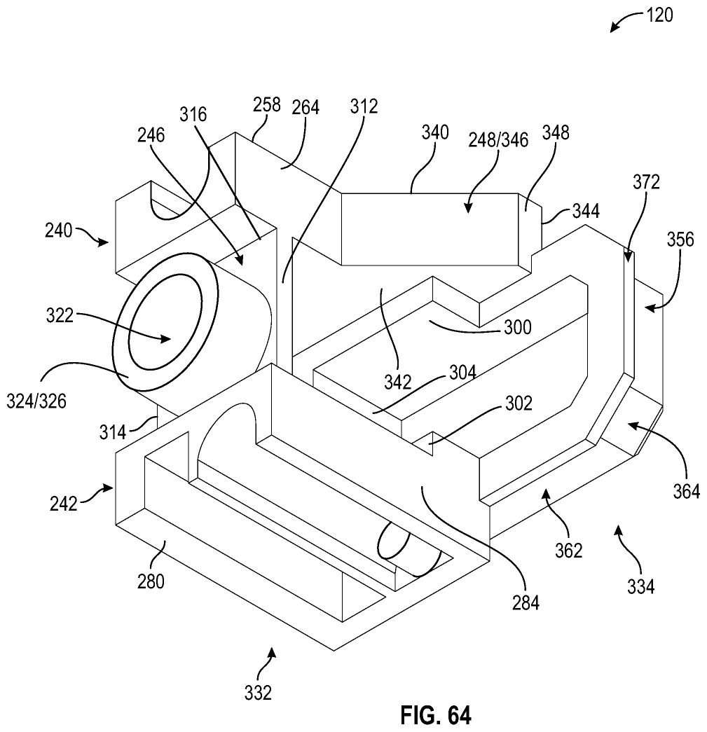

FIG. 65 shows a back side elevation view of the actuator of FIG. 64; the view showing the actuator having an inner portion; the inner portion comprising a bottom member, a top member, and an opening.

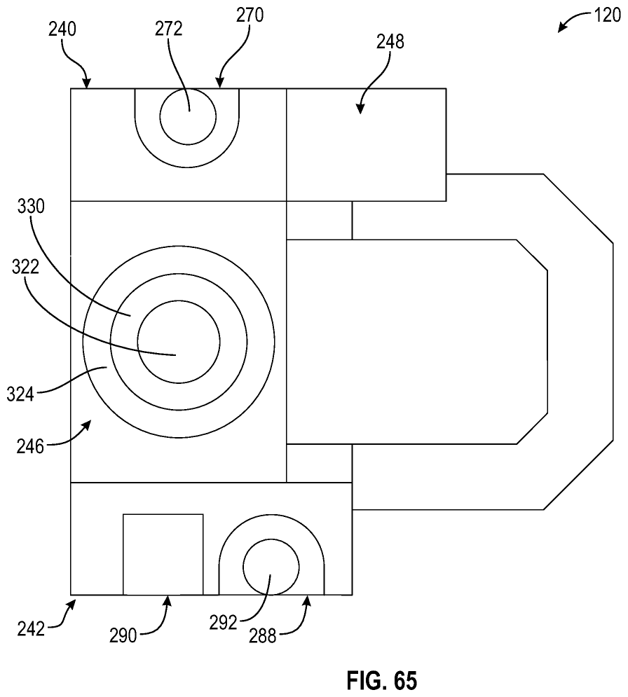

FIG. 66 shows a perspective view of the actuator of FIG. 64; the view showing the actuator having an inner portion and a button; the inner portion comprising a bottom member, a top member, and an opening; the top member having a connection feature within a recessed channel; the bottom member having a recessed channel and a recessed track.

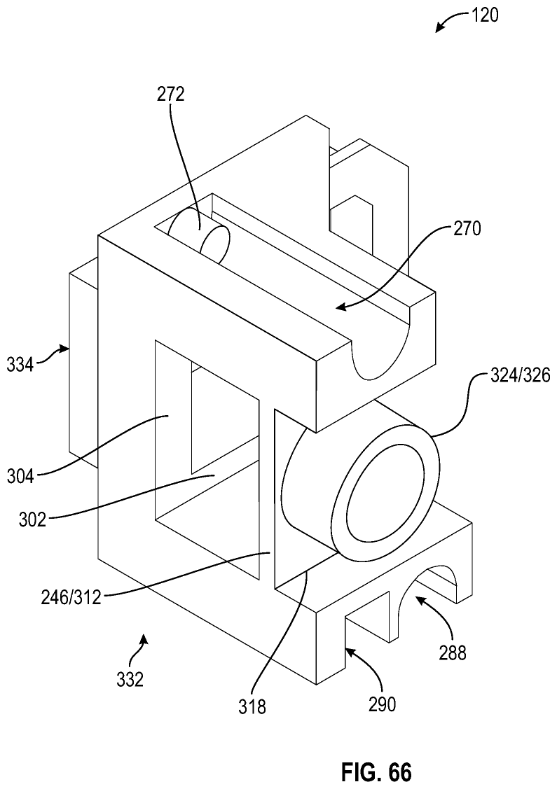

FIG. 67 shows a perspective view of the actuator of FIG. 64; the view showing the actuator having an inner portion and a button; the inner portion comprising a bottom member, a top member, and an opening; the top member having a recessed channel; the bottom member having a recessed channel and a recessed track with a connection feature within the recessed channel.

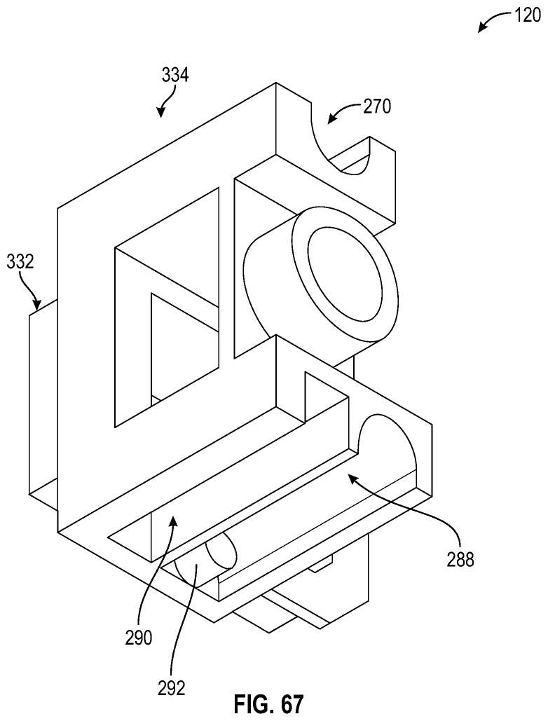

FIG. 68 shows a perspective view of an actuator; the view showing the actuator having a button and an inner portion extending away from the button.

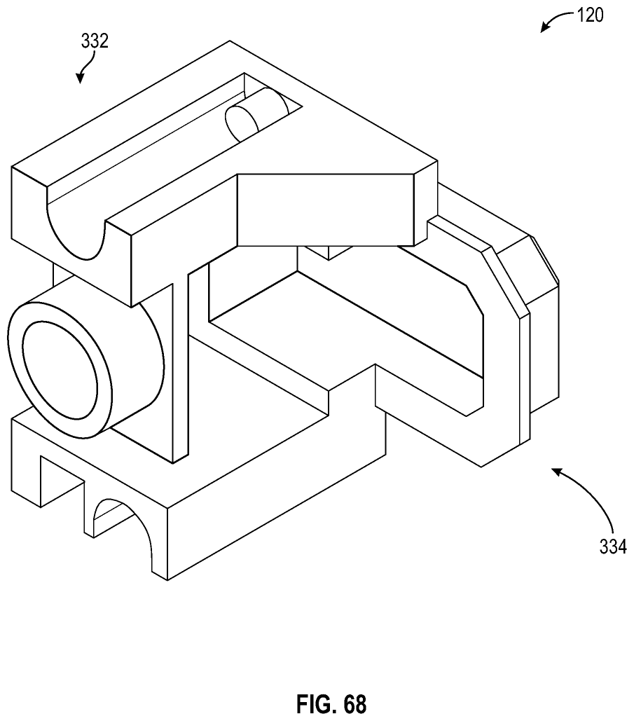

FIG. 69 shows a top elevation view of an actuator; the view showing the actuator having a button and an inner portion extending away from the button; the inner portion of the button having a top member with a recessed channel.

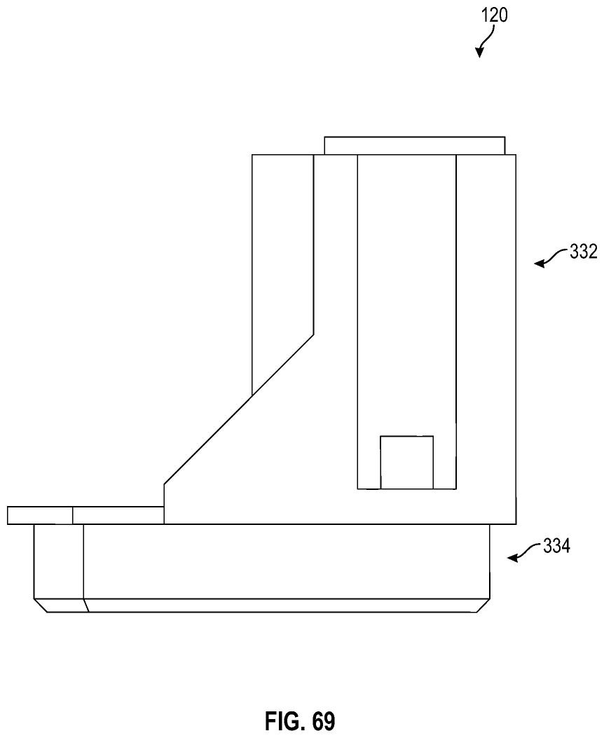

FIG. 70 shows a bottom elevation view of an actuator; the view showing the actuator having a button and an inner portion extending away from the button; the inner portion having a bottom member with a recessed channel and a recessed track.

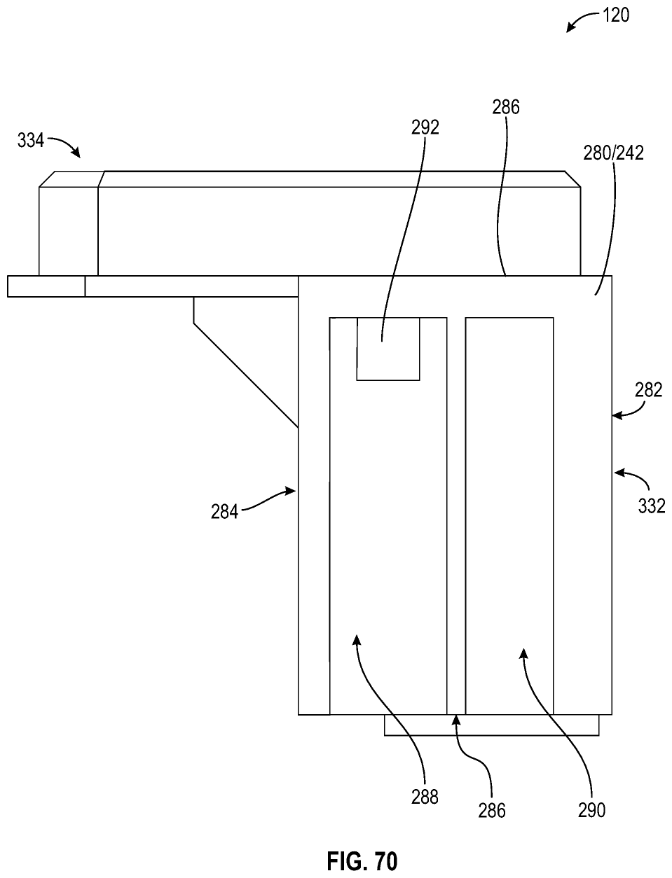

FIG. 71 shows a side elevation view an actuator having a button and an inner portion; the view showing the inner portion having a top member, a bottom member, and an opening.

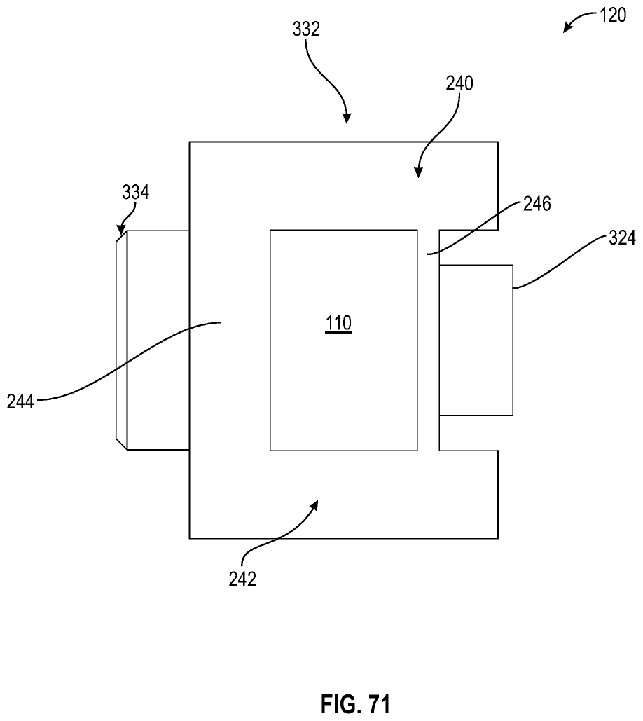

FIG. 72 shows a perspective view of a cover of an end stop assembly; the view showing the cover having an opening for an actuator to fit through.

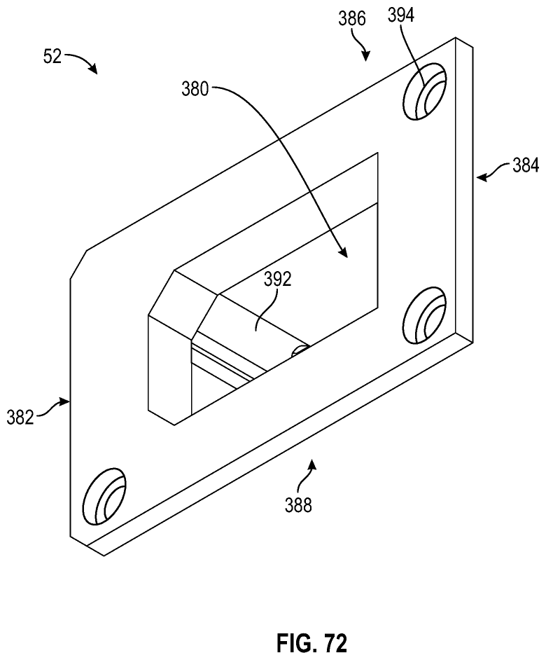

FIG. 73 shows a perspective view of a cover of an end stop assembly; the view showing the cover having a beam and an opening for an actuator to fit through.

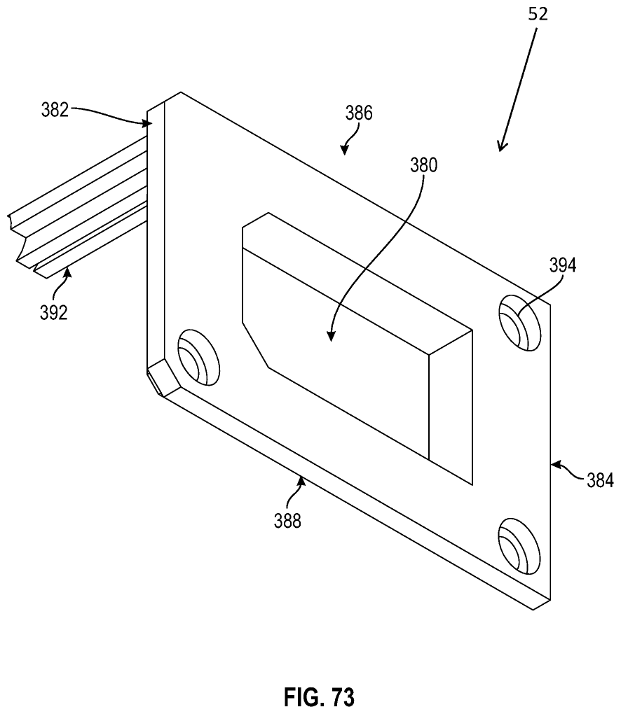

FIG. 74 shows a back perspective view of a cover of an end stop assembly; the view showing the cover having a beam and an opening for an actuator to fit through.

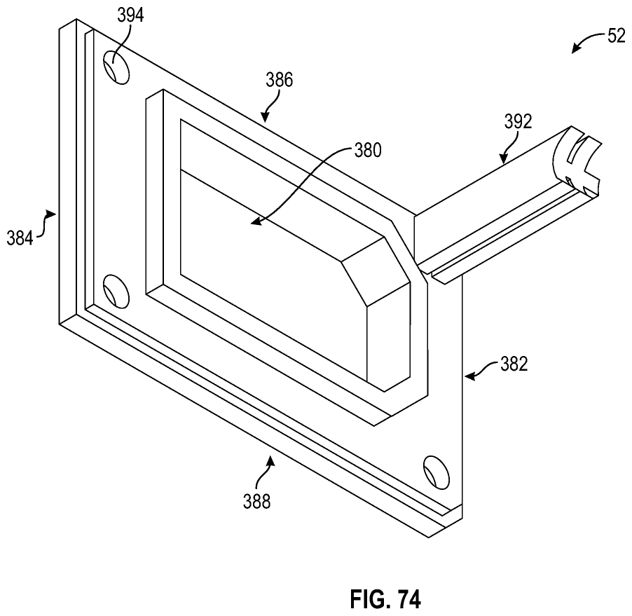

FIG. 75 shows a back perspective view of a cover of an end stop assembly; the view showing the cover having a beam and an opening for an actuator to fit through.

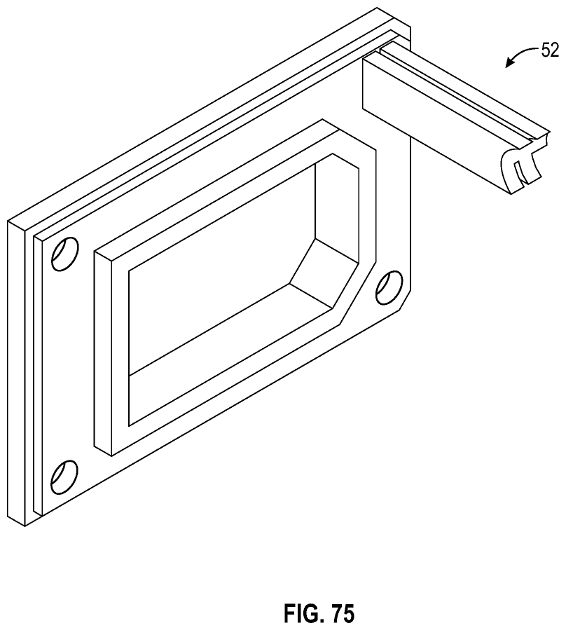

FIG. 76 shows a back perspective view of a cover of an end stop assembly; the view showing the cover having a beam and an opening for an actuator to fit through.

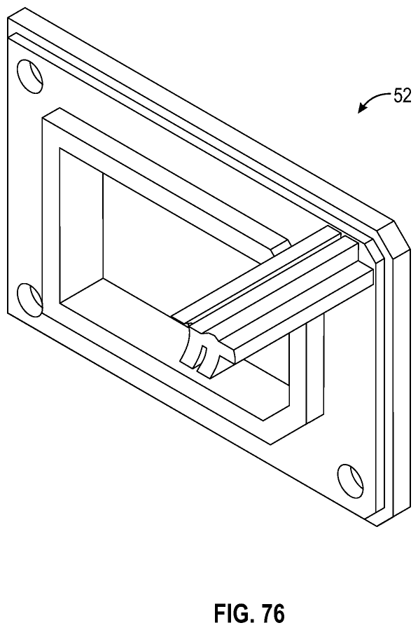

FIG. 77 shows a back perspective view of a cover of an end stop assembly; the view showing the cover having a beam and an opening for an actuator to fit through.

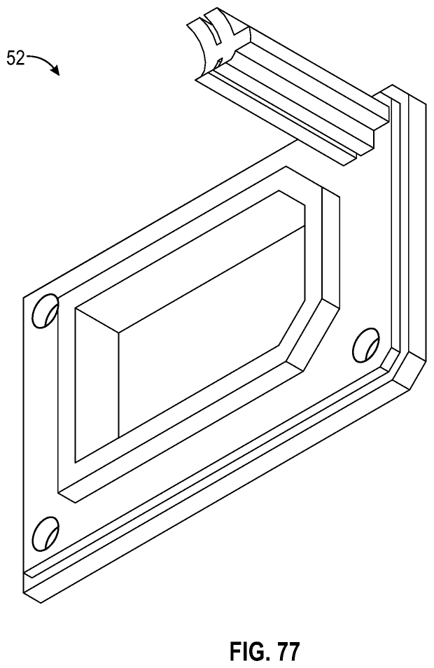

FIG. 78 shows a front perspective view of a cover of an end stop assembly; the view showing the cover having a beam and an opening for an actuator to fit through.

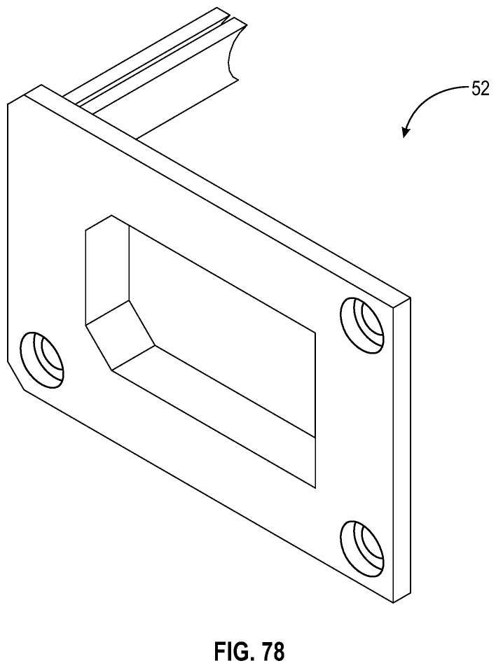

FIG. 79 shows a back perspective view of a cover of an end stop assembly; the view showing the cover having a beam and an opening for an actuator to fit through and a beam.

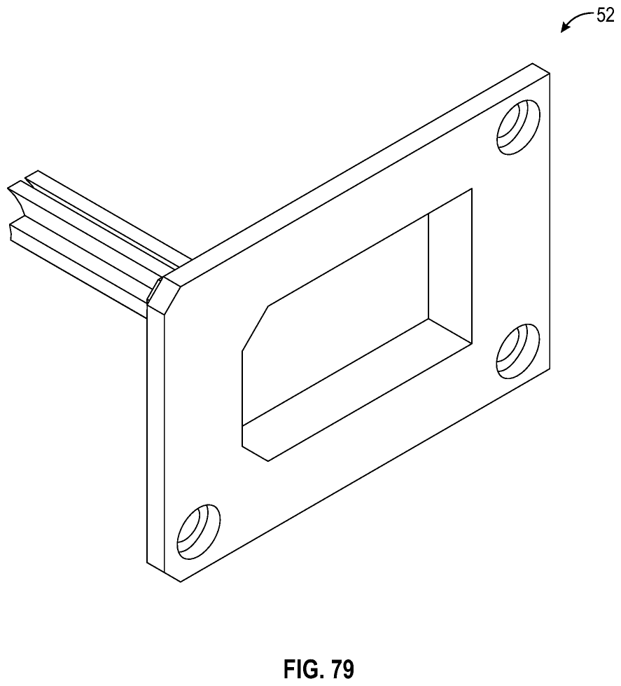

FIG. 80 shows a front elevation view of a cover of an end stop assembly; the view showing the cover having an opening for an actuator to fit through.

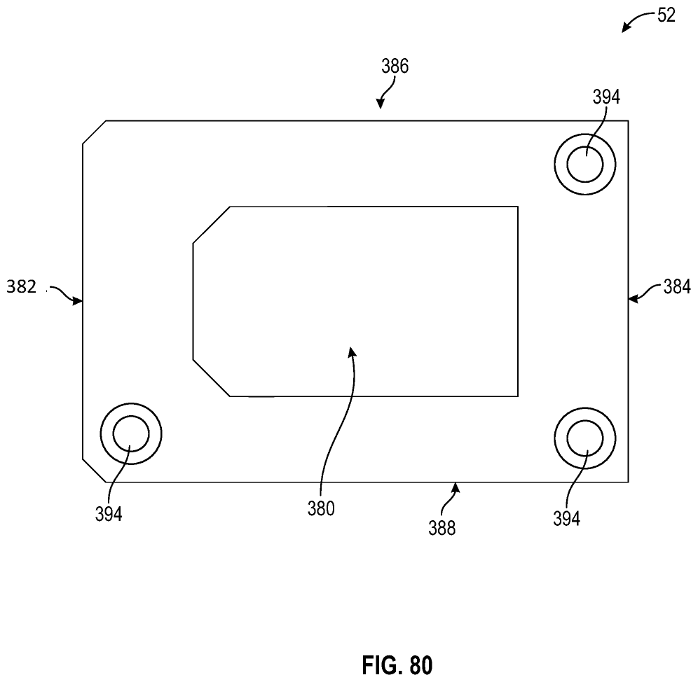

FIG. 81 shows a front elevation view of a cover of an end stop assembly; the view showing the cover having a beam and an opening for an actuator to fit through and a beam.

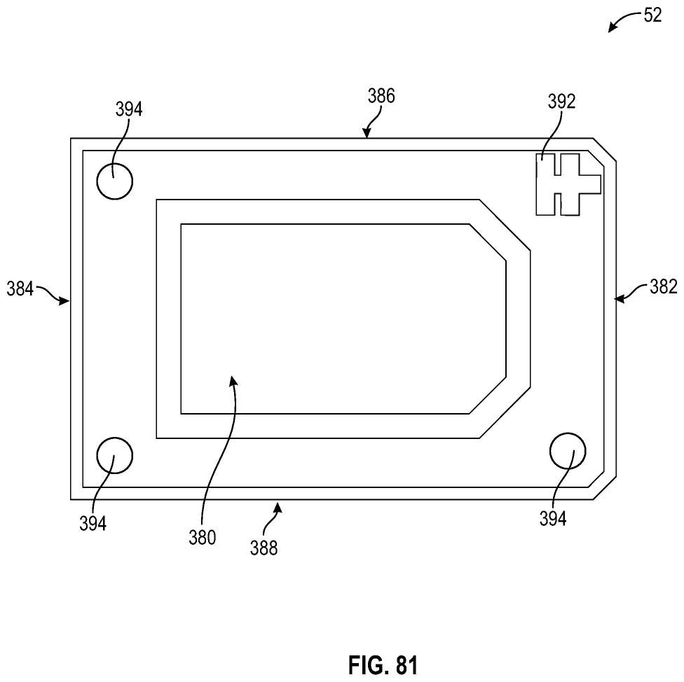

FIG. 82 shows a bottom elevation view of a cover of an end stop assembly; the view showing the cover having a beam.

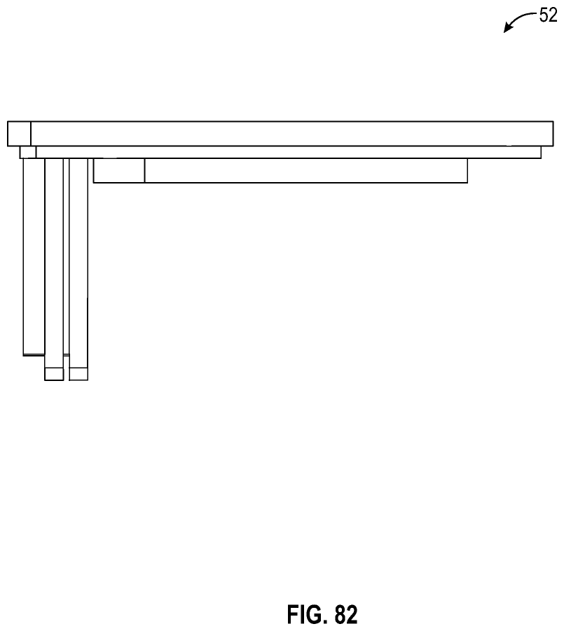

FIG. 83 shows a side elevation view of a cover of an end stop assembly; the view showing the cover having a beam.

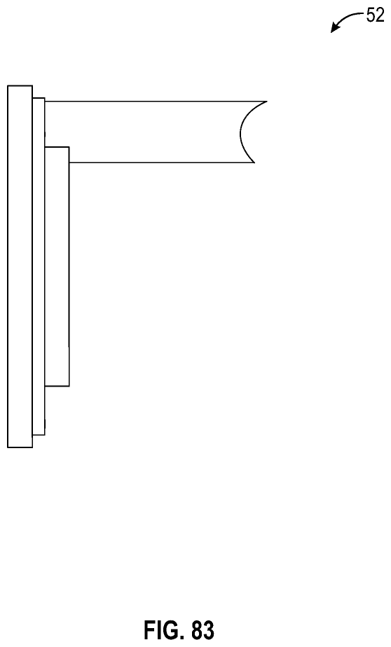

FIG. 84 shows an alternate side elevation view of a cover of an end stop assembly; the view showing the cover having a beam.

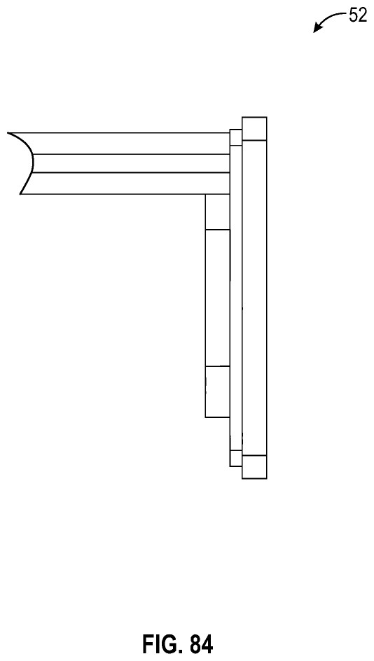

FIG. 85 shows a top elevation view of a cover of an end stop assembly; the view showing the cover having a beam.

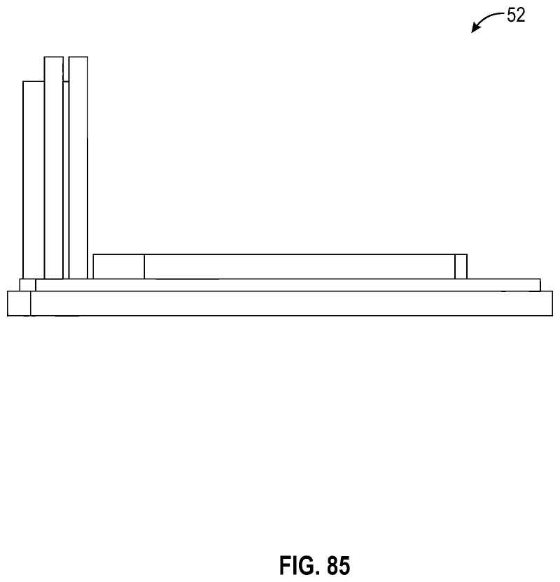

FIG. 86 shows an elevation view of a bar clamp system; the view showing an end stop assembly and a handle assembly positioned to be facing outward away from each other.

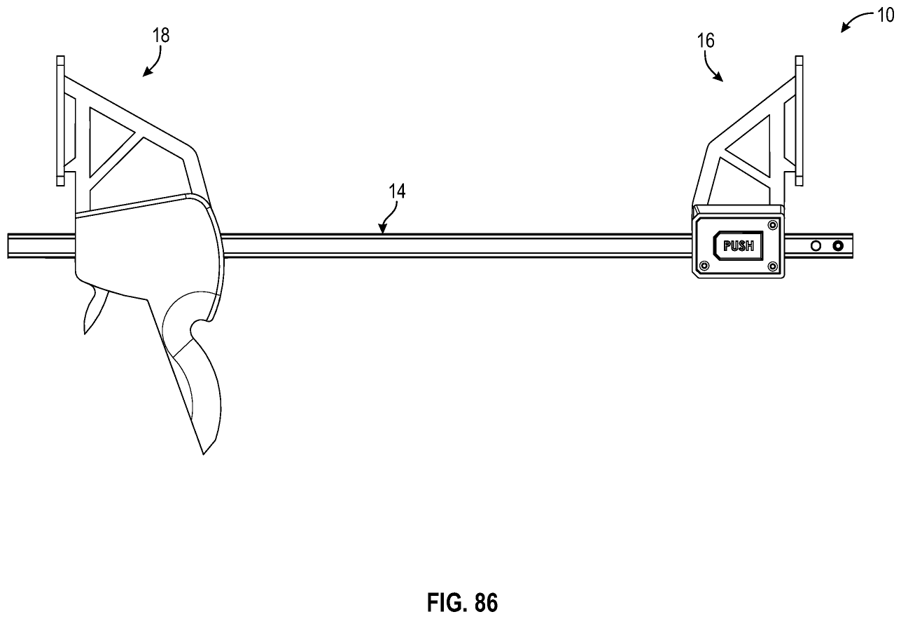

FIG. 87 shows a perspective view of a bar clamp system; the view showing an end stop assembly and a handle assembly positioned to be facing outward away from each other.

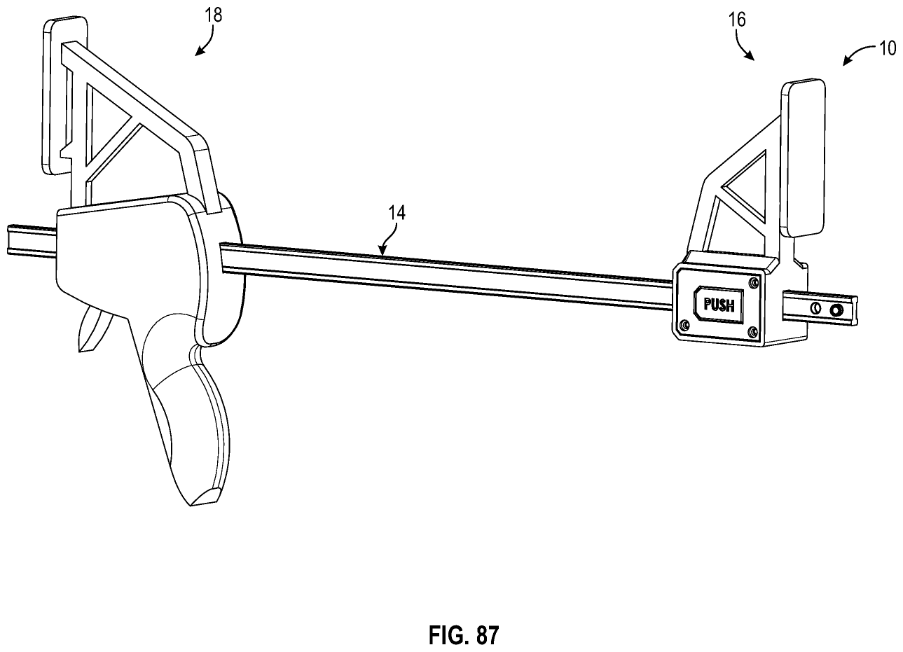

FIG. 88 shows a side elevation view of a handle assembly; the view showing the handle assembly having a main body, a clamp plate, a clamp arm, a handle, a clamp actuator, and a release actuator.

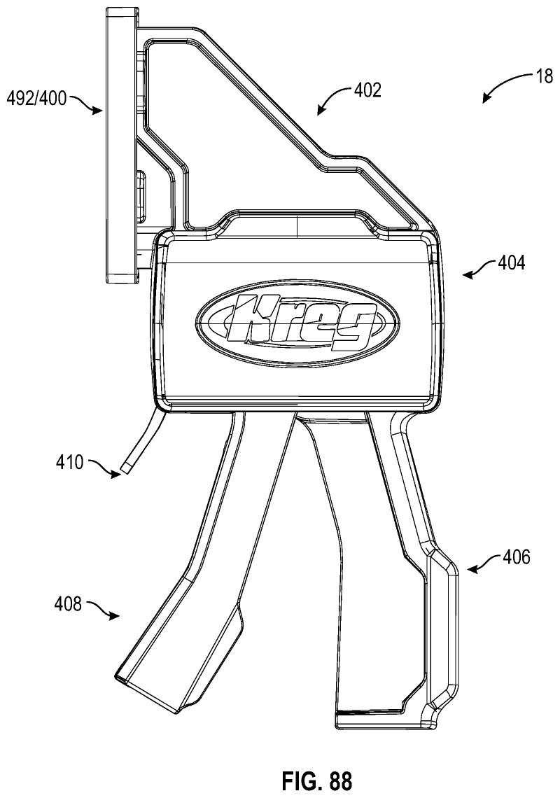

FIG. 89 shows a side elevation view of a handle assembly; the view showing the handle assembly having a main body, a clamp plate, a clamp arm, a handle, a clamp actuator, and a release actuator; the view showing the clamp plate having a removable clamp plate cover.

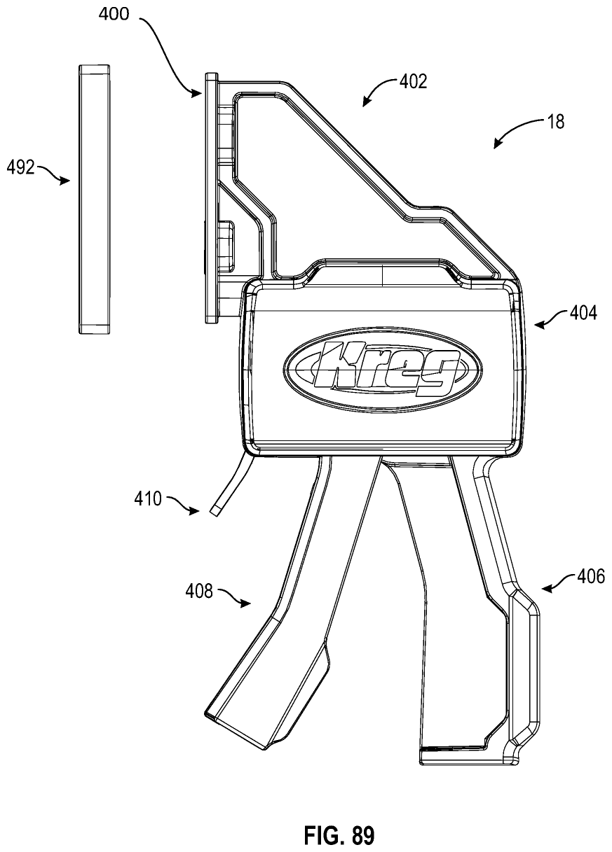

FIG. 90 shows a side elevation view of a handle assembly; the view showing the handle assembly having a main body, a clamp plate, a clamp arm, a handle, a clamp actuator, and a release actuator.

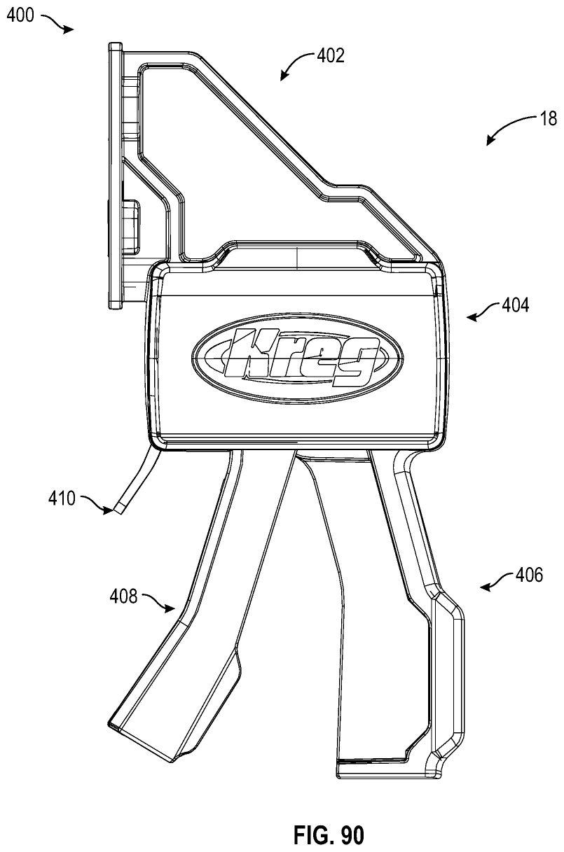

FIG. 91 shows a cut away view of a handle assembly; the view showing the handle assembly having a main body, a clamp plate, a clamp arm, a handle, a clamp actuator, and a release actuator; the view showing the main body having openings to facilitate connection of the clamp actuator and the release actuator.

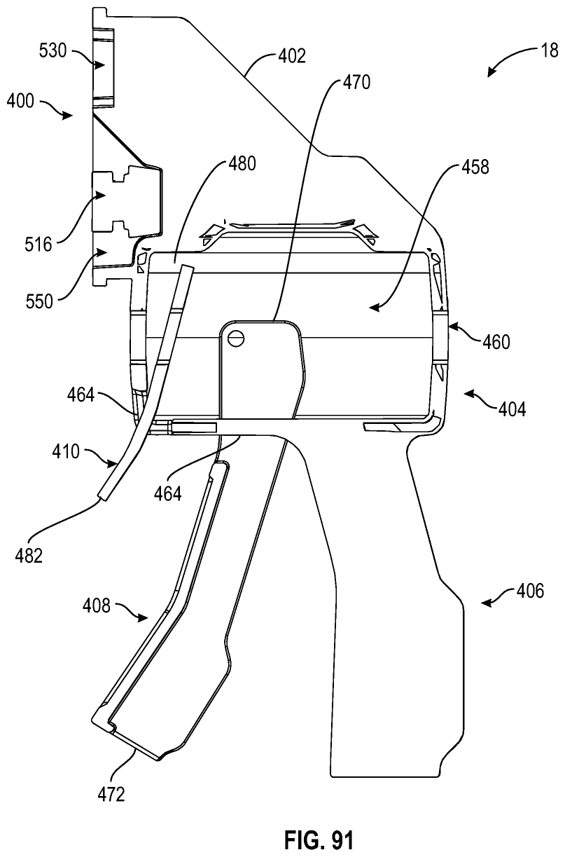

FIG. 92 shows a cut away view of a handle assembly; the view showing the handle assembly having a main body, a clamp plate, a clamp arm, a handle, a clamp actuator, and a release actuator; the view showing the main body having openings to facilitate connection of the clamp actuator and the release actuator; the view showing the clamp plate having a connection assembly.

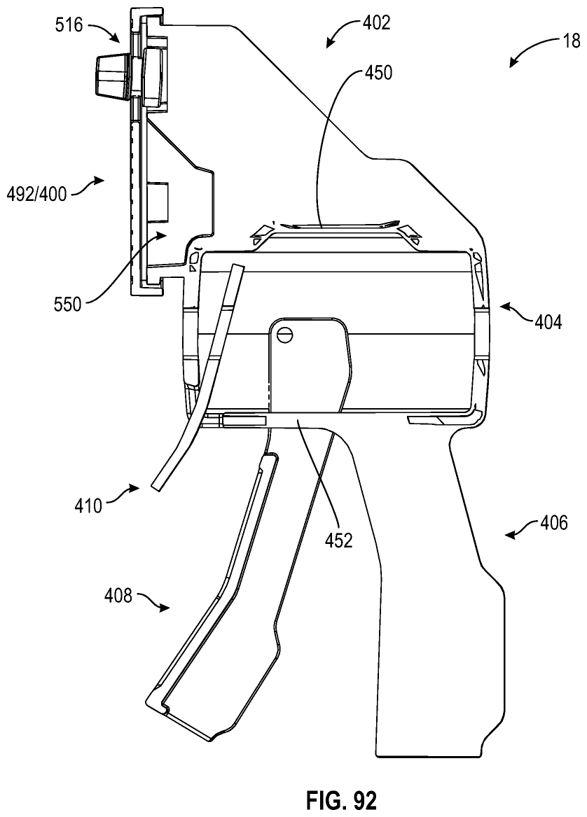

FIG. 93 shows a front perspective view of a handle assembly; the view showing the handle assembly having a main body, a clamp plate, a clamp arm, a handle, a clamp actuator, and a release actuator.

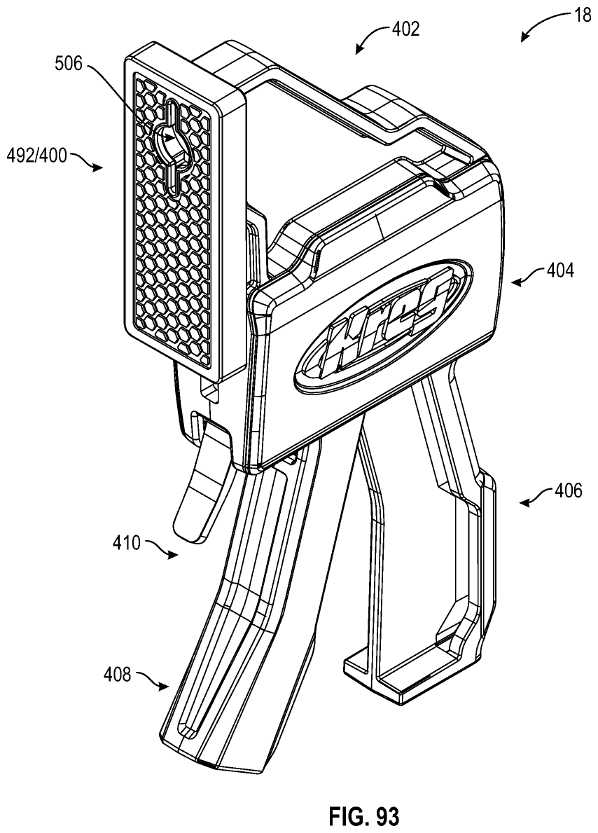

FIG. 94 shows a front perspective view of a handle assembly; the view showing the handle assembly having a main body, a clamp plate, a clamp arm, a handle, a clamp actuator, and a release actuator; the view showing the clamp plate having a removable clamp plate cover.

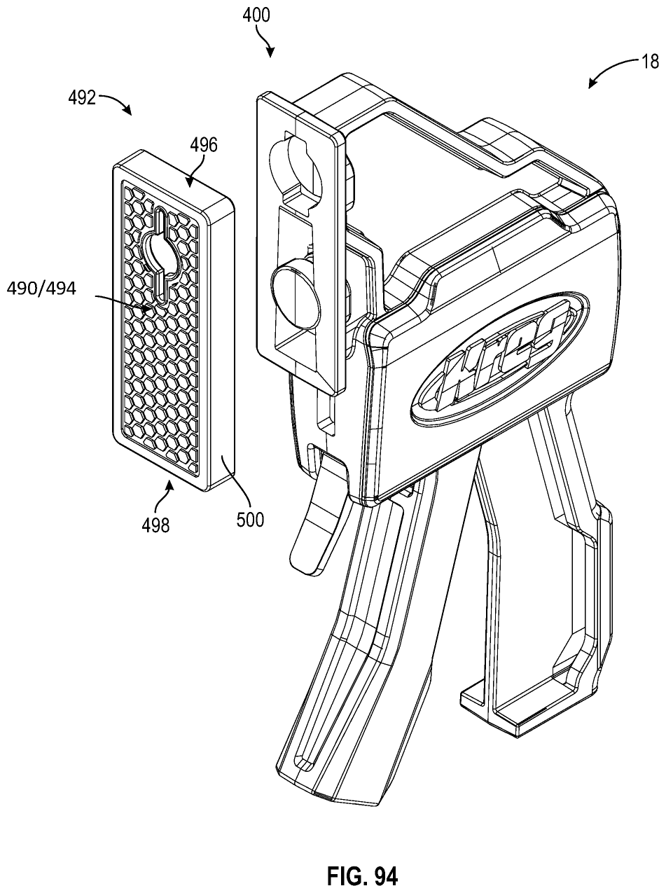

FIG. 95 shows a front perspective view of a handle assembly; the view showing the handle assembly having a main body, a clamp plate, a clamp arm, a handle, a clamp actuator, and a release actuator; the view showing the clamp plate without a clamp plate cover.

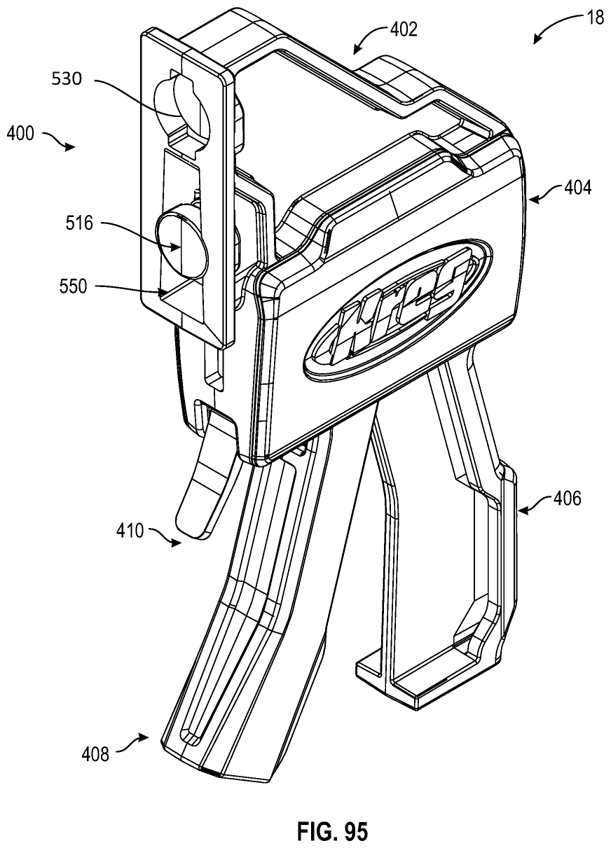

FIG. 96 shows a front perspective view of a handle assembly; the view showing the handle assembly having a main body, a clamp plate, a clamp arm, a handle, a clamp actuator, and a release actuator; the view showing the clamp plate with a connection assembly and without a clamp plate cover.

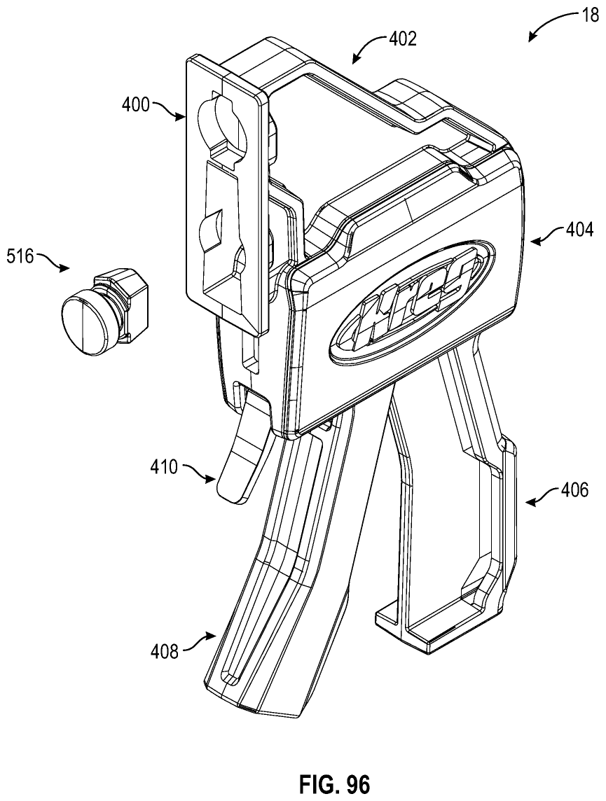

FIG. 97 shows a front perspective view of a handle assembly; the view showing the handle assembly having a main body, a clamp plate, a clamp arm, a handle, a clamp actuator, and a release actuator; the view showing the clamp plate with a connection assembly and a clamp plate cover installed on the clamp plate.

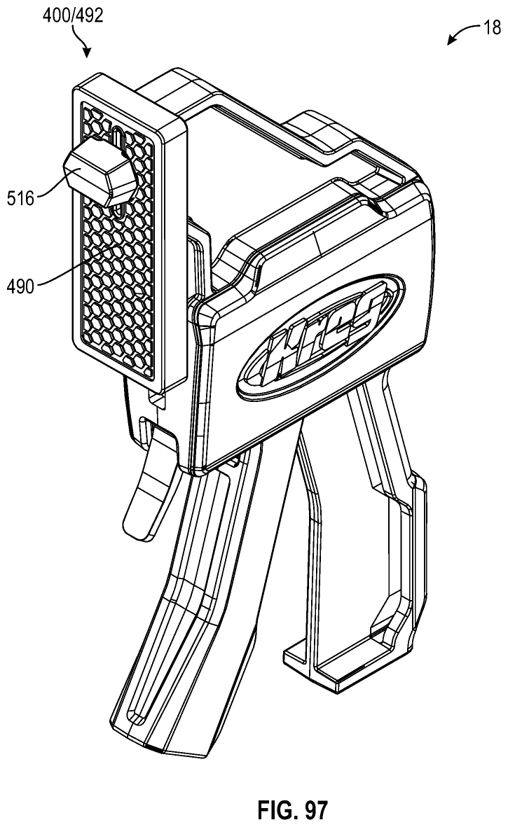

FIG. 98 shows a front perspective view of a handle assembly; the view showing the handle assembly having a main body, a clamp plate, a clamp arm, a handle, a clamp actuator, and a release actuator; the view showing the clamp plate with a clamp plate cover installed on the clamp plate.

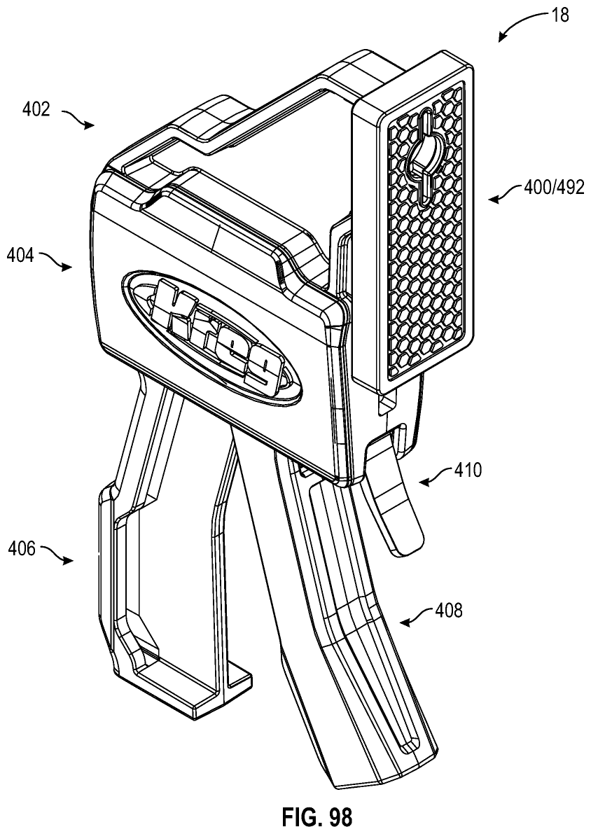

FIG. 99 shows a back perspective view of a handle assembly; the view showing the handle assembly having a main body, a clamp plate, a clamp arm, a handle, a clamp actuator, and a release actuator.

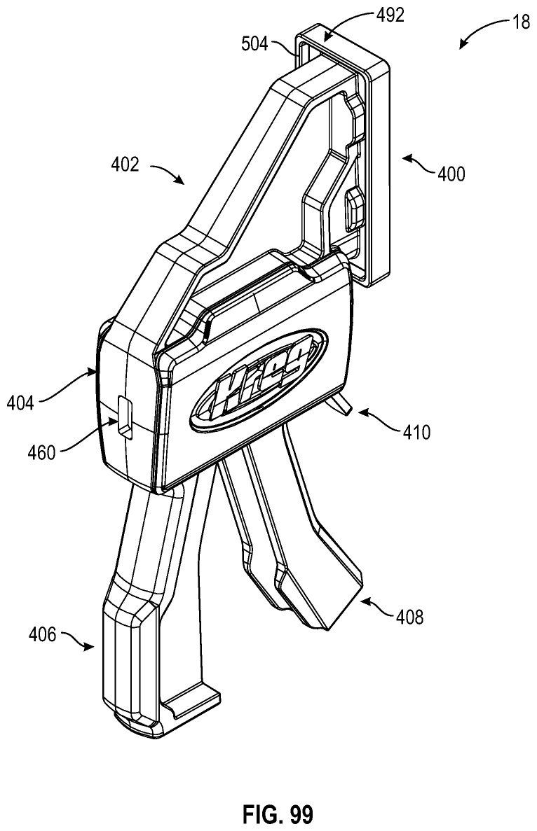

FIG. 100 shows a front elevation view of a handle assembly; the view showing the handle assembly having a main body, a clamp plate, a clamp arm, a handle, a clamp actuator, and a release actuator.

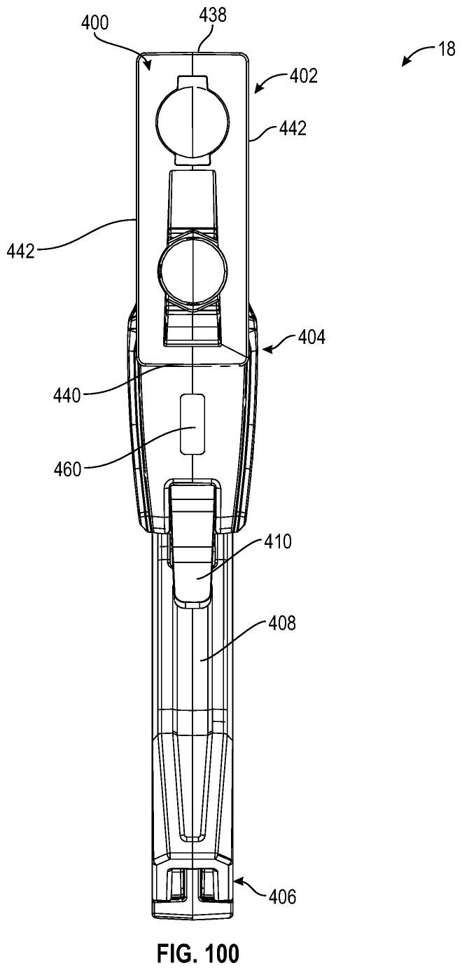

FIG. 101 shows a front elevation view of a handle assembly; the view showing the handle assembly having a main body, a clamp plate, a clamp arm, a handle, a clamp actuator, and a release actuator; the view showing a clamp plate cover installed on the clamp plate.

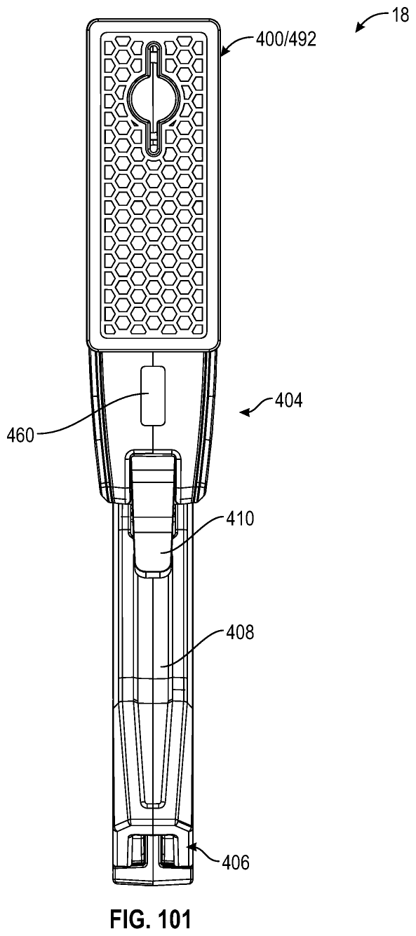

FIG. 102 shows a front perspective view of a clamp plate cover; the view showing the clamp plate cover having an opening to facilitate connection of a connection assembly.

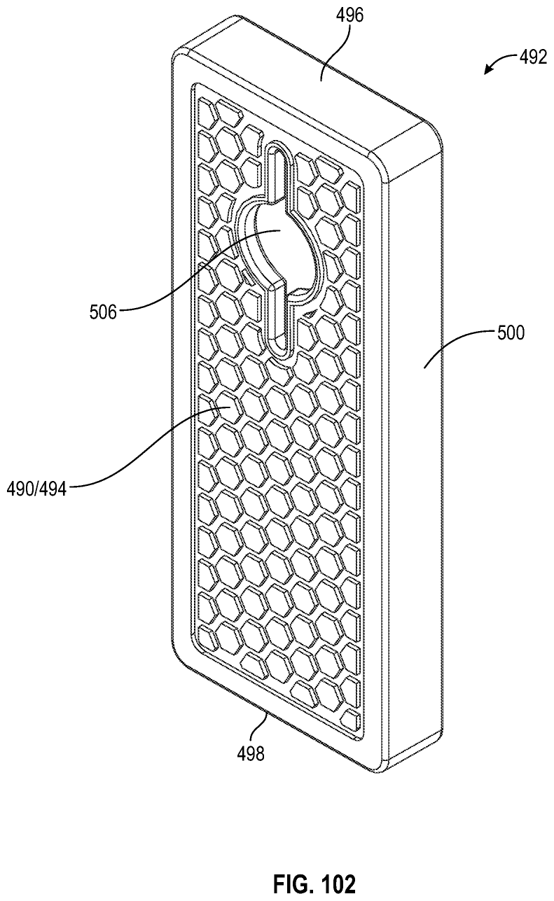

FIG. 103 shows a back perspective view of a clamp plate cover; the view showing the clamp plate cover having an opening to facilitate connection of a connection assembly.

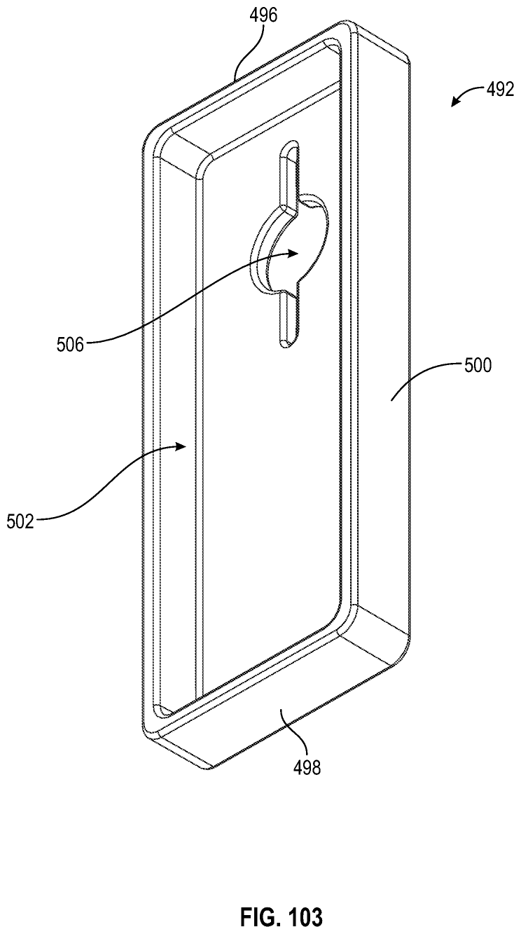

FIG. 104 shows a front elevation view of a clamp plate cover; the view showing the clamp plate cover having an opening to facilitate connection of a connection assembly.

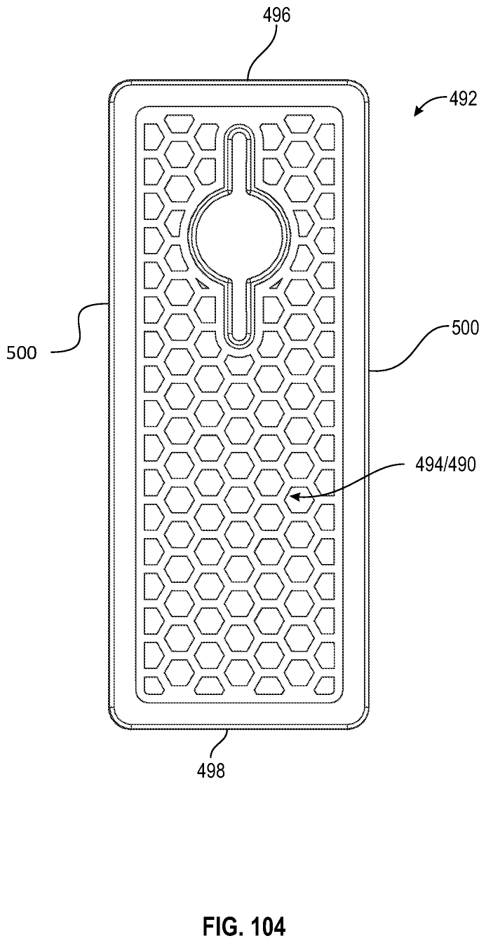

FIG. 105 shows a back elevation view of a clamp plate cover; the view showing the clamp plate cover having an opening to facilitate connection of a connection assembly.

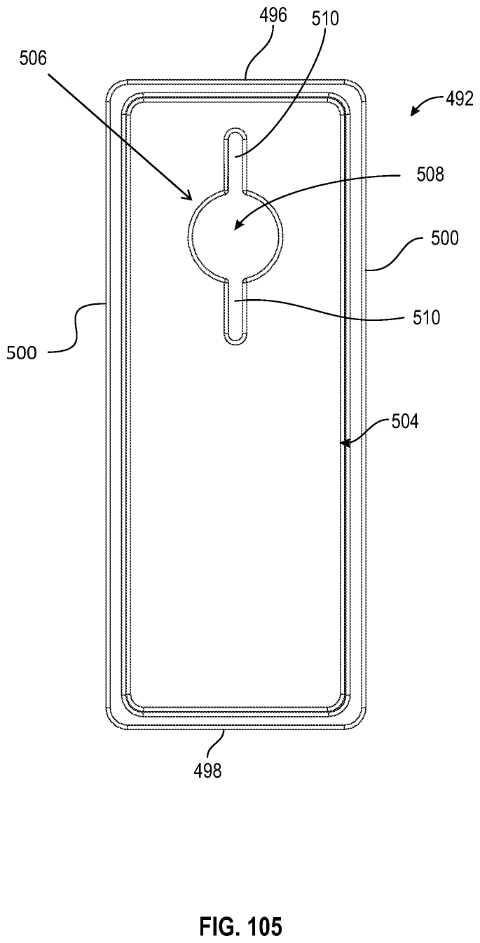

FIG. 106 shows a side elevation view of a clamp plate cover.

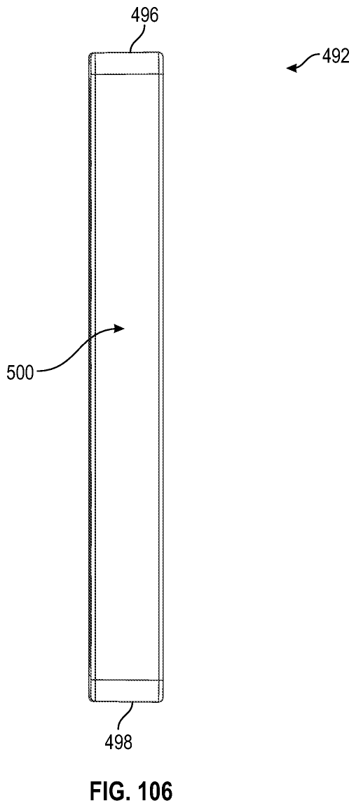

FIG. 107 shows a back perspective view of a clamp plate cover; the view showing the clamp plate cover having an opening to facilitate connection of a connection assembly.

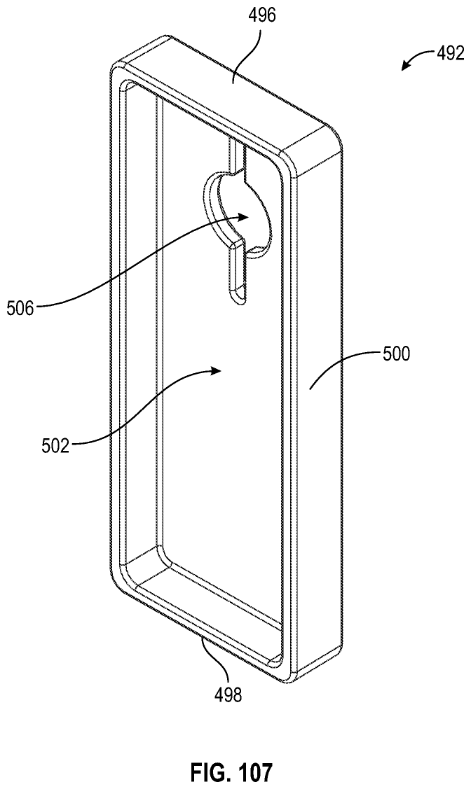

FIG. 108 shows a top elevation view of a clamp plate cover.

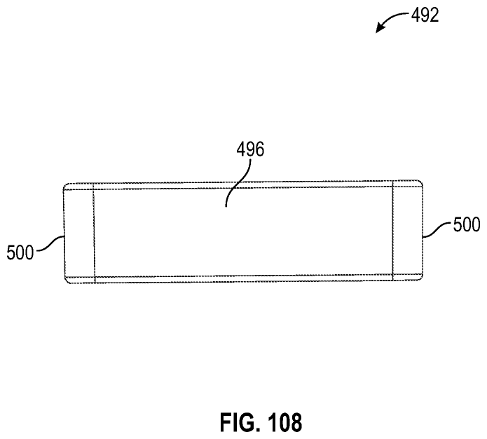

FIG. 109 shows a front perspective view of a clamp plate cover; the view showing the clamp plate cover having an opening to facilitate connection of a connection assembly and a connection assembly configured to be connected through the opening.

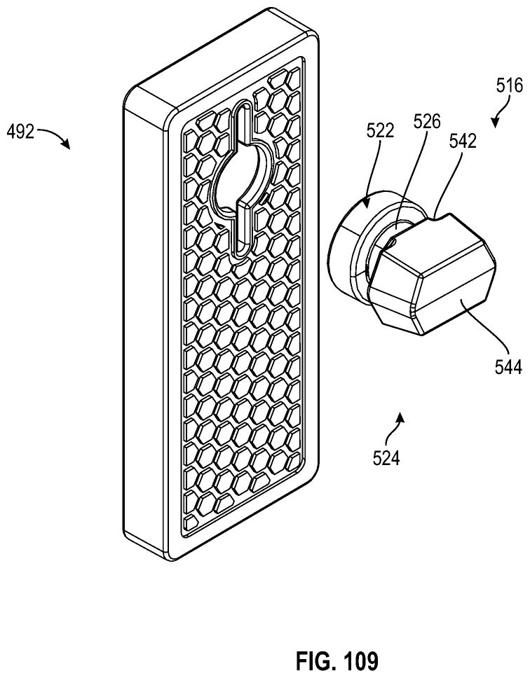

FIG. 110 shows a front perspective view of a clamp plate cover; the view showing a connection assembly installed in the clamp plate cover.

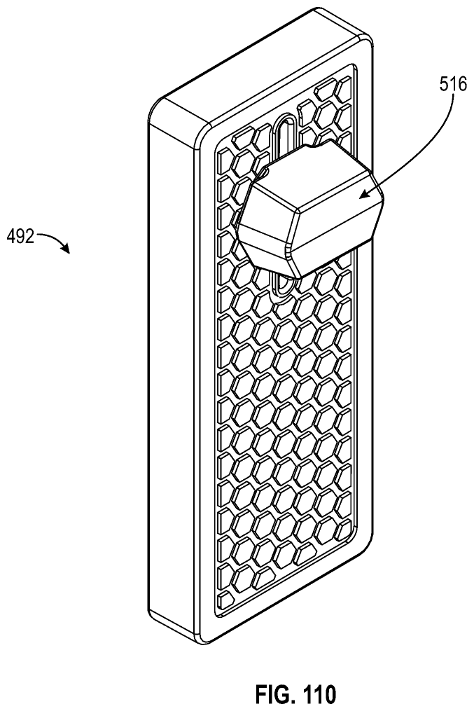

FIG. 111 shows a side elevation view of an end stop assembly; the view showing the end stop assembly having a main body, a clamp arm connected to the main body, a clamp plate connected to the clamp arm, and a clamp plate cover installed on the clamp plate.

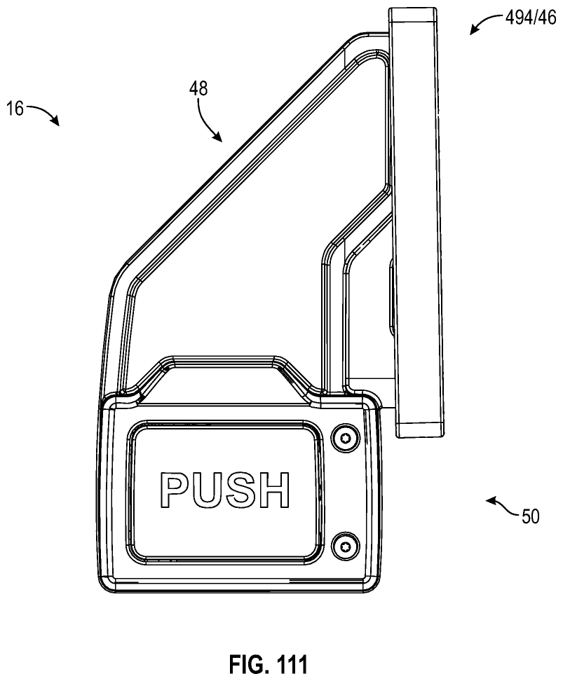

FIG. 112 shows a back elevation view of an end stop assembly; the view showing the end stop assembly having a main body and a clamp plate.

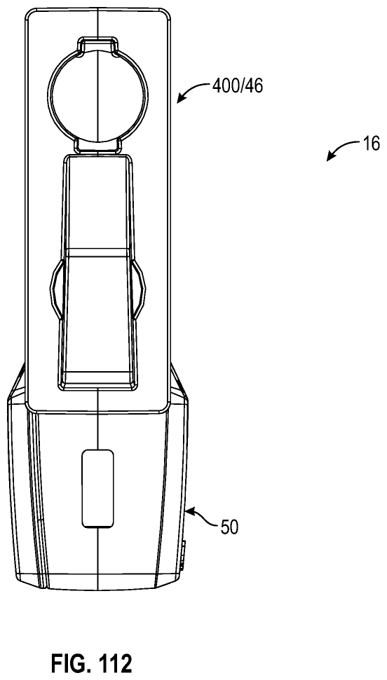

FIG. 113 shows a side elevation view of an end stop assembly; the view showing the end stop assembly having a main body, a clamp arm, a clamp plate, and a connection assembly.

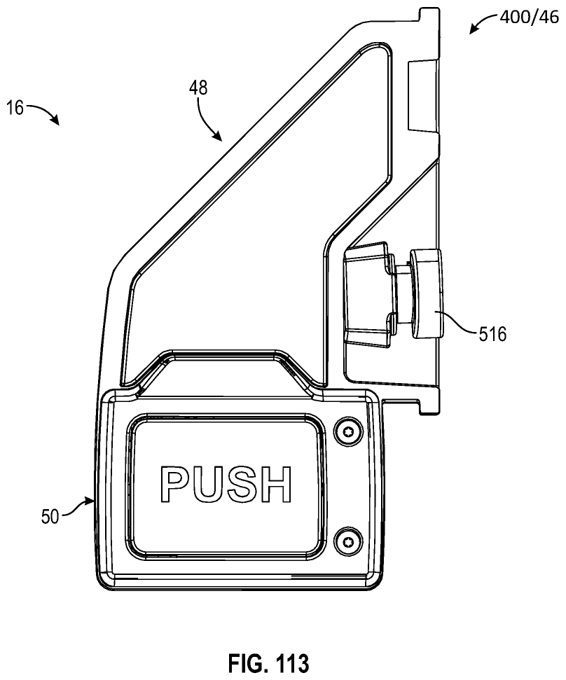

FIG. 114 shows a side elevation view of an end stop assembly; the view showing the end stop assembly having a main body, a clamp arm connected to the main body, and a clamp plate connected to the clamp arm.

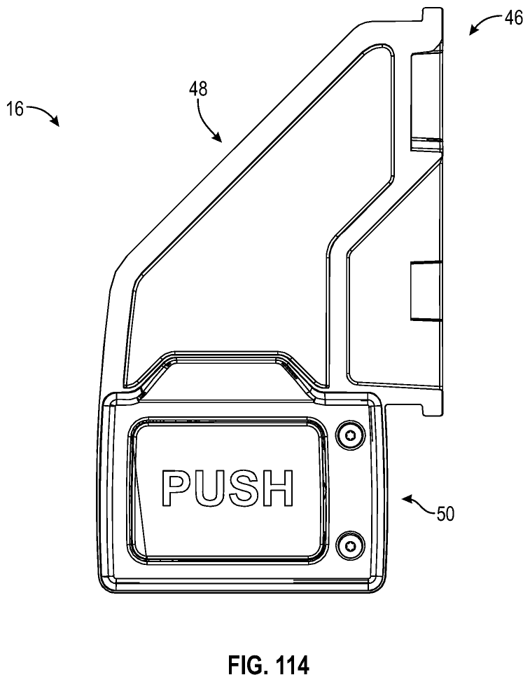

FIG. 115 shows a side elevation view of an end stop assembly; the view showing the end stop assembly having a main body, a clamp arm connected to the main body, a clamp plate connected to the clamp arm, and a connection assembly located proximate one end of the clamp arm.

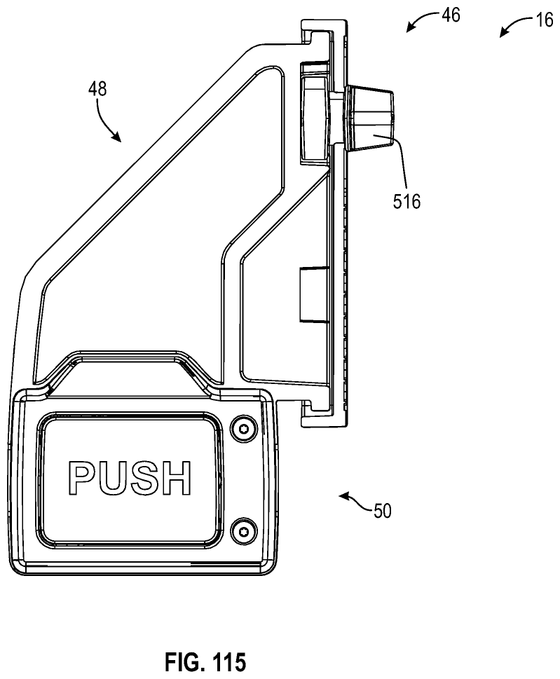

FIG. 116 shows a perspective view of an end stop assembly; the view showing the end stop assembly having a connection assembly operably connected to a cover plate.

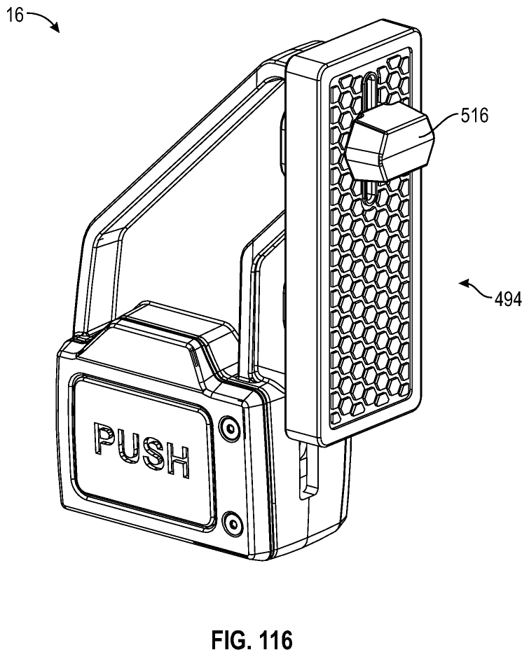

FIG. 117 shows a side elevation view of a bar clamp assembly; the view showing an end stop assembly and a handle assembly located on an elongated bar facing each other to facilitate clamping.

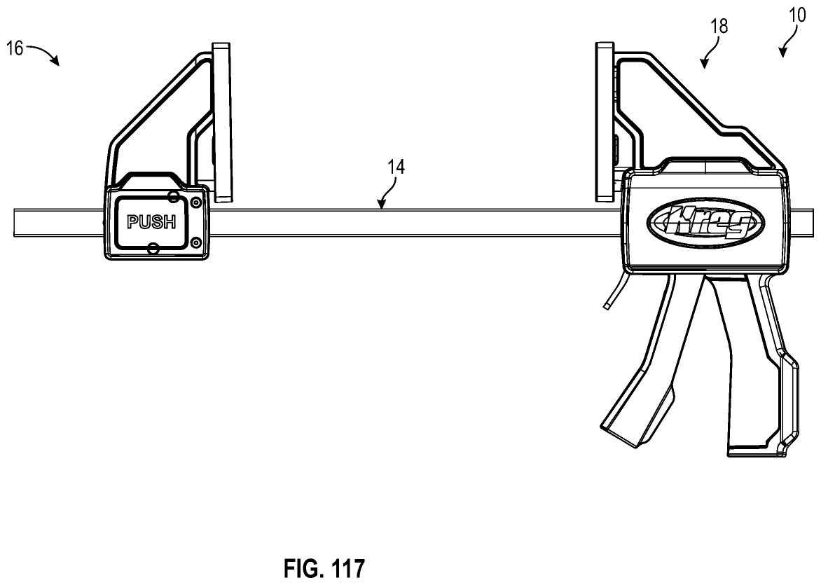

FIG. 118 shows a top perspective view of a bar clamp assembly; the view showing an end stop assembly and a handle assembly located on an elongated bar facing each other to facilitate clamping.

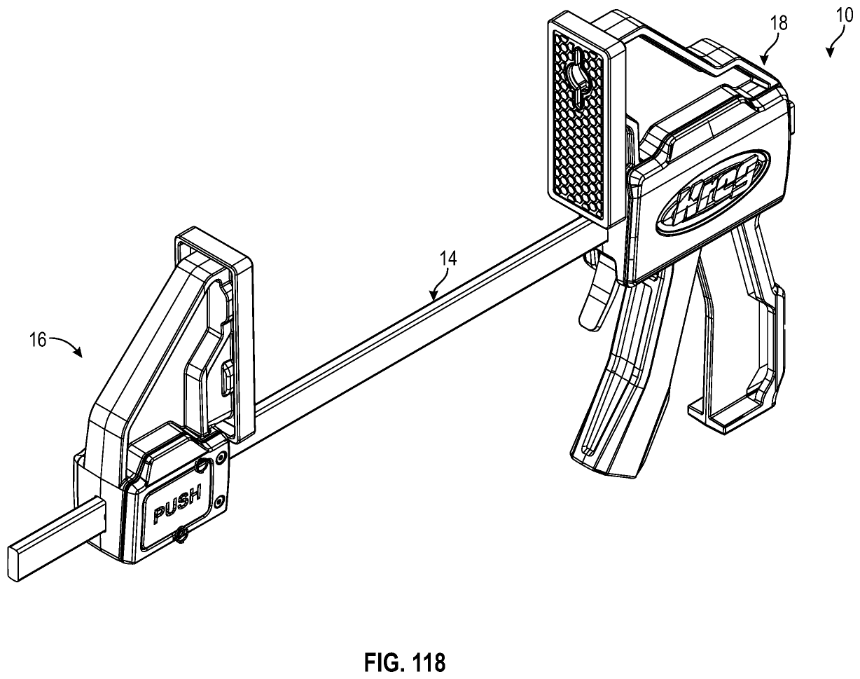

FIG. 119 shows a top perspective view of a bar clamp assembly; the view showing an end stop assembly and a handle assembly located on an elongated bar facing each other to facilitate clamping.

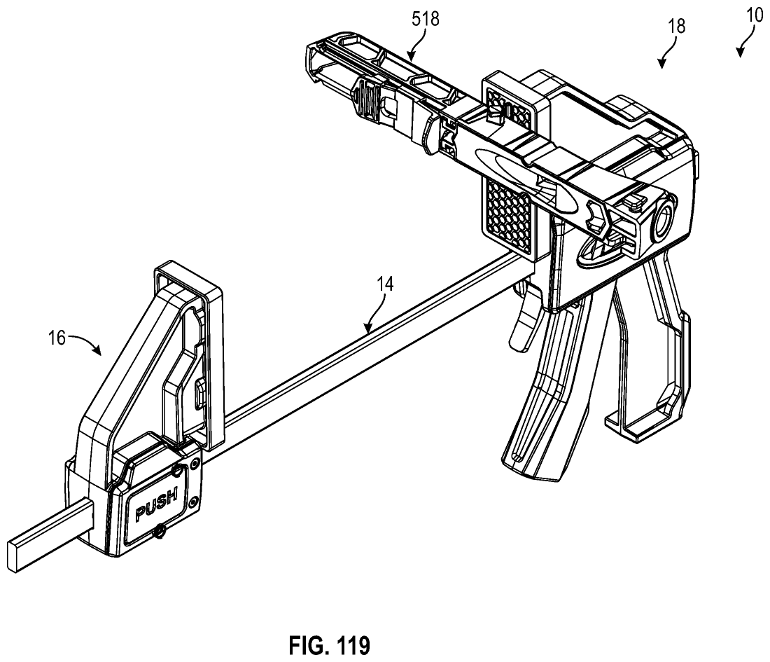

FIG. 120 shows a top elevation view of a bar clamp assembly; the view showing an end stop assembly and a handle assembly located on an elongated bar facing each other to facilitate clamping.

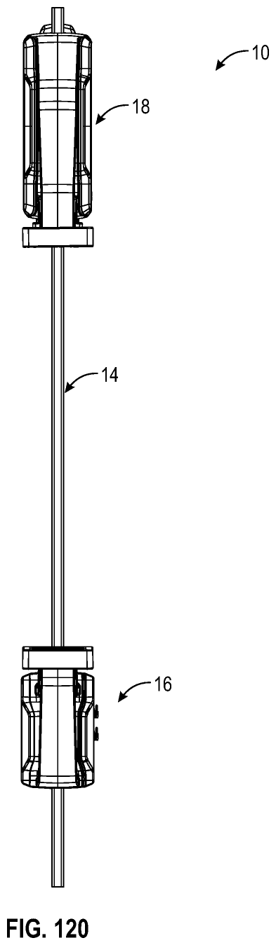

FIG. 121 shows a bottom elevation view of a bar clamp assembly; the view showing an end stop assembly and a handle assembly located on an elongated bar facing each other to facilitate clamping.

FIG. 122 shows a perspective view of an end stop assembly; the view showing the end stop assembly having a main body, the main body comprising an actuator and an opening for an elongated bar to be inserted; the view also showing the end stop assembly having a clamp arm, a clamp plate, and a cover plate.

FIG. 123 shows an alternate perspective view of an end stop assembly; the view showing the end stop assembly having a main body, the main body comprising an opening for an elongated bar to be inserted; the view also showing the end stop assembly having a clamp arm, a clamp plate, and a cover plate.

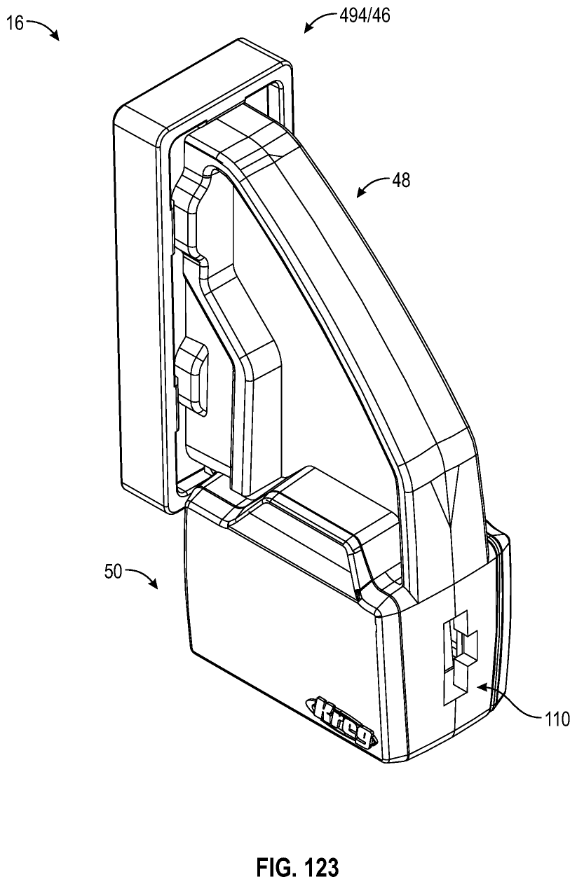

FIG. 124 shows a back elevation view of an end stop assembly; the view showing the end stop assembly having a main body, the main body comprising an opening for an elongated bar to be inserted; the view also showing the end stop assembly having a clamp arm, a clamp plate, and a cover plate.

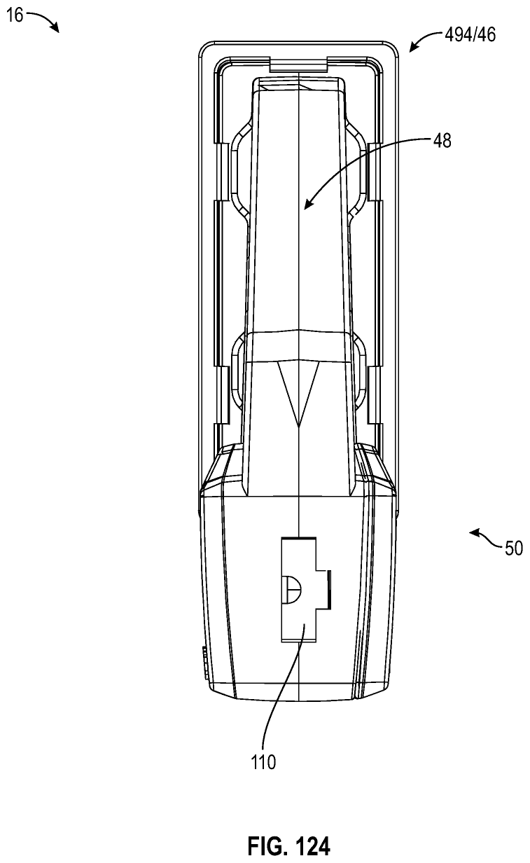

FIG. 125 shows a front perspective view of an end stop assembly; the view showing the end stop assembly having a main body, the main body comprising an opening for an elongated bar to be inserted; the view also showing the end stop assembly having a clamp arm, a clamp plate, and a cover plate.

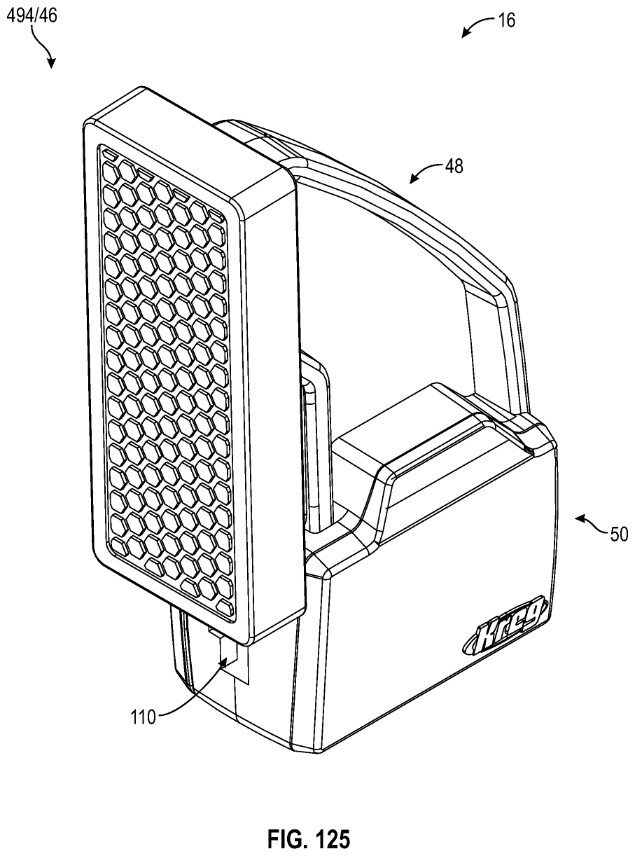

FIG. 126 shows a front perspective view of an end stop assembly; the view showing the end stop assembly having a main body, the main body comprising an actuator and an opening for an elongated bar to be inserted; the view also showing the end stop assembly having a clamp arm, a clamp plate, and a cover plate

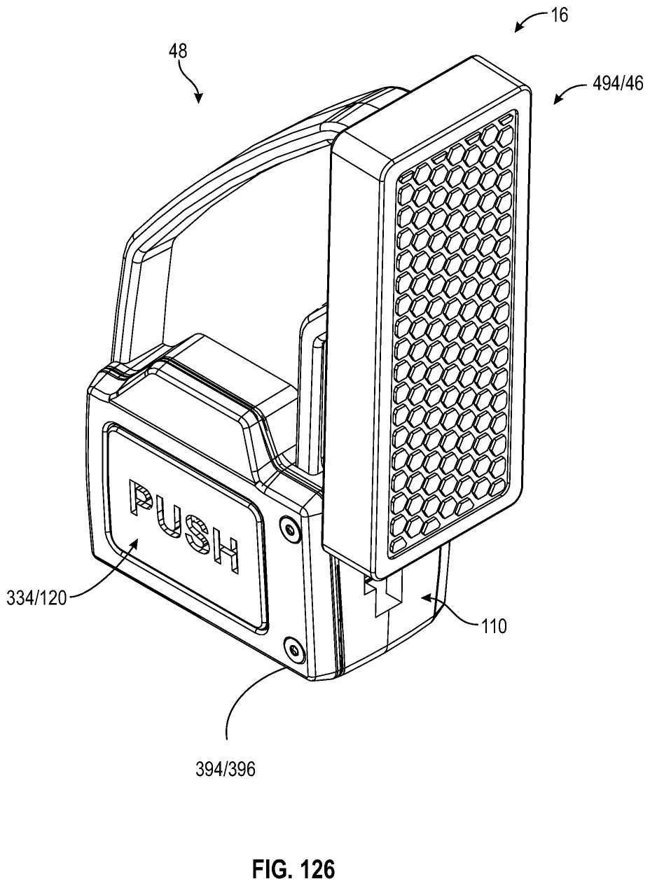

FIG. 127 shows a front perspective view of an end stop assembly; the view showing the end stop assembly having a main body, the main body comprising an opening for an elongated bar to be inserted; the view also showing the end stop assembly having a clamp arm, a clamp plate, and a cover plate.

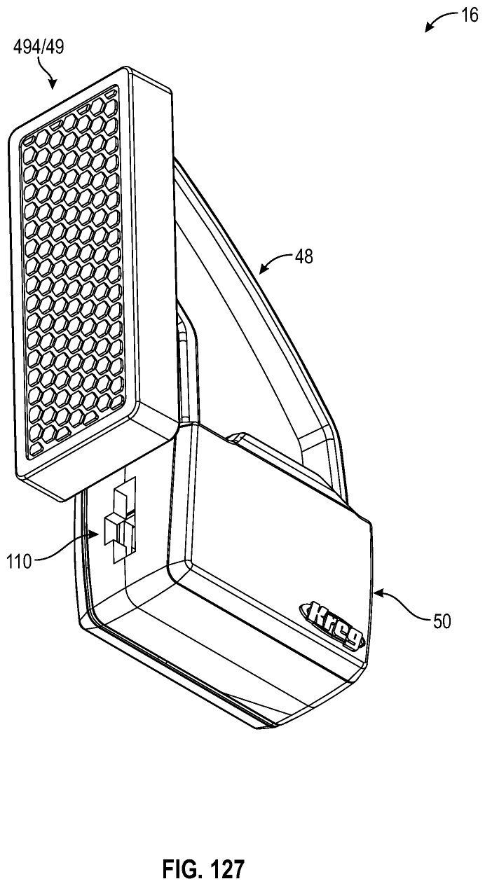

FIG. 128 shows a back perspective view of an end stop assembly; the view showing the end stop assembly having a main body, the main body comprising an opening for an elongated bar to be inserted; the view also showing the end stop assembly having a clamp arm, a clamp plate, and a cover plate.

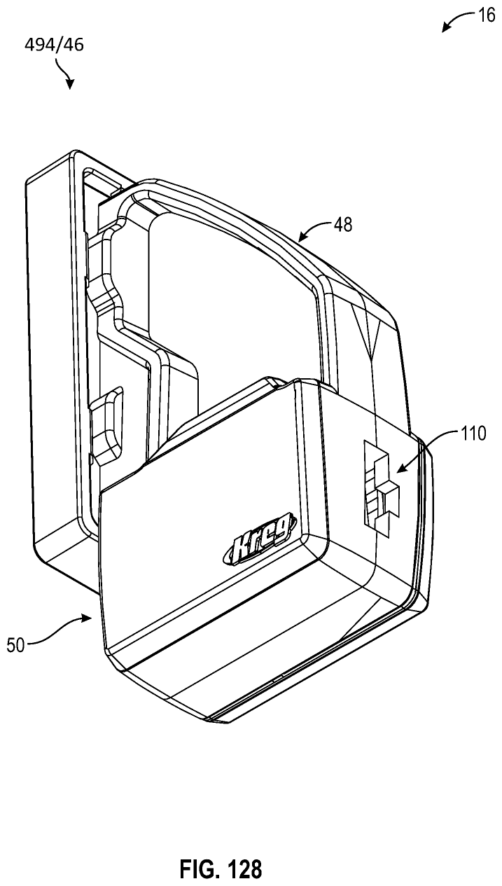

FIG. 129 shows a front perspective view of an end stop assembly; the view showing the end stop assembly having a main body, the main body comprising an actuator and an opening for an elongated bar to be inserted; the view also showing the end stop assembly having a clamp arm, a clamp plate, and a cover plate.

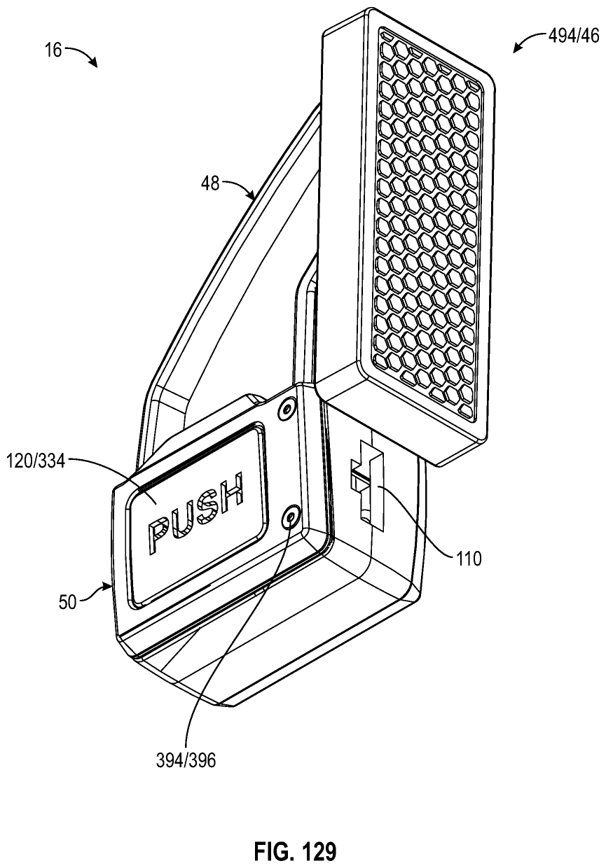

FIG. 130 shows a back perspective view of an end stop assembly; the view showing the end stop assembly having a main body, the main body comprising an actuator and an opening for an elongated bar to be inserted; the view also showing the end stop assembly having a clamp arm, a clamp plate, and a cover plate.

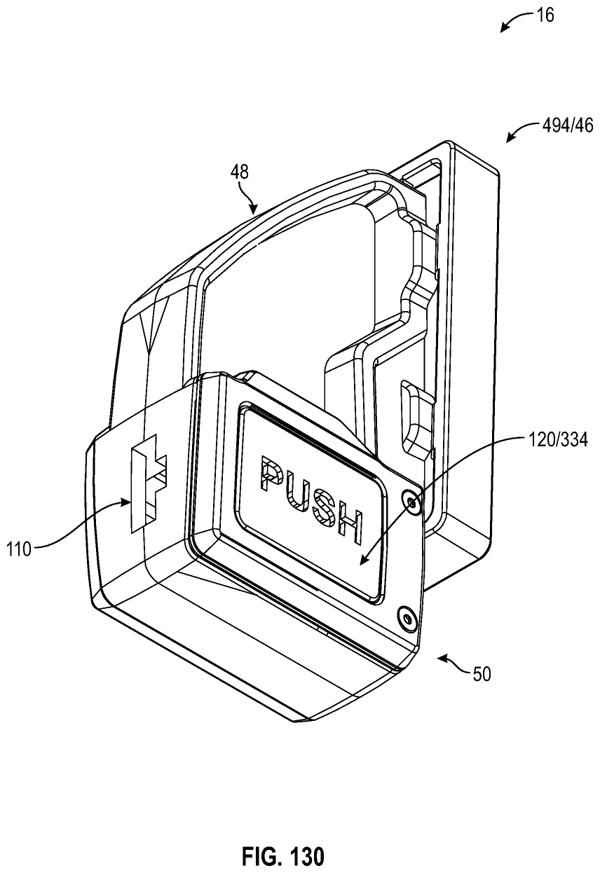

FIG. 131 shows a side elevation view of an end stop assembly; the view showing the end stop assembly having a main body, a clamp arm connected to the main body, a clamp plate connected to the clamp arm, and a cover plate connected to the clamp plate.

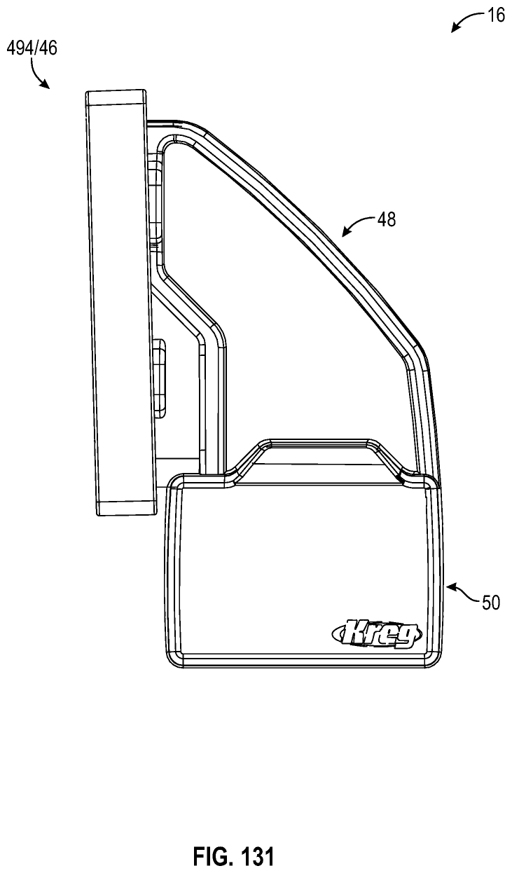

FIG. 132 shows an exploded view of an end stop assembly; the view showing the end stop assembly having a main body, the main body comprising an actuator, a cover, and an opening to facilitate insertion of an elongated member; the view also showing the end stop assembly having a clamp arm and a clamp plate.

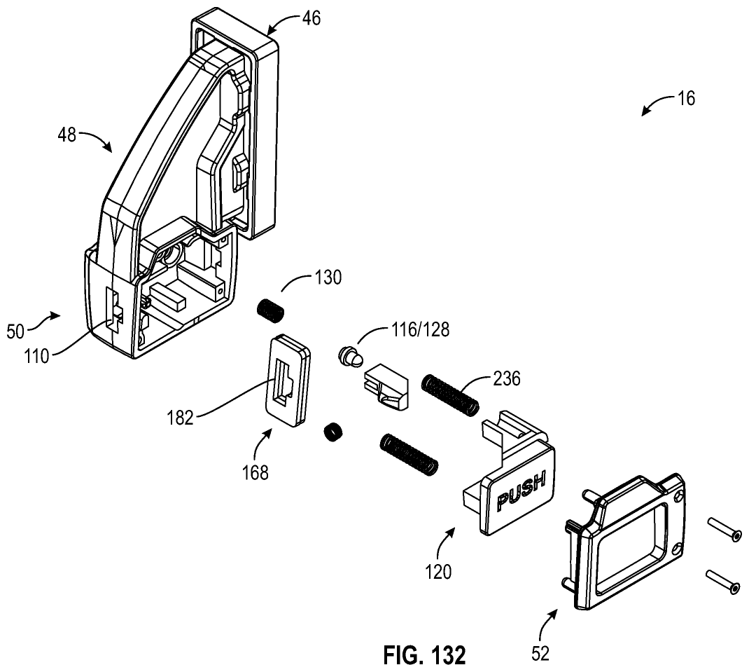

FIG. 133 shows a cut away view of an end stop assembly; the view showing the end stop assembly having a main body, the main body having an opening to facilitate the insertion of an elongated bar; the view also showing the end stop assembly having a clamp arm and a clamp plate.

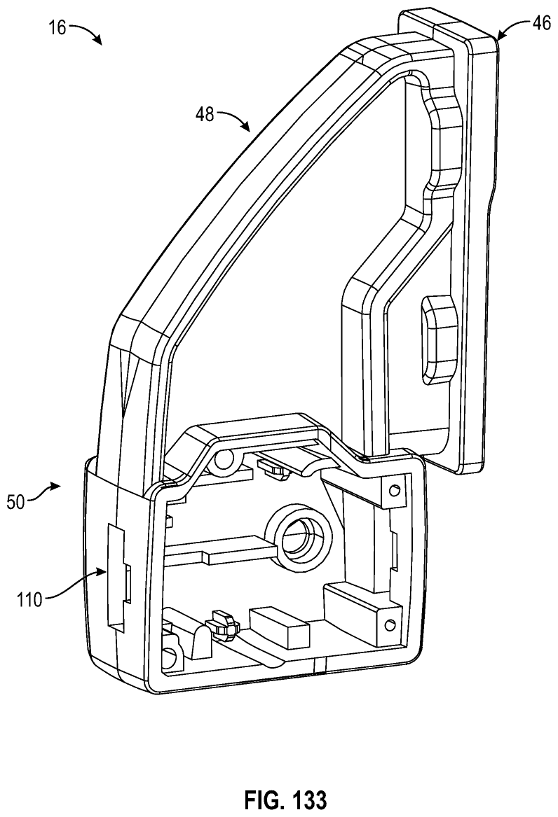

FIG. 134 shows a front perspective view of an end stop assembly; the view showing the end stop assembly having a main body, the main body having an opening to facilitate the insertion of an elongated bar; the view also showing the end stop assembly having a clamp arm and a clamp plate.

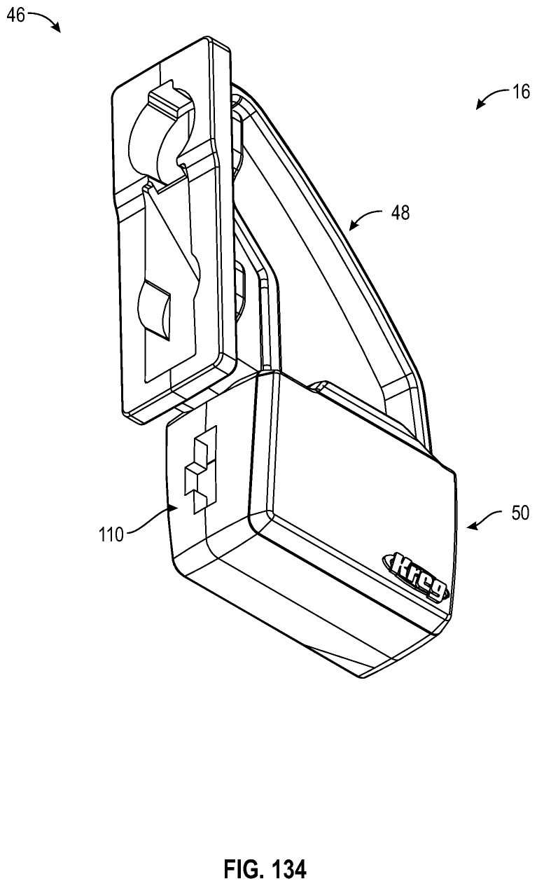

FIG. 135 shows a front perspective view of an end stop assembly; the view showing the end stop assembly having a main body, the main body having an opening to facilitate the insertion of an elongated bar; the view also showing the end stop assembly having a clamp arm and a clamp plate.

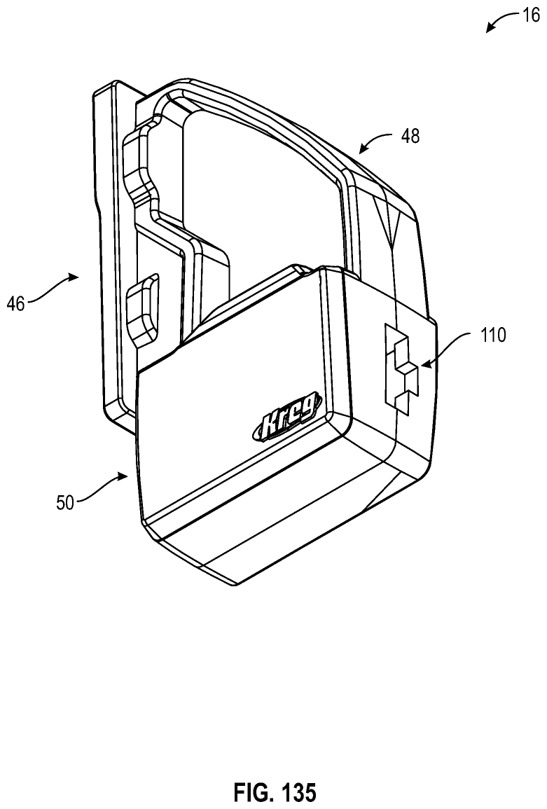

FIG. 136 shows a cut away view of an end stop assembly; the view showing the end stop assembly having a main body, the main body having an opening to facilitate the insertion of an elongated bar; the view also showing the end stop assembly having a clamp arm and a clamp plate.

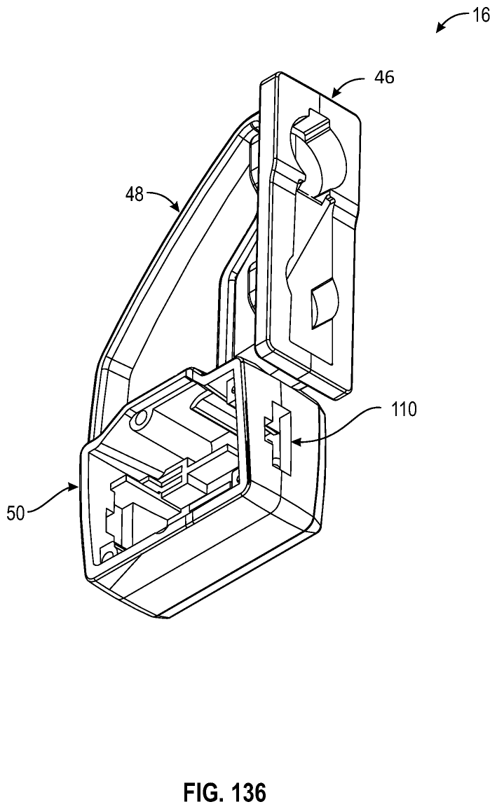

FIG. 137 shows an alternative cut away view of an end stop assembly; the view showing the end stop assembly having a main body, the main body having an opening to facilitate the insertion of an elongated bar; the view also showing the end stop assembly having a clamp arm and a clamp plate.

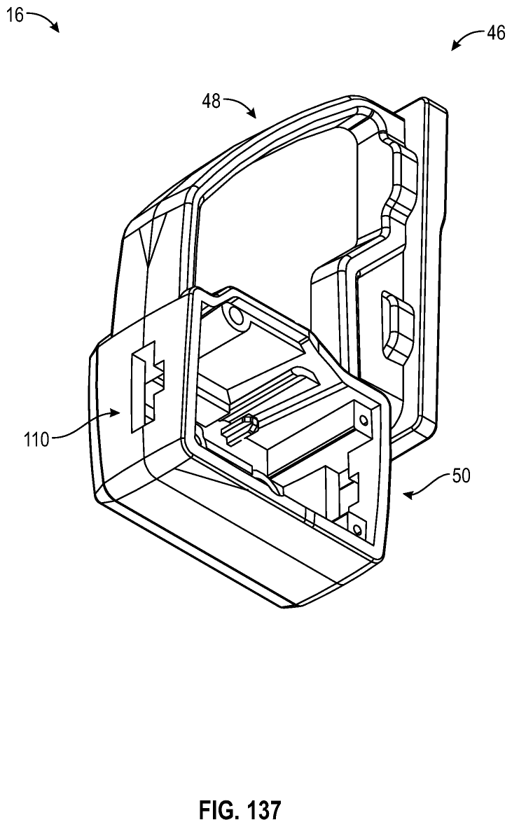

FIG. 138 shows a bottom elevation view of an end stop assembly; the view showing the end stop assembly having a main body and a clamp plate.

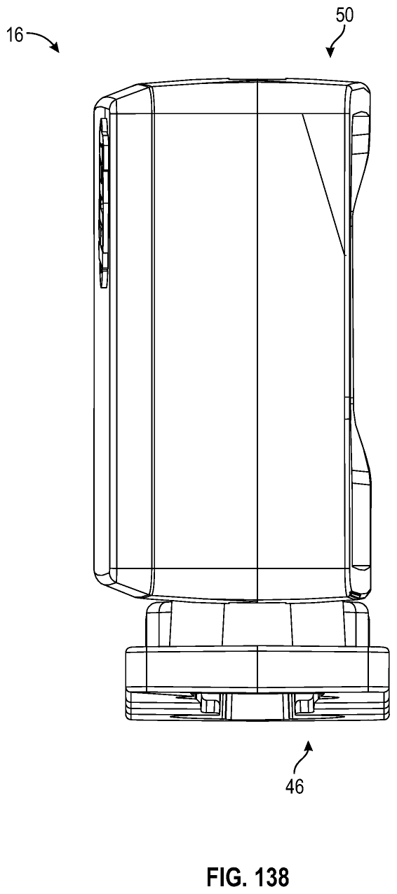

FIG. 139 shows a cut away view of an end stop assembly; the view showing the end stop assembly having a main body, a clamp arm, and a clamp plate.

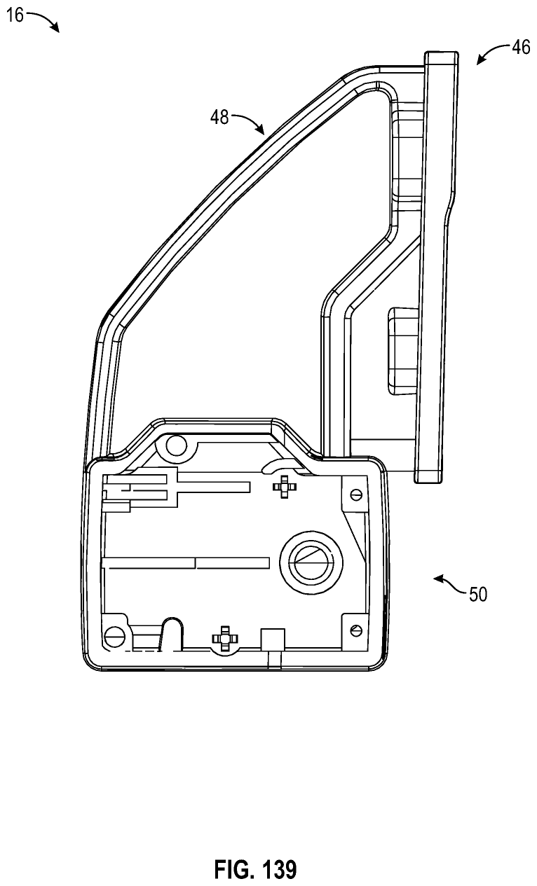

FIG. 140 shows a front elevation view of an end stop assembly; the view showing the end stop assembly having a main body, the main body having an opening to facilitate the insertion of an elongated bar; the view also showing the end stop assembly having a clamp plate.

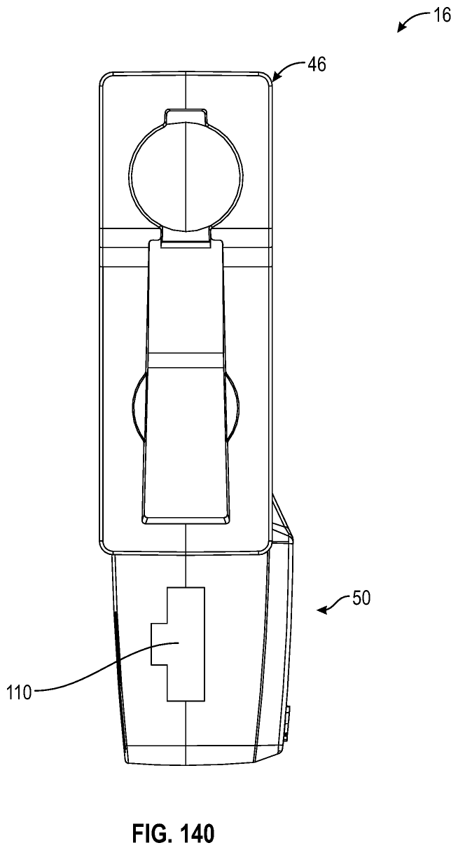

FIG. 141 shows a back elevation view of an end stop assembly; the view showing the end stop assembly having a main body, the main body having an opening to facilitate the insertion of an elongated bar; the view also showing the end stop assembly having a clamp arm and a clamp plate.

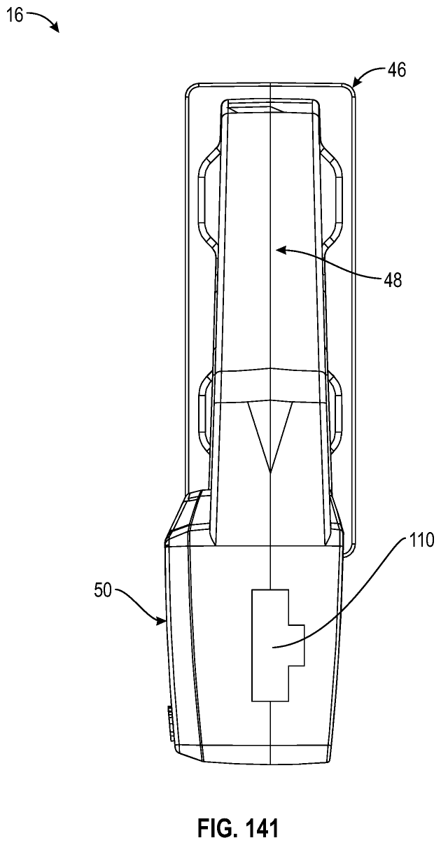

FIG. 142 shows a perspective view of an end stop assembly; the view showing the end stop assembly having a main body, the main body having an opening to facilitate the insertion of an elongated bar; the view also showing the end stop assembly having a clamp arm and a clamp plate.

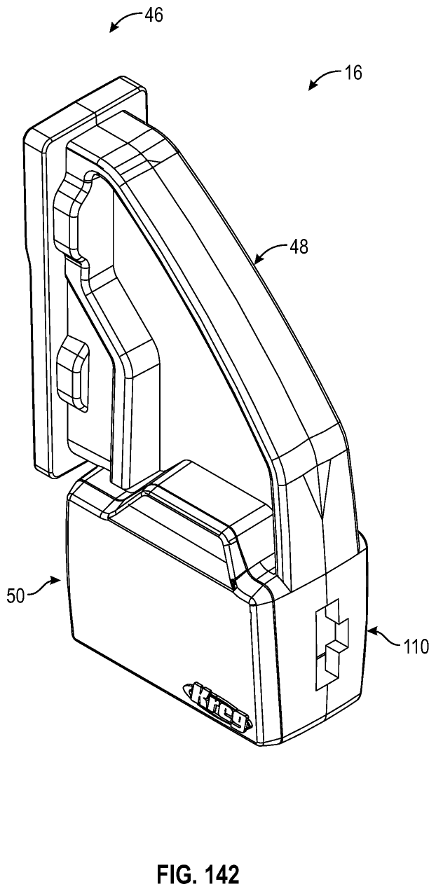

FIG. 143 shows a cut away view of an end stop assembly; the view showing the end stop assembly having a main body, the main body having an opening to facilitate the insertion of an elongated bar; the view also showing the end stop assembly having a clamp arm and a clamp plate.

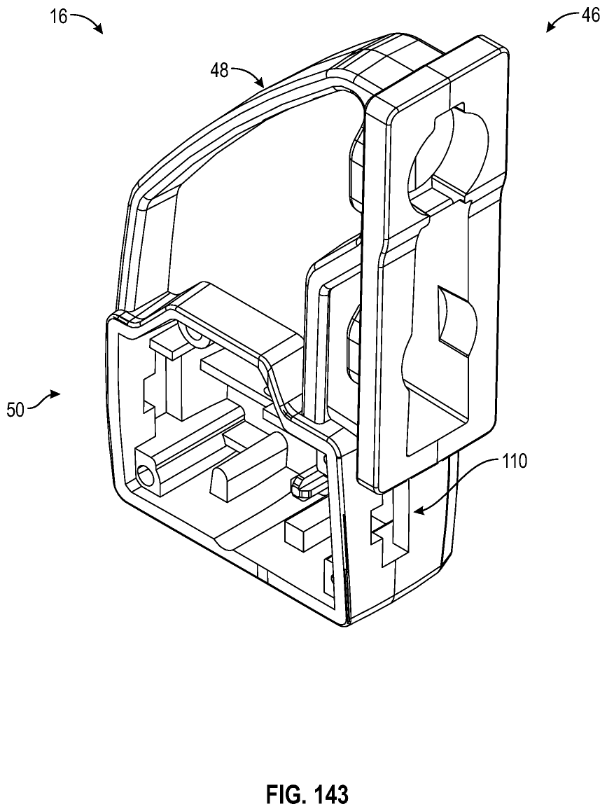

FIG. 144 shows a cut away view of an end stop assembly; the view showing the end stop assembly having a main body, the main body having an opening to facilitate the insertion of an elongated bar; the view also showing the end stop assembly having a clamp arm and a clamp plate.

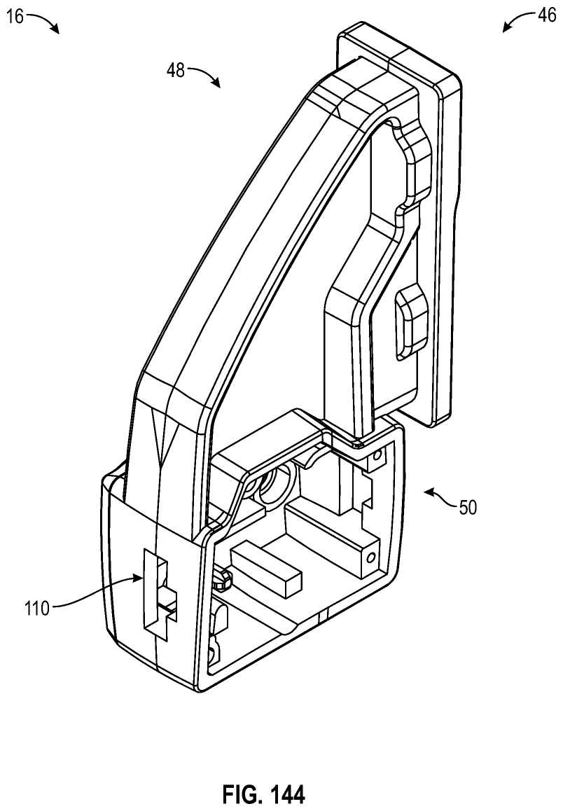

FIG. 145 shows a top elevation view of an end stop assembly; the view showing the end stop assembly having a main body, a clamp arm connected to the main body, and a clamp plate connected to the clamp arm.

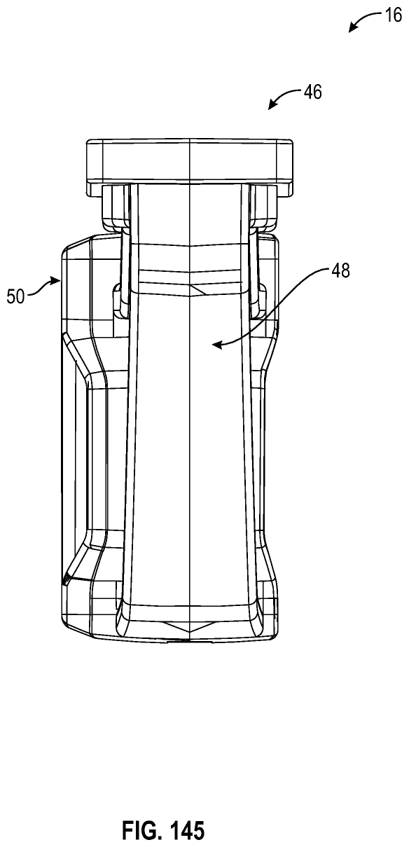

FIG. 146 shows a bottom elevation view of an end stop assembly; the view showing the end stop assembly having a main body, a clamp arm connected to the main body, and a clamp plate connected to the clamp arm.

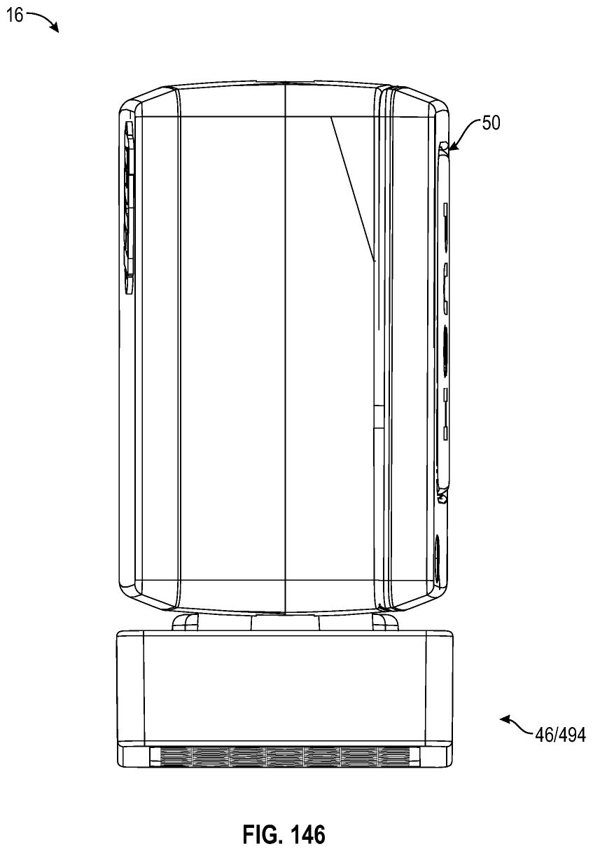

FIG. 147 shows a side elevation view of an end stop assembly; the view showing the end stop assembly having a main body, a clamp arm connected to the main body, a clamp plate connected to the clamp arm, and a cover plate connected to the clamp plate.

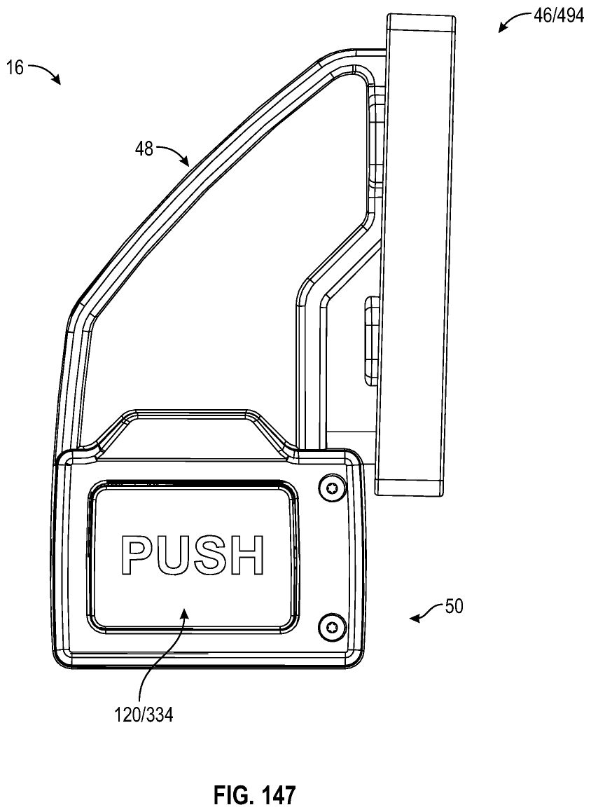

FIG. 148 shows a front elevation view of a clutch plate; the view showing the clutch plate having an opening in the center.

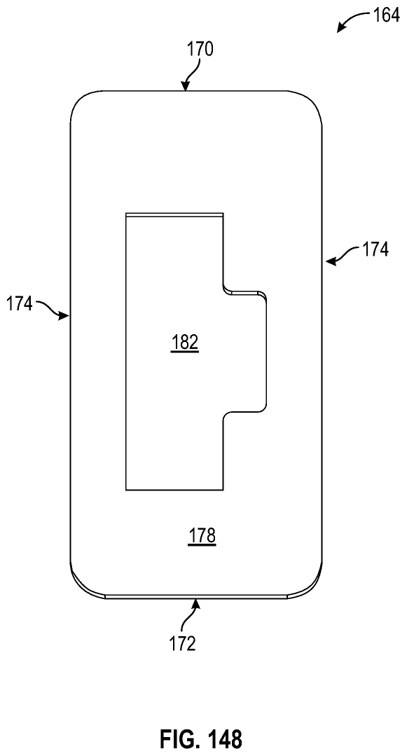

FIG. 149 shows a top elevation view of a clutch plate; the view showing the clutch plate having an opening in the center.

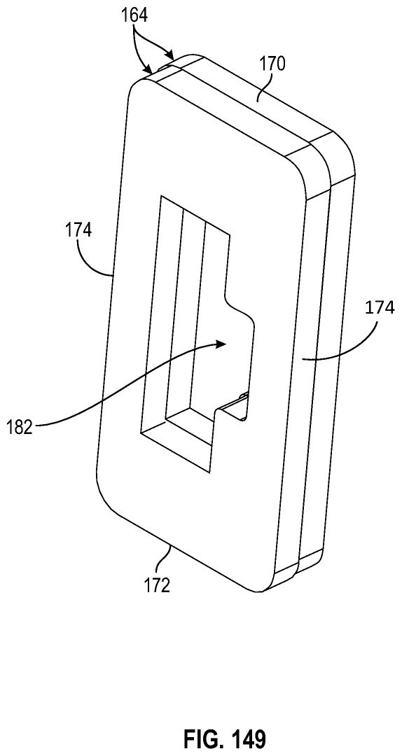

FIG. 150 shows a front elevation view of an actuator of an end stop assembly; the actuator having a top surface, a bottom surface, a forward end, and a rear surface.

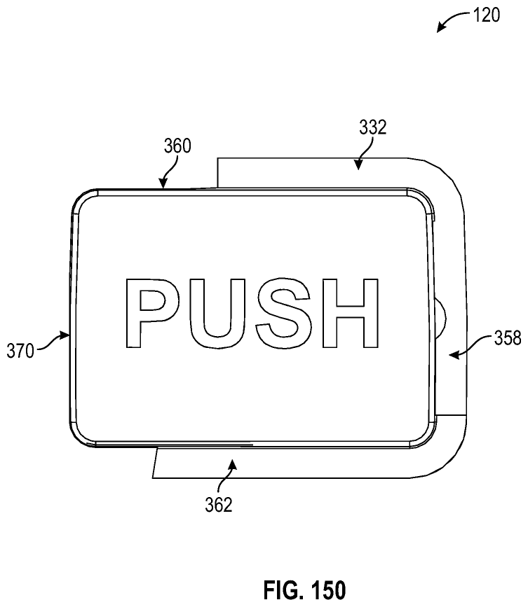

FIG. 151 shows a perspective view of an actuator of an end stop assembly; the view showing the actuator having an inner portion, the inner portion having a bottom surface; the view showing a recessed track and a recessed channel located on the bottom surface; the view showing the inner portion having a lock-side sidewall wherein an opening is located on the lock-side sidewall.

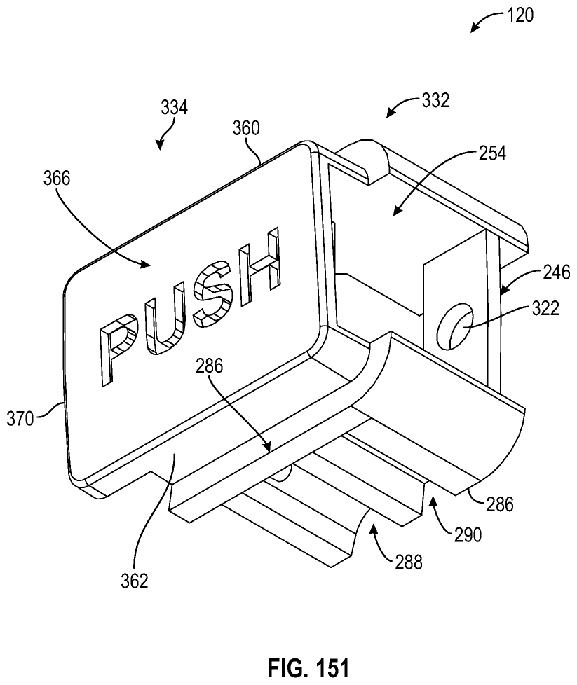

FIG. 152 shows a front perspective view of an actuator of an end stop assembly; the view showing the actuator having an inner portion, the inner portion having a bottom member with a connection feature.

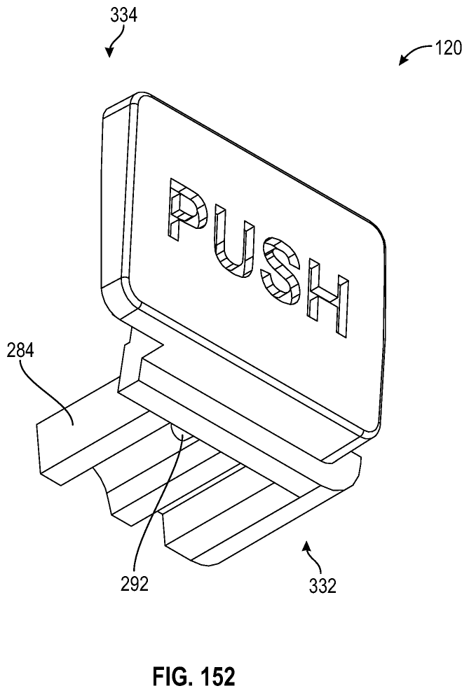

FIG. 153 shows a back perspective view of an actuator of an end stop assembly; the view showing the actuator having an inner portion, the inner portion having a bottom member with a connection feature, a recessed channel, and a recessed track; the view showing the inner portion having a lock-side sidewall and an opening within the lock-side sidewall.

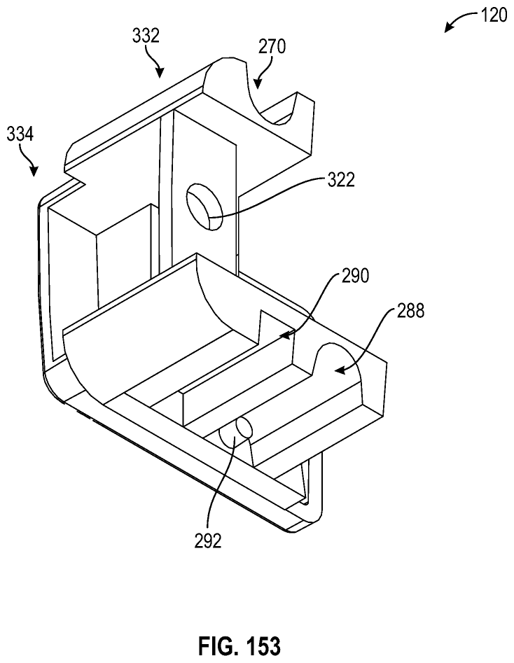

FIG. 154 shows a back perspective view of the actuator of FIG. 151.

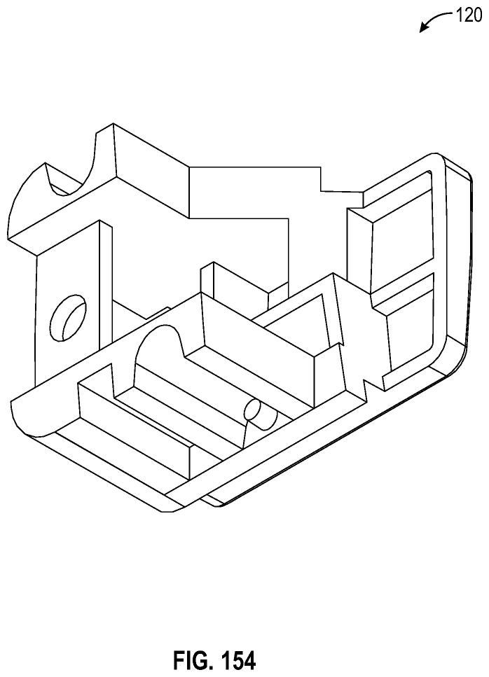

FIG. 155 shows a bottom elevation view of the actuator of FIG. 151.

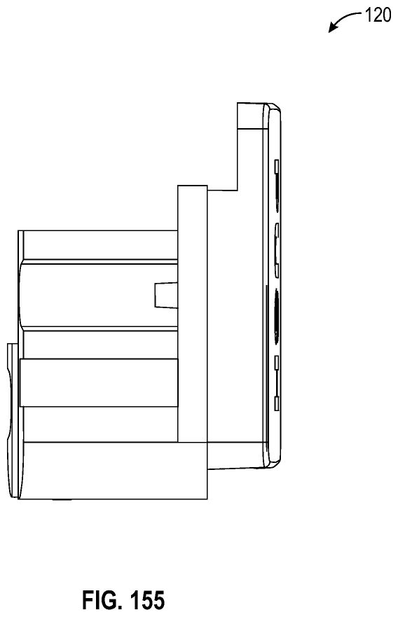

FIG. 156 shows a front elevation view of the actuator of FIG. 151.

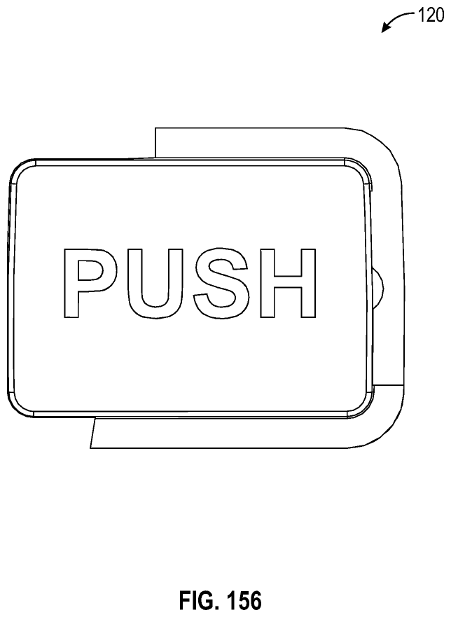

FIG. 157 shows a side elevation view of the actuator of FIG. 151.

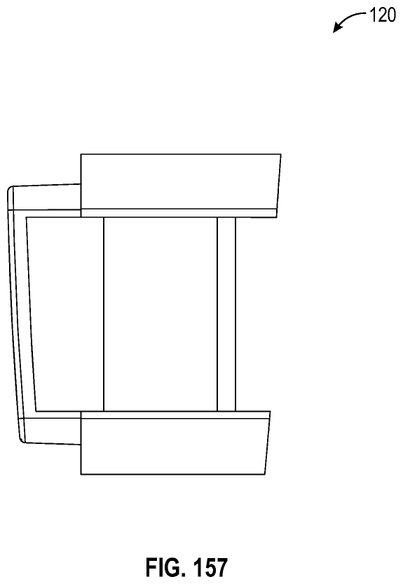

FIG. 158 shows an alternative side elevation view of the actuator of FIG. 151.

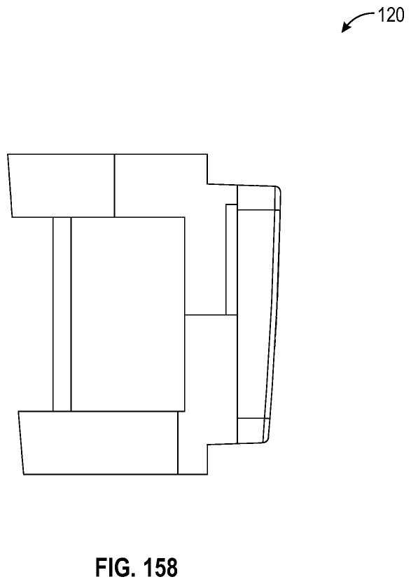

FIG. 159 shows a top perspective view of the actuator of FIG. 151.

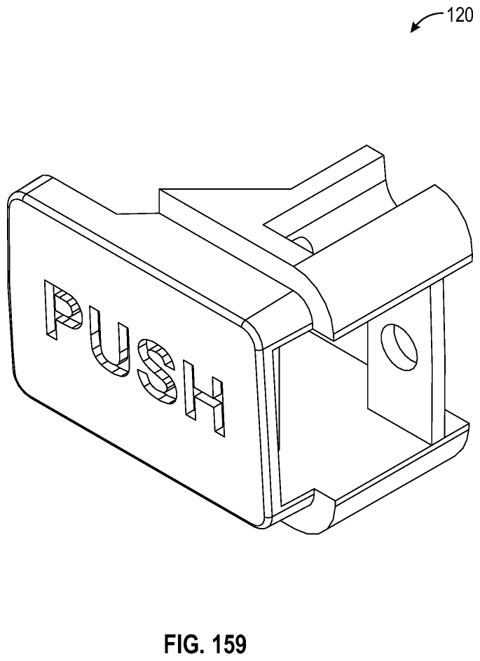

FIG. 160 shows a back perspective view of the actuator of FIG. 151; the view showing the actuator having an inner portion, the inner portion having a top member with a recessed channel; the recessed channel housing a connection feature.

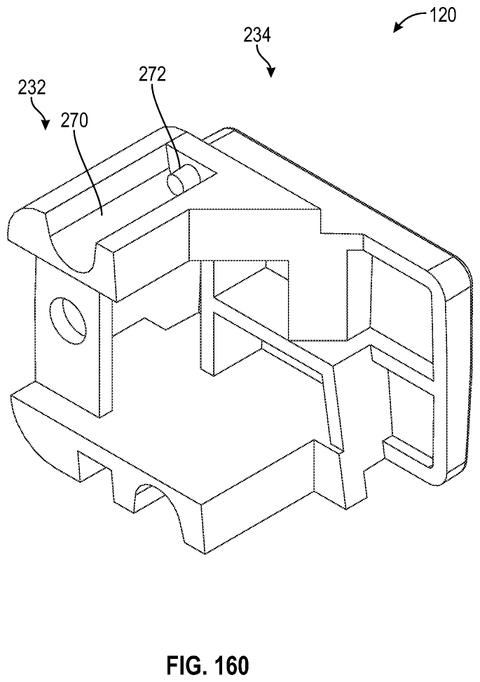

FIG. 161 shows a top perspective view of the actuator of FIG. 151.

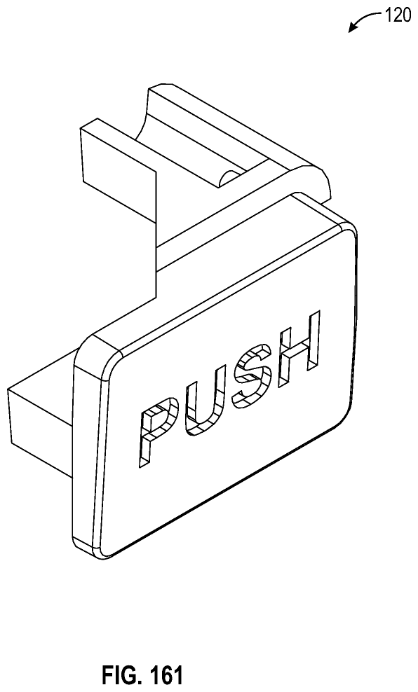

FIG. 162 shows a top elevation view of the actuator of FIG. 151.

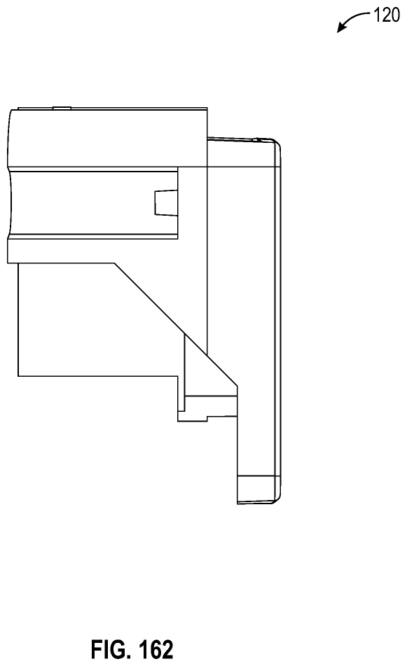

FIG. 163 shows a side elevation view of an end stop assembly; the view showing the end stop assembly having a main body, a clamp arm, a clamp plate and a cover plate; the view a connection assembly configured to facilitate connection of the cover plate; the view showing the cover plate having an opening and the clamp plate having a storage compartment.

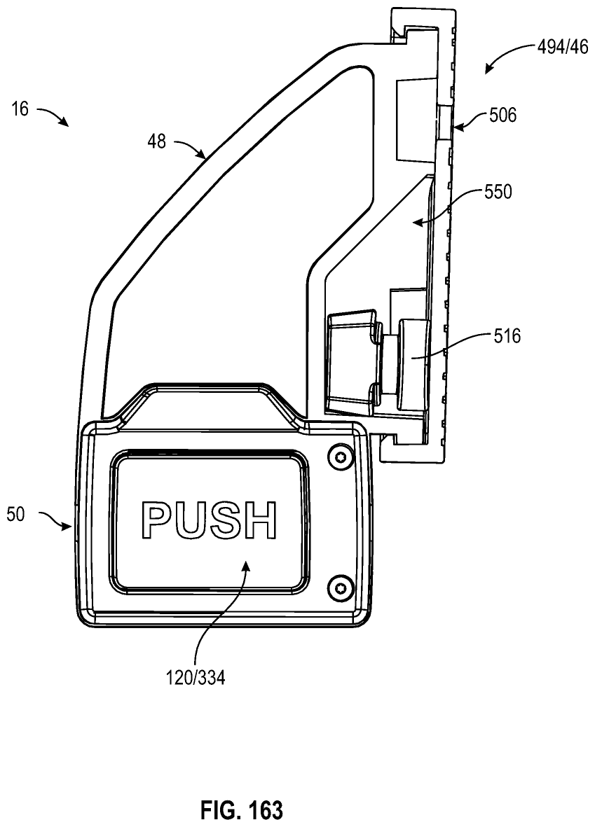

FIG. 164 shows a bottom perspective view of a cover of the end stop assembly; the view showing the cover having an opening for housing an actuator.

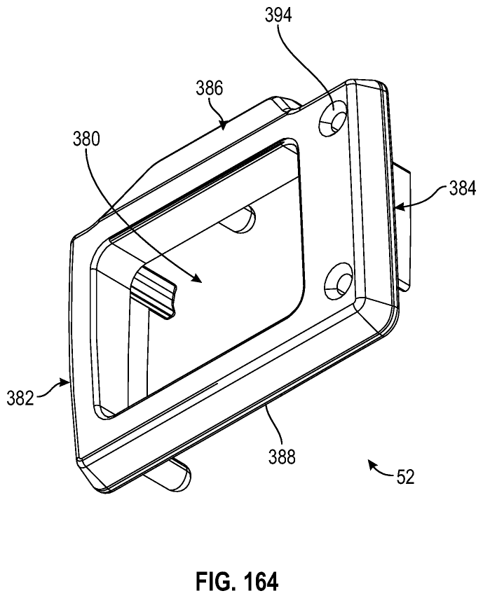

FIG. 165 shows a back elevation view of the cover of FIG. 164.

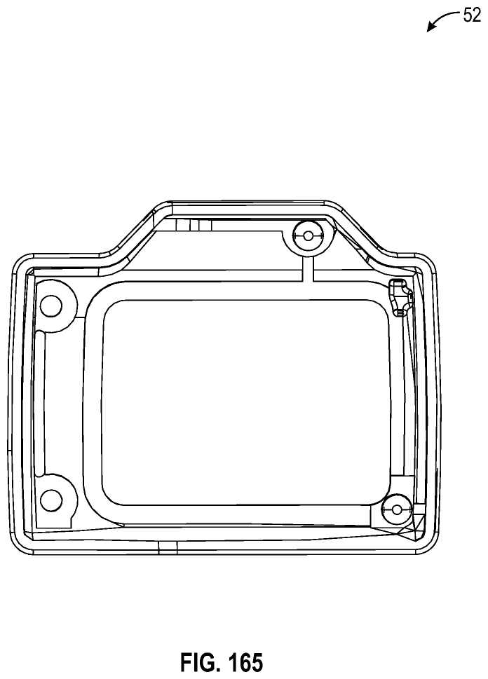

FIG. 166 shows a back perspective view of the cover of FIG. 164.

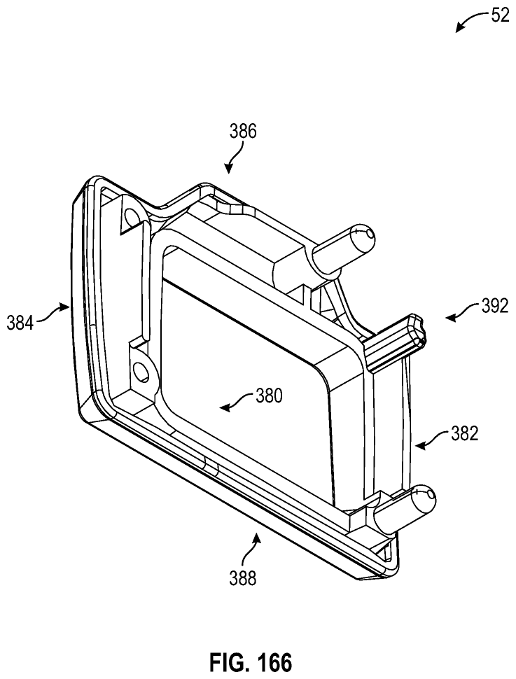

FIG. 167 shows an alternative back perspective view of the cover of FIG. 164.

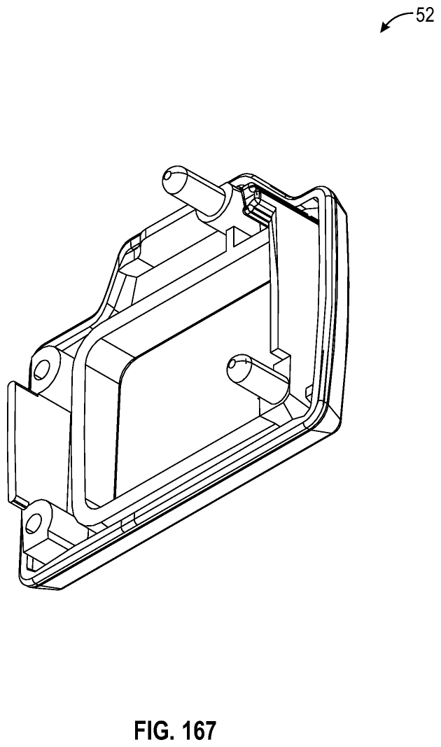

FIG. 168 shows a front perspective view of the cover of FIG. 164.

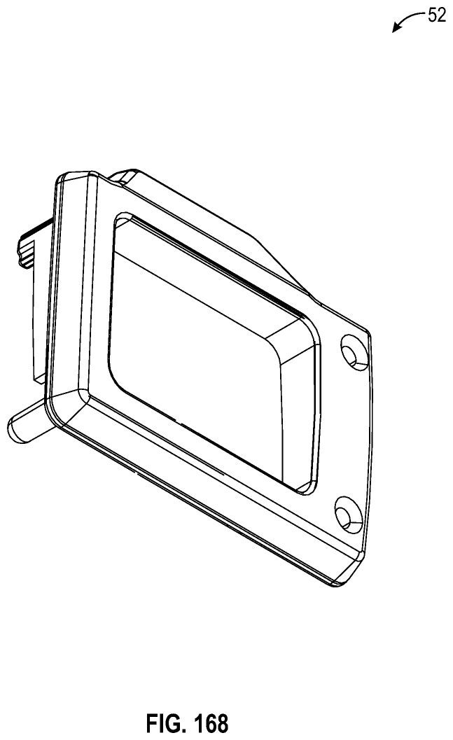

FIG. 169 shows a bottom elevation view of the cover of FIG. 164.

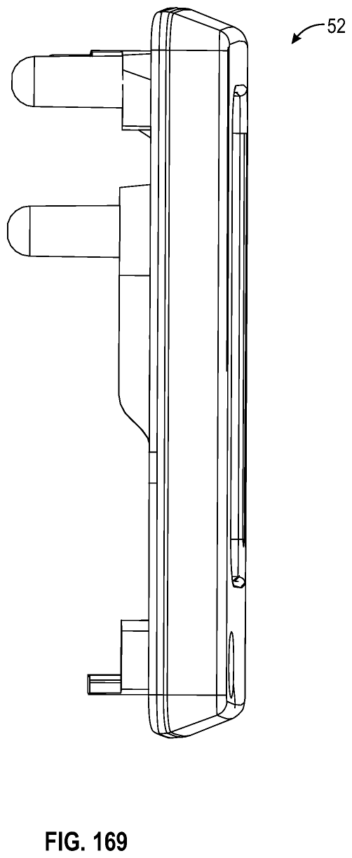

FIG. 170 shows a front elevation view of the cover of FIG. 164.

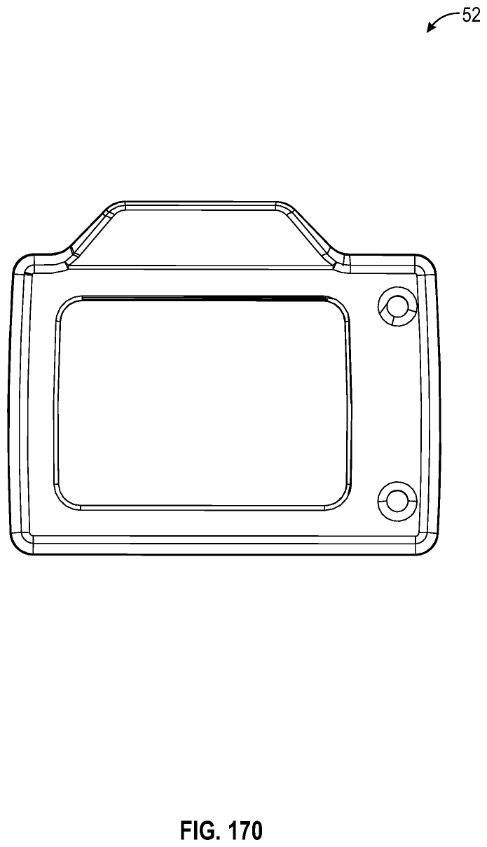

FIG. 171 shows a side elevation view of the cover of FIG. 164.

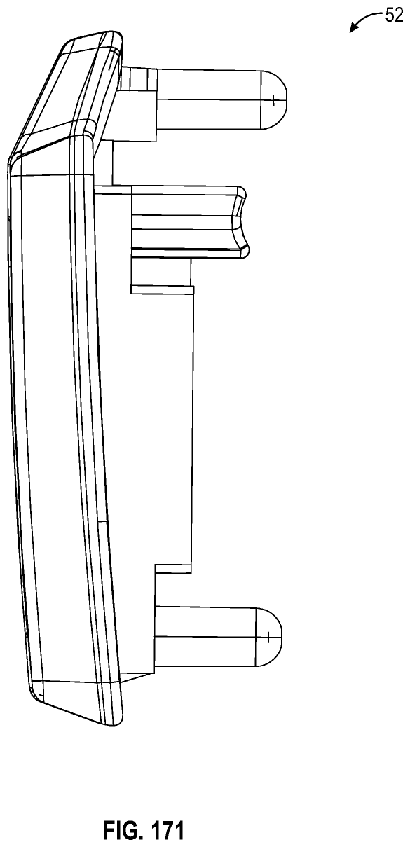

FIG. 172 shows an alternative side elevation view of the cover of FIG. 164.

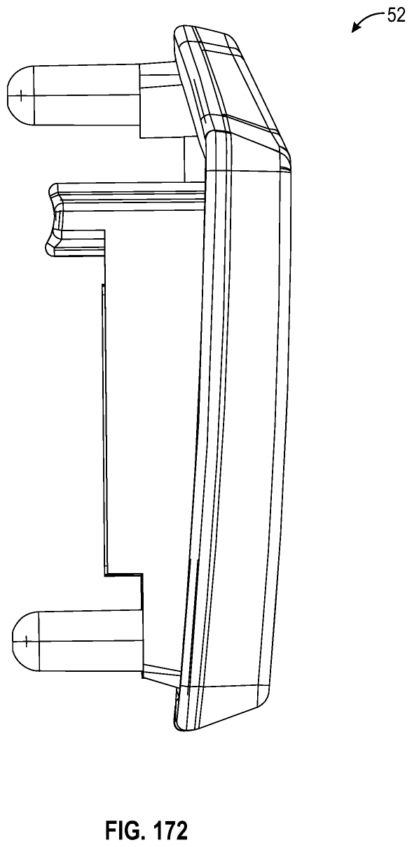

FIG. 173 shows a top perspective view of the cover of FIG. 164.

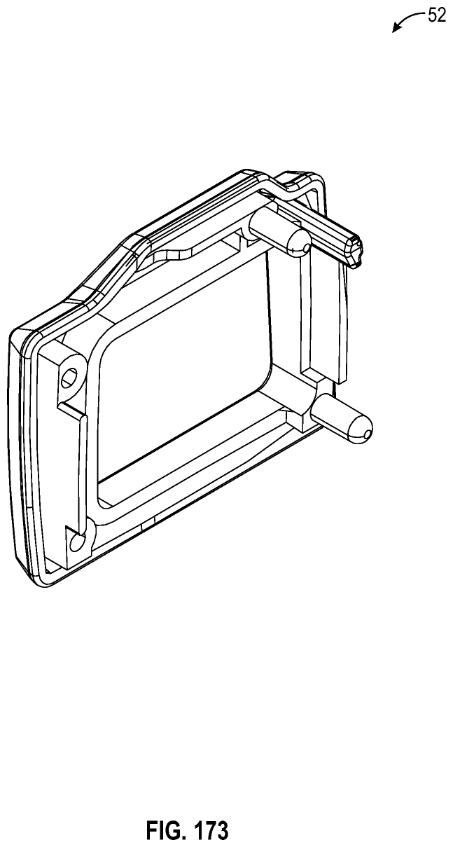

FIG. 174 shows an alternative top perspective view of the cover of FIG. 164.

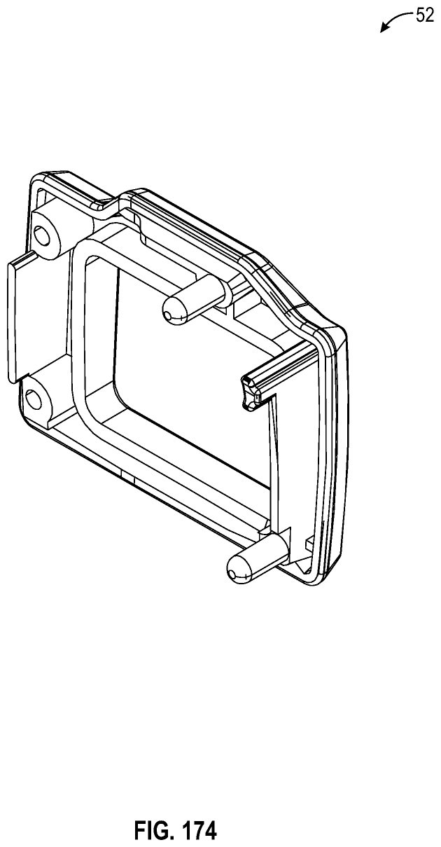

FIG. 175 shows a front perspective view of the cover of FIG. 164.

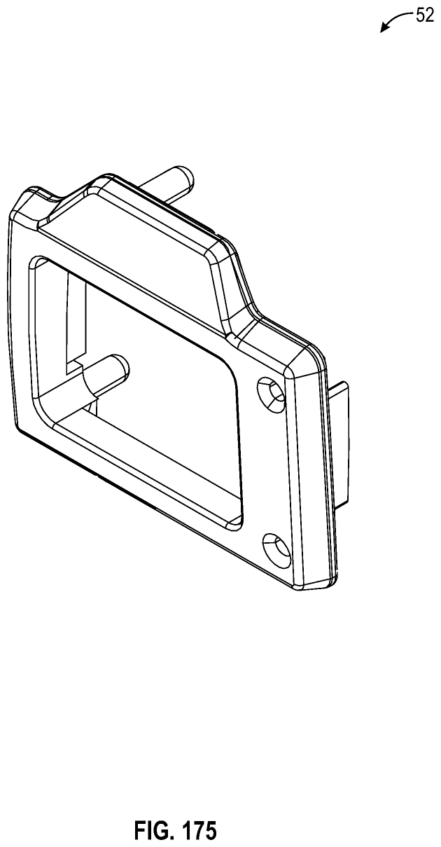

FIG. 176 shows an alternative front perspective view of the cover of FIG. 164.

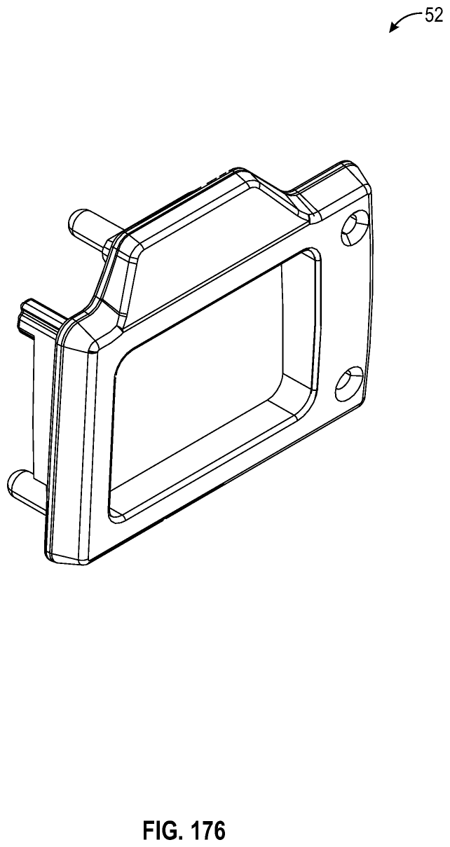

FIG. 177 shows a top elevation view of the cover of FIG. 164.

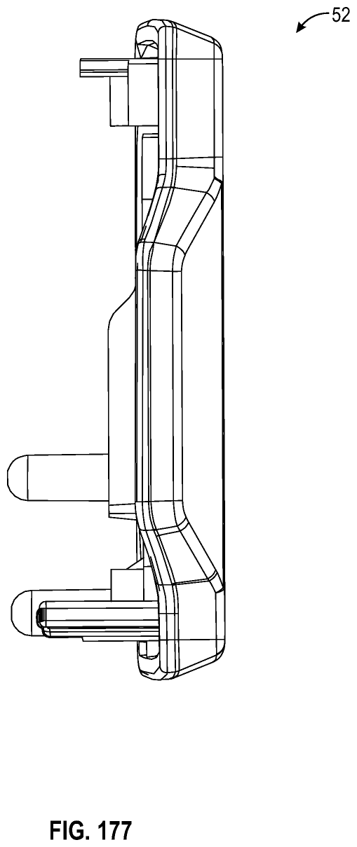

FIG. 178 shows a front elevation view of an end stop assembly; the view showing the end stop assembly having a main body and a clamp plate.

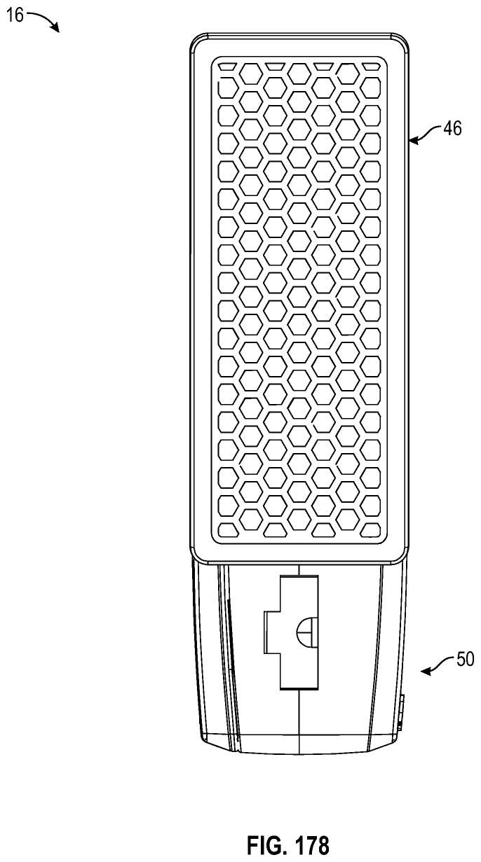

FIG. 179 shows a back elevation view of a cover plate of a clamp plate of an end stop assembly.

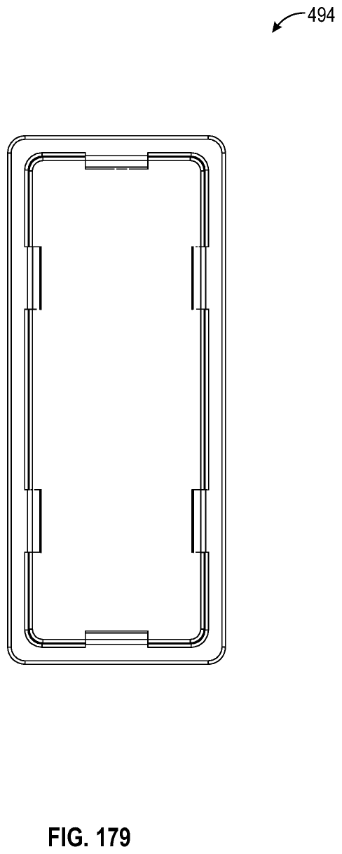

FIG. 180 shows a front elevation view of a cover plate of a clamp plate of an end stop assembly.

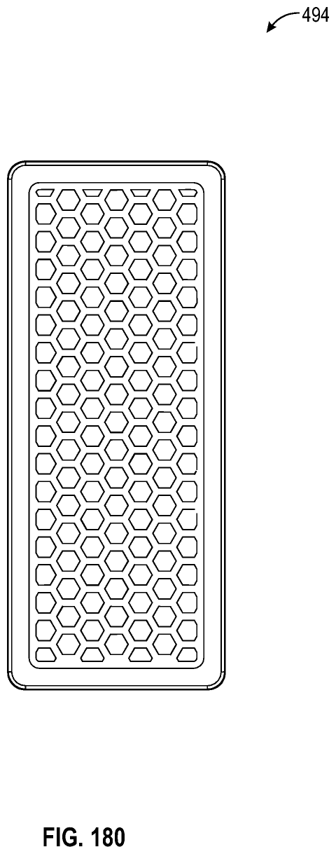

FIG. 181 shows a top perspective view of a cover plate of a clamp plate of an end stop assembly.

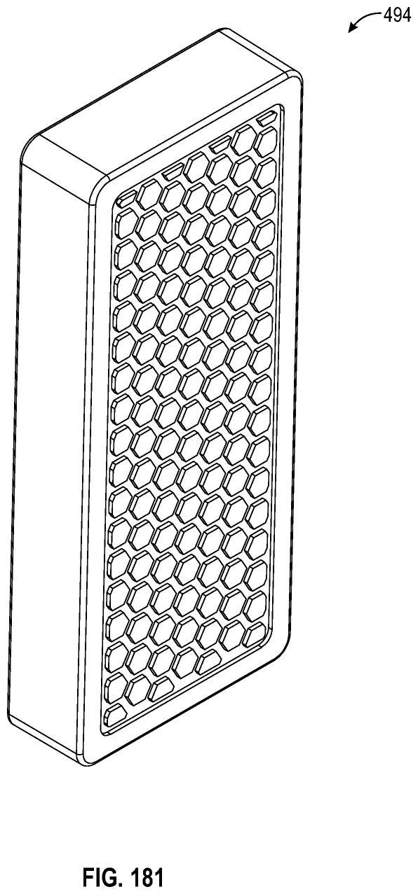

FIG. 182 shows a top elevation view of an end stop assembly; the view showing the end stop assembly having a main body, a clamp arm, a clamp plate, and a cover plate.

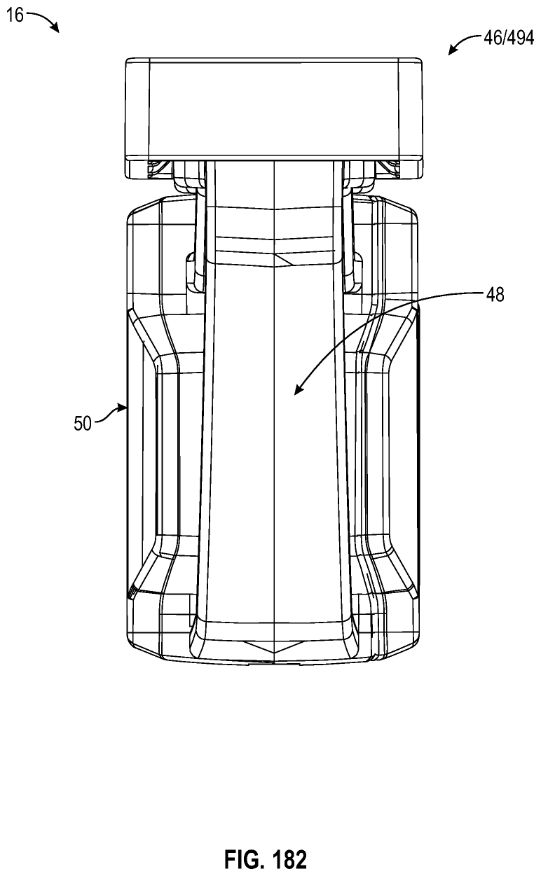

FIG. 183 shows a perspective view of a lock pin of a locking assembly of the end stop assembly

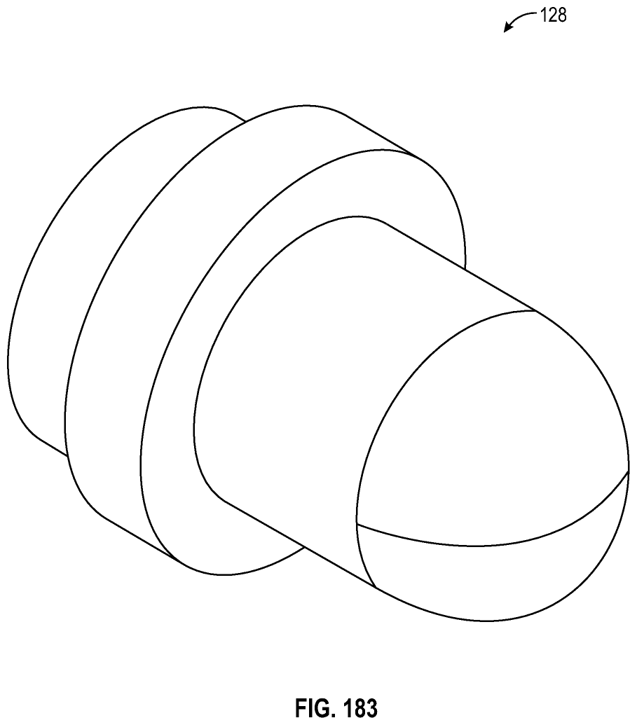

FIG. 184 shows a side elevation view of a lock pin of a locking assembly of the end stop assembly.

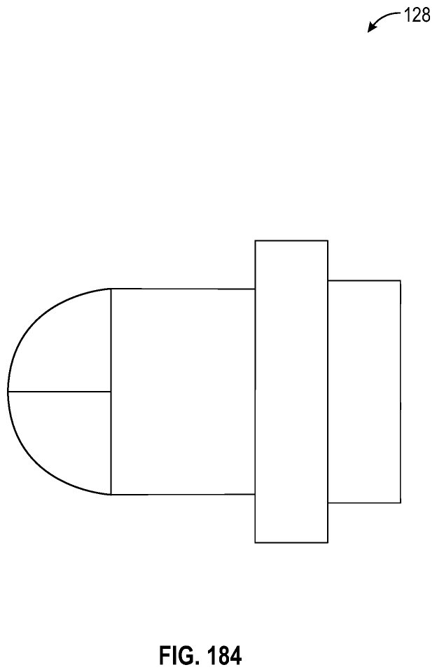

FIG. 185 shows an alternative side elevation view of the lock pin of FIG. 183.

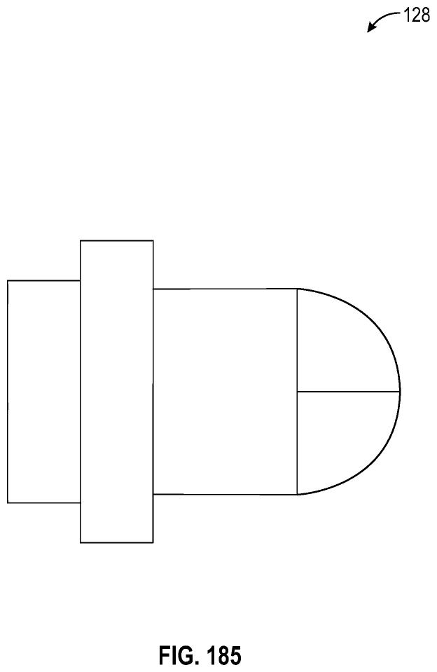

FIG. 186 shows a back elevation view of the lock pin of FIG. 183

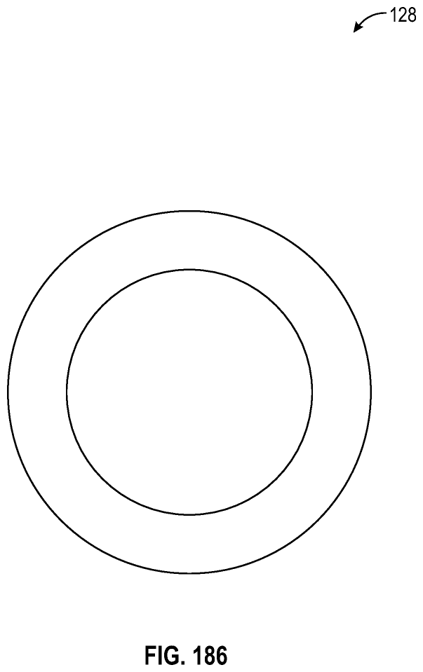

FIG. 187 shows a front elevation view of the lock pin of FIG. 183.

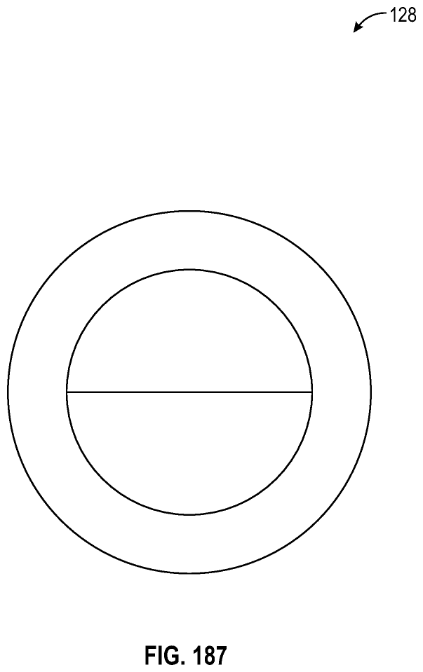

FIG. 188 shows side elevation view of a bar clamp system; the view showing an end stop assembly installed on an elongated bar; the view showing the elongated bar having a stop member.

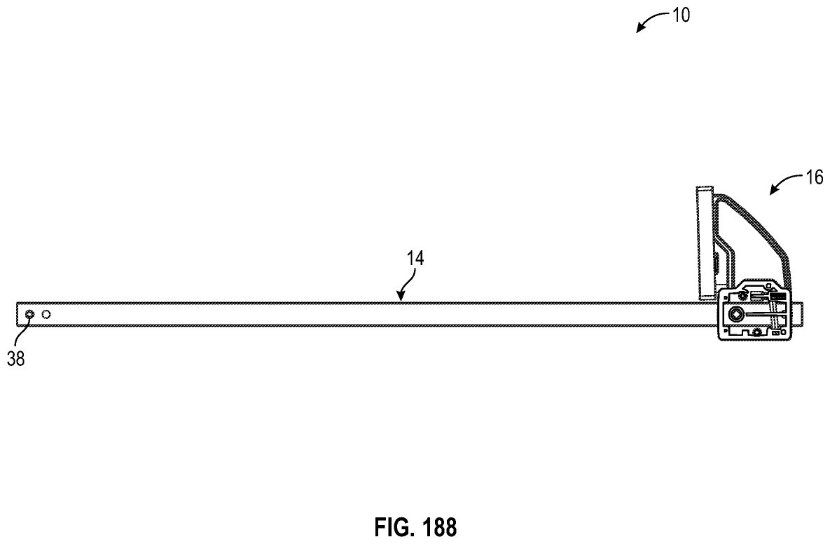

FIG. 189 shows alternative side elevation view of a bar clamp system; the view showing an end stop assembly installed on an elongated bar; the view showing the elongated bar having a stop member.

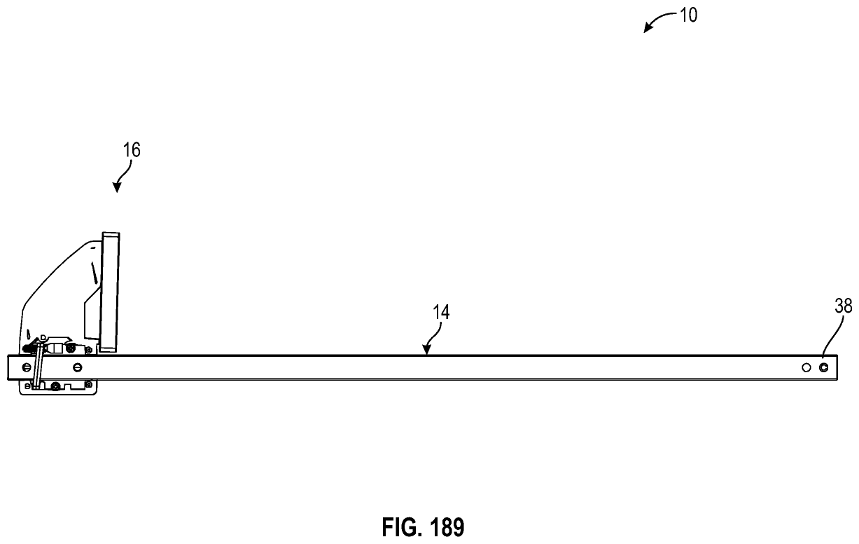

FIG. 190 shows a perspective view of a bar clamp system; the view showing an end stop assembly installed on an elongated bar.

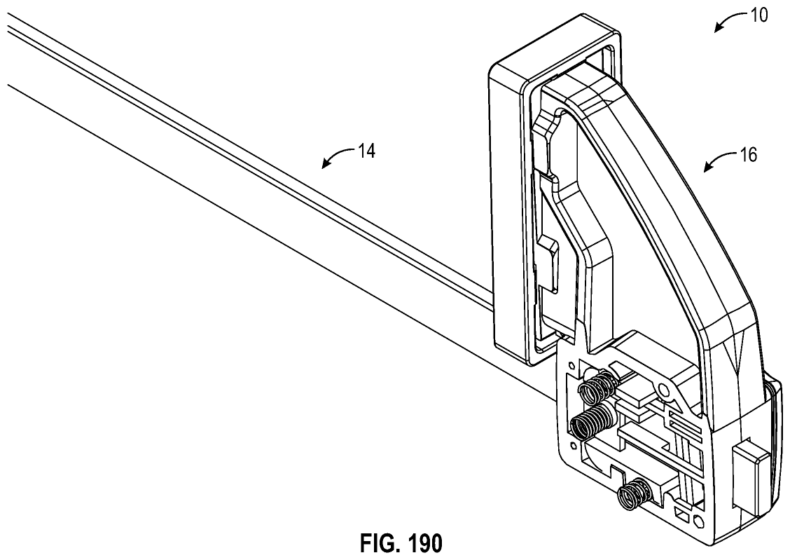

FIG. 191 shows a perspective view of a bar clamp system; the view showing an end stop assembly installed on an elongated bar; the view showing the elongated bar having a stop member.

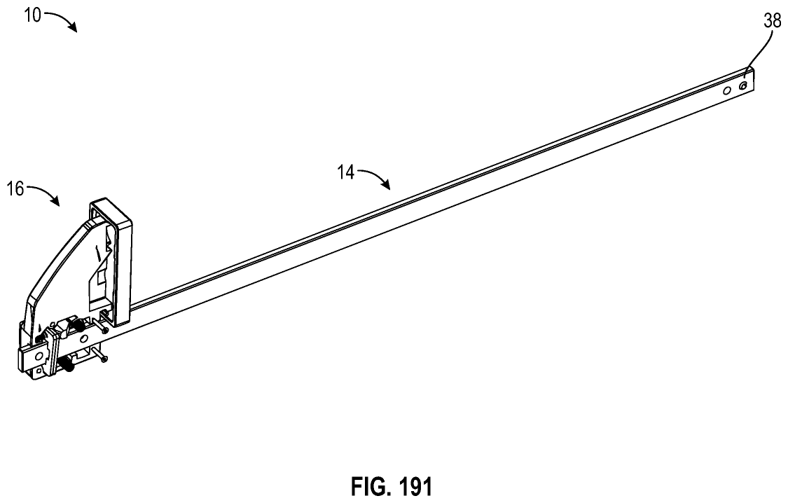

FIG. 192 shows a side elevation view of a bar clamp system; the view showing an end stop assembly and a handle assembly installed on an elongated bar; the view showing the elongated bar having a stop member; the view showing the end stop assembly and handle assembly facing each other to facilitate clamping.

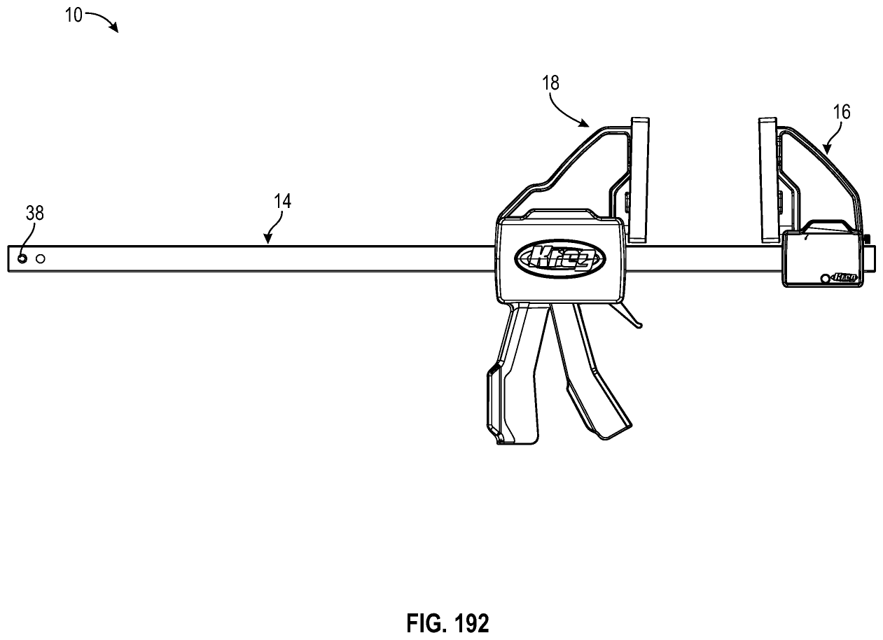

FIG. 193 shows a bottom perspective view of a bar clamp system; the view showing an end stop assembly and a handle assembly installed on an elongated bar; the view showing the elongated bar having a stop member; the view showing the end stop assembly and handle assembly facing each other to facilitate clamping.

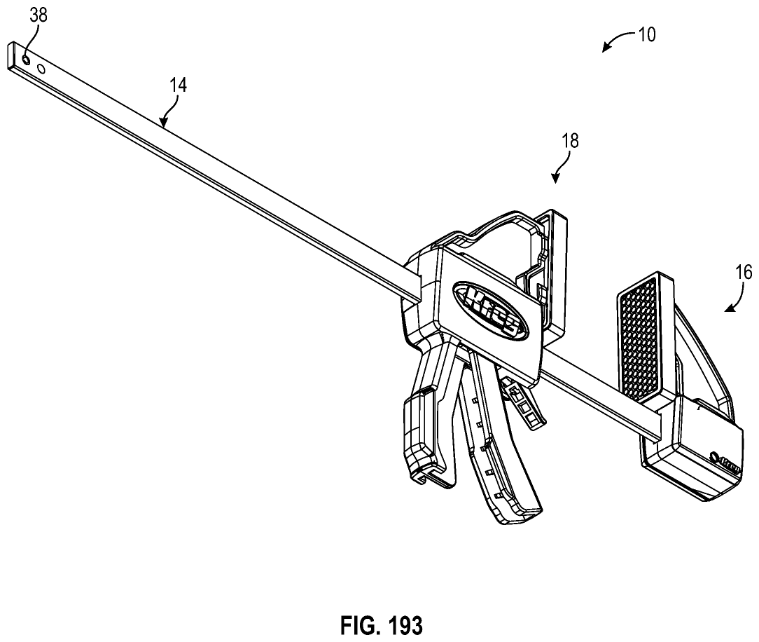

FIG. 194 shows an alternative bottom perspective view of a bar clamp system; the view showing an end stop assembly and a handle assembly installed on an elongated bar; the view showing the end stop assembly and handle assembly facing each other to facilitate clamping.

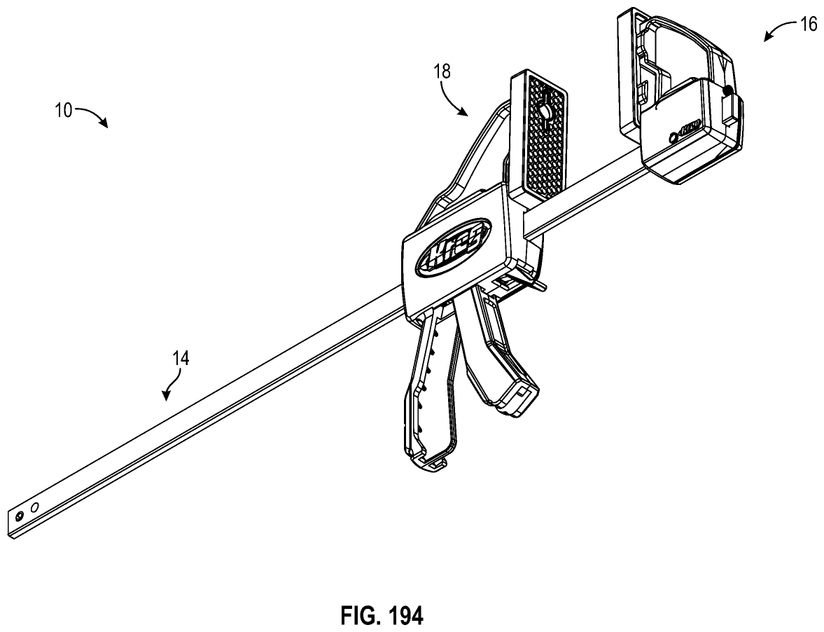

FIG. 195 shows an alternative bottom perspective view of a bar clamp system; the view showing an end stop assembly and a handle assembly installed on an elongated bar; the view showing the end stop assembly and handle assembly facing each other to facilitate clamping.

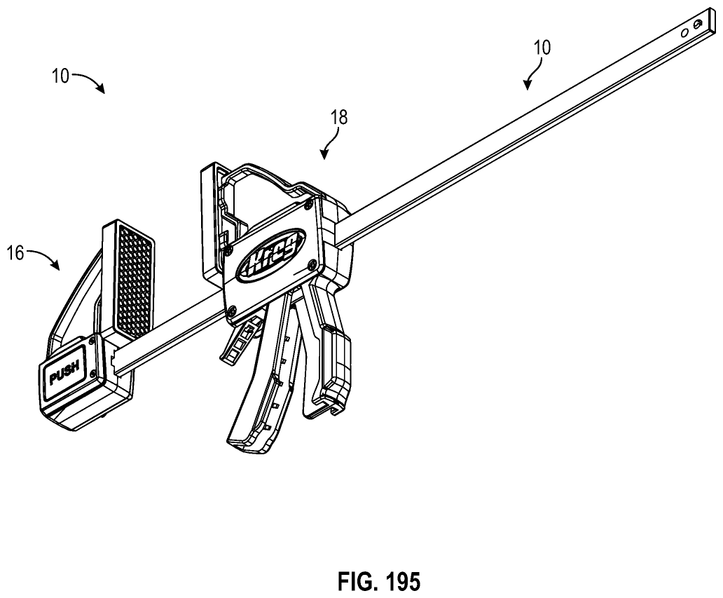

FIG. 196 shows a top perspective view of a bar clamp system; the view showing an end stop assembly and a handle assembly installed on an elongated bar; the view showing the end stop assembly and handle assembly facing each other to facilitate clamping.

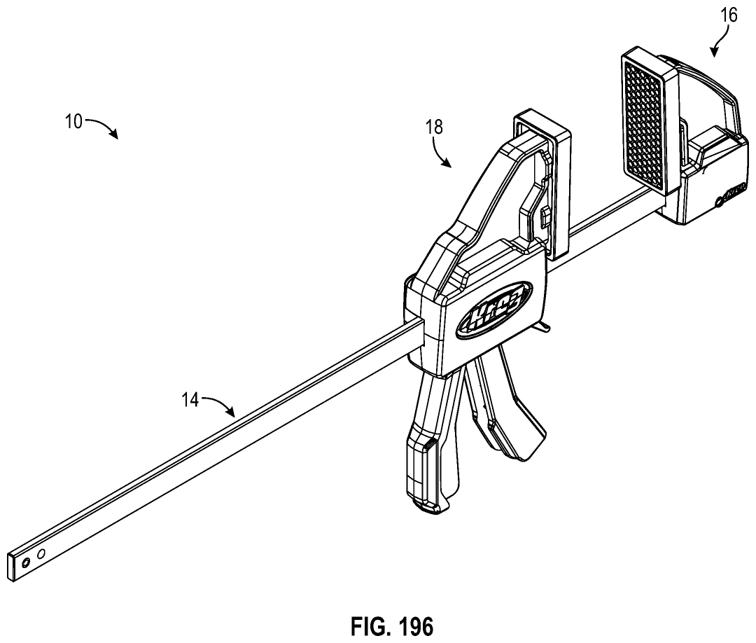

FIG. 197 shows a top elevation view of a bar clamp system; the view showing an end stop assembly and a handle assembly installed on an elongated bar; the view showing the end stop assembly and handle assembly facing each other to facilitate clamping.

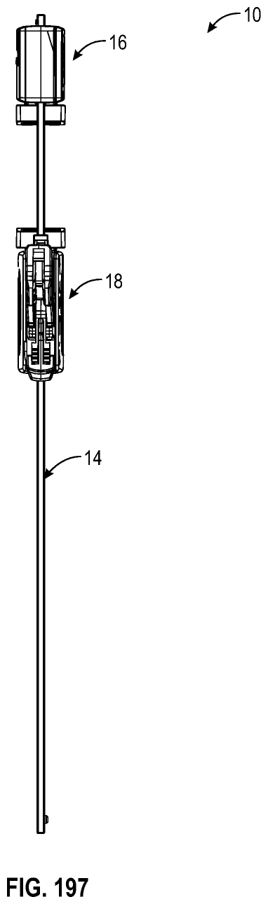

FIG. 198 shows a side elevation view of a bar clamp system; the view showing an end stop assembly and a handle assembly installed on an elongated bar; the view showing the end stop assembly and handle assembly facing each other to facilitate clamping.

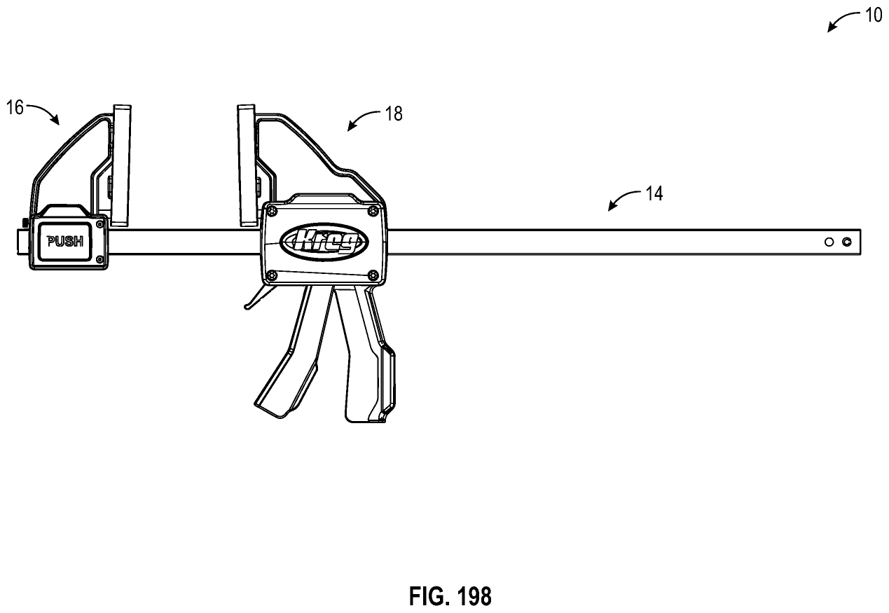

FIG. 199 shows a back side elevation view of a bar clamp system; the view showing a handle assembly installed on an elongated bar.

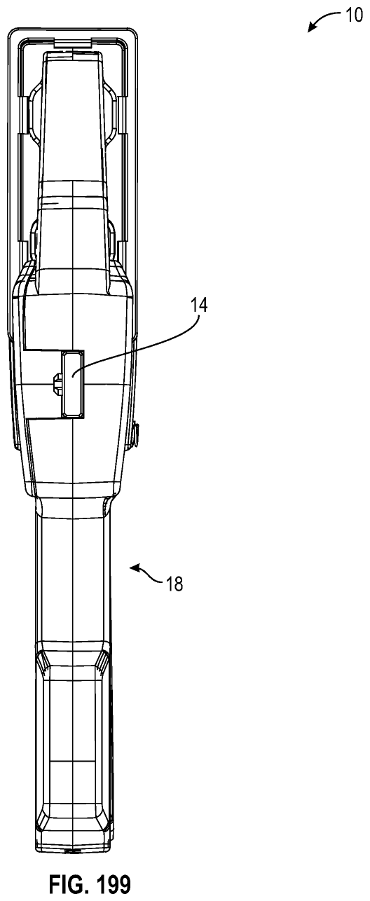

FIG. 200 shows a front side elevation view of a bar clamp system; the view showing a handle assembly installed on an elongated bar.

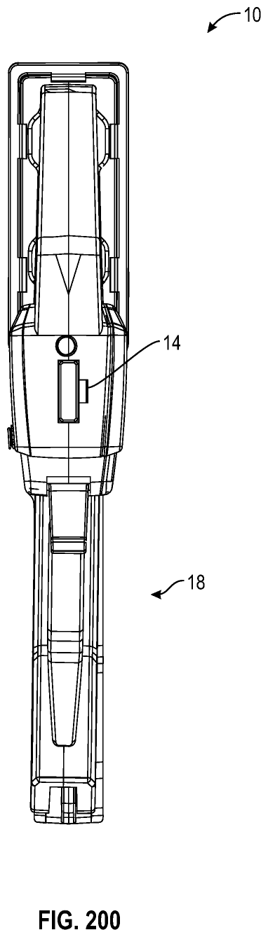

FIG. 201 shows a top perspective view of a bar clamp system; the view showing an end stop assembly and a handle assembly installed on an elongated bar; the view showing the end stop assembly and handle assembly facing each other to facilitate clamping.

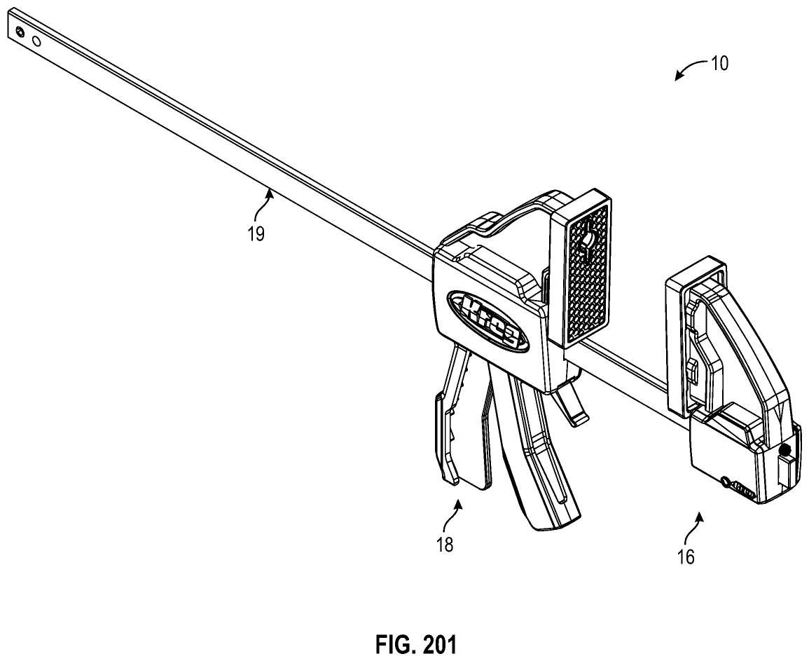

FIG. 202 shows a top perspective view of a bar clamp system; the view showing an end stop assembly and a handle assembly installed on an elongated bar; the view showing the end stop assembly and handle assembly facing each other to facilitate clamping.

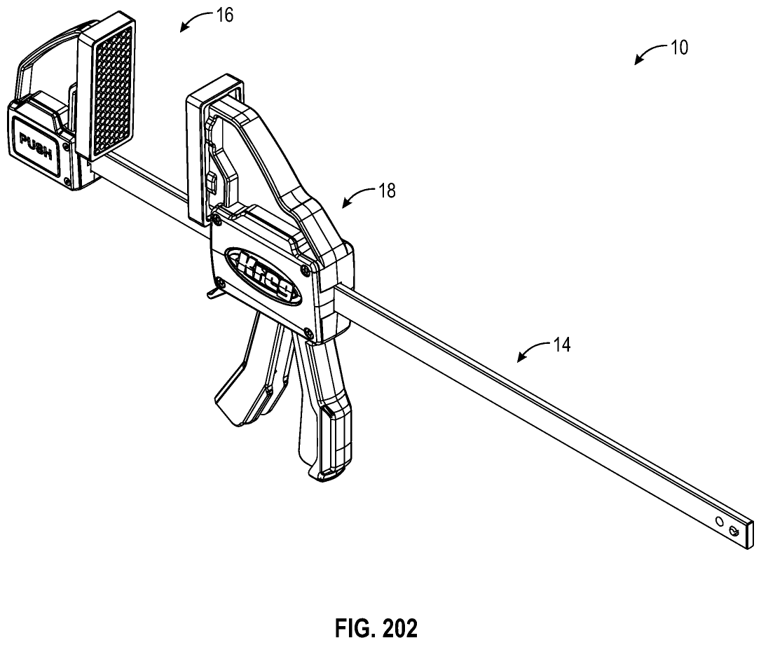

FIG. 203 shows a top perspective view of a bar clamp system; the view showing an end stop assembly and a handle assembly installed on an elongated bar; the view showing the end stop assembly and handle assembly facing each other to facilitate clamping.

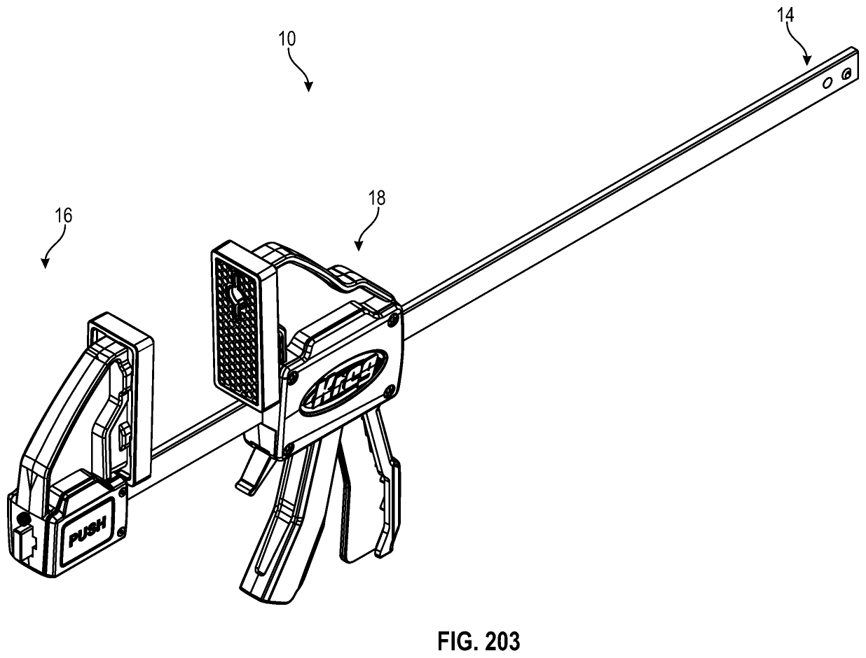

FIG. 204 shows a top elevation view of a bar clamp system; the view showing an end stop assembly and a handle assembly installed on an elongated bar; the view showing the end stop assembly and handle assembly facing each other to facilitate clamping.

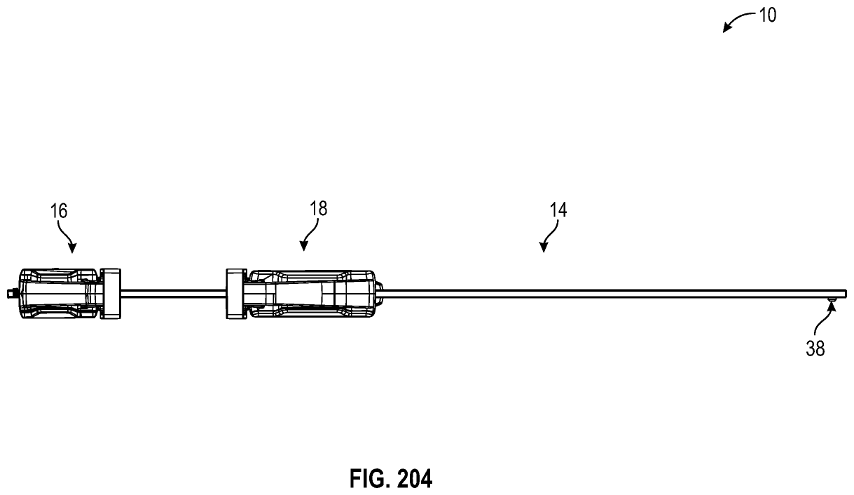

### SUMMARY OF THE DISCLOSURE

In one or more arrangements, a bar clamp system is presented. The system includes an elongated bar extending a length between a first end and a second end. The system includes a end stop assembly operably connected to the elongated bar. The end stop assembly is movable along the length of the elongated bar. The end stop assembly includes an actuator that is movable between a locked position and an unlocked position. The end stop assembly includes a first locking mechanism and a second locking mechanism. The first locking mechanism is configured to engage the elongated bar and secure the end stop assembly in position along the length of the bar when the first locking mechanism is aligned with a recess in the elongated bar and the actuator is in the locked position. The second locking mechanism is configured to engage the elongated bar and inhibit movement of the end stop assembly along the elongated bar when the actuator is in the locked position. Movement of the actuator to the unlocked position causes the first locking mechanism and second locking mechanism to permit end stop assembly to move in either direction along the length of the elongated bar.

The system includes a handle assembly operably connected to the elongated bar. The handle assembly is movable along the length of the elongated bar. The handle assembly includes a clamp actuator, a release actuator, and a clamp mechanism operably connected to the clamp actuator and the release actuator. The release actuator is movable between a locked position and an unlocked position. When the release actuator is in the locked position, the clamp mechanism is configured to move the handle assembly in a first direction along the length of the elongated bar in response to actuation of the clamp actuator and inhibit movement of the handle assembly in the opposite direction. When the release actuator is in the locked position, the clamp mechanism is configured to permit the handle assembly to be moved in either direction along the length of the elongated bar.

In one or more arrangements, the end stop assembly and handle assembly each have a clamp plate having a clamping surface and a non-clamping surface. In some arrangements, the end stop assembly and handle assembly can be repositioned on the elongated bar with the clamping surfaces facing toward each other, to facilitate clamping, or with the clamping surfaces facing outward away from each other, to facilitate spreading.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by some various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, back, front, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, or sequentially, to provide looping or other series of operations aside from single operations described below. It should be presumed that any embodiment or method having features and functionality described below, in any workable combination, falls within the scope of example embodiments. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

As used herein, various disclosed embodiments may be primarily described in the context of clamping workpieces. However, the embodiments are not so limited. It is appreciated that the embodiments may be adapted for use in various other applications, which may be improved by the disclosed structures, arrangements and/or methods. The system is merely shown and described as being used in the context of clamping workpieces for ease of description and as one of countless examples.

### System 10:

With reference to the figures, a bar clamp system 10 (or clamp system 10 or simply system 10) is presented. The bar clamp system 10 is formed of any suitable size, shape, and design and is configured to clamp workpieces in a variety of manners. In the arrangement shown, as one example, the bar clamp system 10 includes an elongated bar 14, an end stop assembly 16, and a handle assembly 18, among other components.

### Bar 14:

In the arrangement shown, as one example, clamp system 10 incudes a bar 14. Bar 14 is formed of any suitable size, shape, and design and is configured to provide an elongated structure to facilitate attachment of end stop assembly 16 and handle assembly 18 thereto and facilitate clamping of workpieces 22 (not shown) therebetween.

In the arrangement shown, as one example, bar 14 has a generally elongated rectangular shape having a top 30, a bottom 32, and sides 34 and extending a length between opposing ends 36. In this example arrangement, bar 14 includes one or more recesses 40 in one or more surfaces of bar 14 to facilitate locking of end stop assembly 16 in one or more particular positions along the length of bar 14. In this example arrangement, recesses 40 are through holes that extend between sides 34 of bar proximate to one of the opposing ends 36. However, embodiments are not so limited. Rather, it is contemplated that in some various arrangements, recesses 40 may be any other shaped recess, may be positioned at various other locations along the length of bar 14 and/or, may be positioned in any other surface of bar 14.

### End Stop Assembly 16 (Also Known as the Front Clamp Arm Assembly):

In the arrangement shown, as one example, clamp system 10 includes an end stop assembly 16. End stop assembly 16 is formed of any suitable size, shape, and design and is configured to be movable along the length of bar 14 and be secured in a desired position thereon to facilitate clamping of a workpiece 22. In the arrangement shown, as one example, end stop assembly 16 includes a clamp plate 46, a clamp arm 48, a main body 50, a cover 52, and a locking assembly 54, among other components.

### Clamp Plate 46:

Clamp plate 46 is formed of any suitable size, shape, and design and is configured to provide a clamping surface to facilitate clamping of a workpiece 22. In the arrangement shown, clamp plate 46 has a generally rectangular planar shape having a clamping surface 60 and a non-clamping surface 62 and extending between an upper edge 64, a lower edge 66, and opposing side edges 68.

### Clamp Arm 48:

Clamp arm 48 is formed of any suitable size, shape, and design and is configured to connect clamp plate 46 to main body 50 in a secure manner. In the arrangement shown, as one example, clamp arm 48 has a generally planar plate 76 extending between a back edge 78, a front edge 80, angled top edge 82, and a bottom edge 84 of clamp arm 48 and a set of support members 90. Support members 90 are formed of any suitable size, shape, and design and are configured to provide structural support and/or rigidity to plate 76. In the arrangement shown, as one example, support members 90 have generally planar flanges extending outward to the sides of plate 76. In this example arrangement, clamp arm 48 includes support members 90 extending outward from plate 76 along top edge 82, back edge 78, and front edge 80. In this example arrangement, clamp arm 48 also includes support members 90 extending from an upper end 86 of front edge 80 to a lower point 88 of back edge 78.

### Main Body 50:

Main body 50 is formed of any suitable size, shape, and design and is configured to be movable along the length of bar 14 and selectably secure end stop assembly 16 in position along bar 14 to facilitate clamping of a workpiece 22. In the arrangement shown, as one example, main body 50 includes a top 96, a bottom 98, a back 100, a front 102, and a closed side 104, forming a hollow interior 106 accessible through an open side 108. In this example arrangement, back 100 and front 102 of main body 50 include openings 110. Openings 110 are formed of any suitable size, shape, and design and is configured to permit bar 14 to be inserted through openings 110 and main body 50 to facilitate connection of main body 50 to bar 14.

### Locking Assembly 54:

In this example arrangement, locking assembly 54 is positioned within hollow interior 106. Locking assembly 54 is formed of any suitable size, shape, and design and is configured to engage bar 14 and secure end stop assembly 16 in position when an actuator 120 in a locked position. Locking assembly 54 is also configured to disengage from bar 14, to permit end stop assembly 16 to be moved along bar 14, when actuator 120 is in an unlocked position. In the arrangement shown, as one example, locking assembly 54 includes a first locking mechanism 116, a second locking mechanism 118, and actuator 120 among other components. However, embodiments are not so limited. Rather it is contemplated that in one or more arrangements, the locking assembly 54 can be implemented with the first locking mechanism 116 only, the second locking mechanism 118 only, or any other arrangement to secure end stop assembly 16.

### First Locking Mechanism 116:

First locking mechanism 116 is formed of any suitable size, shape, and design and is configured to engage recesses 40 in bar 14 to secure end stop assembly 16 in one or more fixed positions along the length of bar 14. In the arrangement shown, as one example, second locking mechanism 118 includes a lock pin 128 and a bias member 130.

Lock pin 128 is formed of any suitable size, shape, and design and is configured to be inserted into recesses 40 by bias member 130 to secure end stop assembly 16 in position along bar 14 when lock pin 128 is aligned with the recesses 40. In this example arrangement, lock pin 128 has a narrow portion 134, a wide portion 136, and a connection feature 138. In this example arrangement, narrow portion 134 of lock pin 128 has a generally cylindrical shape extending between a right end 142 and a left end 144 with a tapered portion 146 proximate the left end 144. In this example arrangement, wide portion 136 has a generally cylindrical shape extending between a left end 152, connected to right end 142, and a right end 150. In this example arrangement, right end 150 of wide portion 136 extends outward from right end 142 of narrow portion 134 to form a lip 154. As described in more detail with reference to actuator 120, actuator 120 engages lip 154 of first locking mechanism 116 to facilitate movement of lock pin 128 of first locking mechanism 116 into and out from recesses 40 of bar 14. Connection feature 138 is formed of any suitable size, shape, and design and is configured to connect lock pin 128 to bias member 130. In the arrangement shown, as one example, connection feature 138 is a cylindrical protrusion that extends rightward from right end 150 of wide portion 136 of lock pin 128. In this example arrangement, connection feature 138 is configured to be received within an open end of bias member 130 to maintain secure connection between bias member 130 and lock pin 128.

Bias member 130 is formed of any suitable size, shape, and design and is configured to operably connect to and between lock pin 128 and closed side 104 of main body 50 of end stop assembly 16 and provide a bias force sufficient to move lock pin 128 leftward toward bar 14 in the absence of an opposing rightward force (e.g., placed on button 334 of actuator 120). In the arrangement shown, as one example, bias member 130 is a spring positioned between lock pin 128 and closed side 104 of main body 50 with connection feature 138 extending into an open end of the spring. However, embodiments are not so limited. Rather, it is contemplated that in various different arrangements bias member 130 may utilize various mechanisms to move lock pin 128 toward bar 14 including but not limited to, for example, one or more springs, one or more gas pistons, one or more gas springs, one or more hydraulic pistons, one or more actuators, one or more solenoids, one or more pneumatic members, and/or any other force generating means or combination thereof.

### Second Locking Mechanism 118:

Second locking mechanism 118 is formed of any suitable size, shape, and design and is configured to facilitate clamping and/or spreading by preventing end stop assembly 16 from being moved forward along the length of bar 14 when actuator 120 is in the locked position. In the arrangement shown, as one example, second locking mechanism 118 includes a pair of clutch plates 164, a bias member 166, and a clutch plate positioning member 168 among other components.

Clutch Plates 164:

Clutch plates 164 are formed of any suitable size, shape, and design and are configured to engage top 30 of bar 14 when moved to an angled locked position and disengage from top 30 of bar 14 when moved to a vertical unlocked position. In the arrangement shown, as one example, clutch plates 164 each have a generally rectangular planar shape having a front 178 and a back 176 extending between a top edge 170, a bottom edge 172, opposing side edges 174. In this example arrangement, clutch plates 164 each have a rectangular opening 182. Rectangular opening 182 is formed of any suitable size, shape, and design and is configured to permit bar 14 to be inserted through rectangular opening 182, permit clutch plates 164 to slide along bar 14 when clutch plates 164 are in the vertical unlocked position, and inhibit clutch plates 164 from sliding forward along bar 14 when clutch plates 164 are in the angled locked position.

Bias Member 166:

In this example arrangement, clutch plates 164 are operably connected to bias member 166 proximate to top edge 170. Bias member 166 is formed of any suitable size, shape, and design and is configured to operably connect to and between clutch plates 164 and back 100 of main body 50 and provide a rearward bias force sufficient to move top edge 170 of clutch plates 164 and clutch plate positioning member 168 rearward in the absence of an opposing rearward force (e.g., provided by actuator 120 when button 334 is pressed). Movement of top edge 170 of clutch plates 164 places clutch plates 164 in the angled locked position.

In the arrangement shown, as one example, bias member 166 is a spring positioned between back 100 of main body 50 and clutch plates 164 and/or clutch plate positioning member 168. However, embodiments are not so limited. Rather, it is contemplated that in various different arrangements bias member 166 may utilize various mechanisms to move top edge 170 of clutch plates 164 rearward including but not limited to, for example, one or more springs, one or more gas pistons, one or more gas springs, one or more hydraulic pistons, one or more actuators, one or more solenoids, one or more pneumatic members, and/or any other force generating means or combination thereof.

When clutch plates 164 are moved to the angled locked position, engagement between clutch plates 164 and top 30 of bar 14 prevent end stop assembly 16 from moving forward along the length of bar 14. In this angled locked position, application of force to move end stop assembly 16 forward transfers to top edge 170 of clutch plates 164, thereby moving top edge 170 end forward, further angling clutch plates 164, and increasing frictional forces between clutch plates 164 and top 30 of bar 14. Conversely, in the angled locked position, application of force to move end stop assembly 16 rearward transfers forces to move top edge 170 of clutch plates 164 rearward, thereby moving clutch plates 164 more vertical and reducing frictional forces between clutch plates 164 and top 30 of bar 14. In this manner, in the locked position, second locking mechanism 118 prevents end stop assembly 16 from being moved forward and permits end stop assembly 16 to be slid rearward (e.g. to engage a workpiece 22).

Clutch Plate Positioning Member 168:

Clutch plate positioning member 168 is formed of any suitable size, shape, and design and is configured to move top edge 170 of clutch plates 164 rearward when actuator 120 is moved to an unlocked position (e.g., when button 334 of actuator 120 is pressed). In the arrangement shown, as one example, clutch plate positioning member 168 has a generally rectangular shape body having a top 200, a bottom 202, a back 204, a front 206, a right side 208, and a left side 210. In this example arrangement, clutch plate positioning member 168 includes a recessed track 212 extending horizontally along right side 208. In this example arrangement, recessed track 212 has an elongated rectangular shape and is configured to receive a similar shaped protrusion 214 formed in inner surface of closed side 104 of main body 50. In this example arrangement, protrusion 214 slides inside recessed track 212 and operates to keep clutch plate positioning member 168 properly oriented within hollow interior 106 and guides forward and backward movement of clutch plate positioning member 168.

In this example arrangement, clutch plate positioning member 168 includes a contact protrusion 220 extending forward from front 206 of clutch plate positioning member 168. Contact protrusion 220 is formed of any suitable size, shape, and design and is configured to facilitate contact with a center point of one of the clutch plates 164 proximate to top edge 170. In the arrangement shown, contact protraction 220 has a pyramid like shape extending forward from front 206. However, the embodiments are not so limited. Rather, it is contemplated that contact protrusion 220 may have any shape.

In one or more arrangements, clutch plate positioning member 168 includes a connection feature 222 (not shown). Connection feature 222 is formed of any suitable size, shape, and design and is configured to connect clutch plate positioning member 168 to bias member 166 of second locking mechanism 118. In one example arrangement, connection feature 222 is a cylindrical protrusion that extends forward from front 206 of clutch plate positioning member 168. In this example arrangement, connection feature 222 is configured to be received within an open end of bias member 166 to maintain secure connection between clutch plate positioning member 168 and bias member 166.

In this example arrangement, clutch plate positioning member 168 includes an angled surface 218 in a rear-left portion of clutch plate positioning member 168. In this example arrangement, angled surface 218 is a vertical surface angled approximately forty-five degrees relative to left side 210. However, the embodiments are not so limited. Rather, it is contemplated that in various arrangements, angled surface 218 may be oriented at any angle. In this example arrangement, angled surface 218 of clutch plate positioning member 168 is positioned to engage actuator 120 when button 334 of actuator 120 is depressed and actuator 120 is moved to an unlocked position. As described in more detail with reference to actuator 120, movement of actuator 120 to the unlocked position, presses against angled surface of clutch plate positioning member 168, which causes clutch plate positioning member 168 to be moved forward and against clutch plates 164. As a result, top edge 170 of clutch plates 164 is moved rearward, thereby moving clutch plates 164 more vertical and reducing frictional forces between clutch plates 164 and top 30 of bar 14.

### Actuator 120:

Actuator 120 is formed of any suitable size, shape, and design and is configured to engage first locking mechanism 116 and/or second locking mechanism 118 when actuator 120 is in the locked position and disengage first locking mechanism 116 and/or second locking mechanism 118 when actuator 120 is in the unlocked position. In the arrangement shown, as one example, actuator 120 is a button-type actuator configured to disengage both first locking mechanism 116 and second locking mechanism 118 when depressed by a user and reengage both first locking mechanism 116 and second locking mechanism 118 when released. However, the arrangements are not so limited. Rather, it is contemplated that in one or more arrangements, actuator 120 may be any type of actuator including but not limited to, for example, a button, a lever, a knob, a slider, a switch, a hand wheel, a crank, a pump, or any other type of actuator. In this example arrangement, actuator 120 includes an inner portion 332/232, a button 334/234, and one or more bias members 236, among other components.

### Inner Portion 332:

Inner portion 332 of actuator 120 is formed of any suitable size, shape, and design and is configured to facilitate side to side movement within hollow interior 106 of main body 50 of end stop assembly 16 between the locked position and unlocked position and cause first locking mechanism 116 and second locking mechanism 118 to disengage from bar 14 when inner portion 332 is moved to the unlocked position when button 334 is depressed.

In the arrangement shown, as one example, inner portion 332 includes a top member 240, a bottom member 242, a button-side sidewall 244, a lock-side sidewall 246, a wedge member 248, among other components. In this example arrangement, top member 240 and bottom member 242 extend between button-side sidewall 244 and lock-side sidewall 246 to form a generally rectangular shaped opening 254. In this example arrangement, when bar 14 is inserted through end stop assembly 16, bar 14 extends through opening 254. In this example arrangement, opening 254 is wider than bar 14 so as to permit inner portion 332 to be moved side to side between the locked position and the unlocked position while bar 14 is inserted through opening 254.

Top Member 240:

Top member 240 is formed of any suitable size, shape, and design and is configured to facilitate side to side movement of actuator 120 and connection with one or bias member(s) 236. In the arrangement shown, as one example, top member 240 has a generally rectangular planar shape having a top 258, a bottom 260, a back 262, a front 264, and opposing sides 266. In this example arrangement, top member 240 includes a recessed channel 270 formed in top 258 of top member 240. In this example arrangement, recessed channel 270 has a semi-cylindrical shape and is configured to receive and hold one of bias member(s) 236.

In this example arrangement, top member 240 includes a connection feature 272 positioned within recessed channel 270 proximate to an outward one of the sides 266. In this example arrangement, connection feature 272 is a cylindrical protrusion configured to be received within a spring type bias member 236. However, the embodiments are not so limited. Rather, it is contemplated that connection feature 272 may be connected to bias member 236 using any means and methods known in the art including but not limited to, for example, adhesive bonding, chemical bonding, welding, and/or mechanical attachment means such as frictional fitting, screws, bolts, threading, interlocks, clips, pins, or other coupling devices.

Bottom Member 242:

Bottom member 242 is formed of any suitable size, shape, and design and is configured to facilitate side to side movement of actuator 120 and connection with one or more bias member(s) 236. In the arrangement shown, as one example, bottom member 242 has a generally rectangular planar shape having a top 278, a bottom 280, a back 282, a front 284, and opposing sides 286.

In this example arrangement, bottom member 242 includes a recessed channel 288 formed in bottom 280 of bottom member 242 and extending inward from one of the sides 286. In this example arrangement, recessed channel 288 has a semi-cylindrical shape and is configured to receive and hold one of bias member(s) 236.

In this example arrangement, bottom member 242 includes a connection feature 292 positioned within recessed channel 288 proximate to an outward one of the sides 286. In this example arrangement, connection feature 292 is similar to connection feature 272. However, as described with reference to connection feature 272, connection feature 292 may be implemented using any means or method for forming a connection.

In this example arrangement, bottom member 242 includes a recessed track 290 formed in bottom 280 of bottom member 242 and extending inward from one of the sides 286. In this example arrangement, recessed track 290 has an elongated rectangular shape and is configured to receive a similar shaped connection feature 292 formed in an upper surface of bottom 98 of main body 50. In this example arrangement, connection feature 292 slides inside recessed track 290 and operates to keep inner portion 332 properly oriented within hollow interior 106 as inner portion 332 is moved from side to side between the locked position and the unlocked position.

Button-Side Sidewall 244:

Button-side sidewall 244 is formed of any suitable size, shape, and design and is configured to operably connect top member 240 and bottom member 242 of inner portion 332 together and with button 334 of actuator 120. In the arrangement shown, as one example, button-sidewall 244 is a rectangular c-shaped member having an upper portion 300, a lower portion 302, and a rearward portion 304 extending from a rearward end of upper portion 300 to a rearward end of lower portion 302.

Lock-Side Sidewall 246:

Lock-side sidewall 246 is formed of any suitable size, shape, and design and is configured to operably connect top member 240 and bottom member 242 of inner portion 332 together and facilitate locking and unlocking of first locking mechanism 116. In the arrangement shown, as one example, lock-side sidewall 246 has a generally planar rectangular shape extending between a forward edge 312, a rearward edge 314, a top edge 316 connected to top member 240, and a bottom edge 318 connected to bottom member 242. In this example arrangement, lock-side sidewall 246 includes a circular opening 322 through which first locking mechanism 116 extends to engage with bar 14 to facilitate locking of end stop assembly 16 in position when first locking mechanism 116 encounters one of recesses 40 in bar 14.

In this example arrangement, lock-side sidewall 246 includes a collar 324 extending outward from a right side of lock-side sidewall 246. Collar 324 is formed of any suitable size, shape, or design and is configured to receive and align first locking mechanism 116 with circular opening 322. In this example arrangement, collar 324 has a generally cylindrical shape extending from lock-side sidewall 246 to an outward end 326. In this example arrangement, collar 324 has an inner diameter that is approximately the same as the outer diameter of a wide portion 136 of lock pin 128 of first locking mechanism 116. In this example arrangement, opening 322 has a smaller diameter than collar 324 so lock-side sidewall 246 extends inward from collar 324 to form a lip 330. As described in more detail with reference to first locking mechanism 112, lip 330 engages wide portion 136 of lock pin 128 of first locking mechanism 116 to facilitate retraction of first locking mechanism 116 from bar 14 when button 334 of actuator 120 of locking assembly 54 is pressed by a user.

Wedge Member 248:

Wedge member 248 is formed of any suitable size, shape, and design and is configured to engage angled surface 218 of clutch plate positioning member 168 when button 334 of actuator 120 of locking assembly 54 is pressed by a user to facilitate moving clutch plates 164 to the vertical position to permit front arm clamp arm assembly 16 to be moved in either direction along the length of bar 14. In the arrangement shown, as one example, wedge member 248 has a generally planar top 340, bottom 342, side 344, angled surface 346 extending forward from front 264 of top member 240 to a front 348. In this example arrangement, angled surface 368 is a vertical surface angled approximately forty-five degrees relative to side 344. However, the embodiments are not so limited. Rather, it is contemplated that in various arrangements, angled surface 368 may be oriented at any angle. In this example arrangement, angled surface 368 is positioned at approximately the same angle as angled surface 218 to facilitate smooth sliding movement between angled surface 368 and angled surface 218 to facilitate smooth movement of clutch plate positioning member 168 when actuator 120 moved between the locked and unlocked positions.

Button 334:

Button 334 of actuator 120 is formed of any suitable size, shape, and design and is configured to facilitate movement of actuator 120 between the unlocked and locked positions by a user. In the arrangement shown, as one example, button 334 has irregular hexagon shaped protrusion having front surface 356, rear surface 358, top surface 360, bottom surface 362, and angled surfaces 364 extending outward from button-side sidewall 244 of inner portion 332 of actuator 120 to an outer side surface 366. More specifically, when viewed from the side, button 334 has a hexagonal shape resembling a trapezoid connected to a forward side of a rectangle. In this example arrangement, a forward end 370 of button extends forward beyond front 264 of top member 240 beyond front 264 of inner portion 332. In this example arrangement, button 334 has a flange 372 that is flush with button-side sidewall 244 and extends around the forward end 370 of button 334. In this example arrangement, button 334 is positioned within and extends through a similar shaped opening 380 of cover 52.

### Bias Member(s) 236:

In one or more arrangements, system 10 includes one or more bias members 236. Bias member 236 is formed of any suitable size, shape, and design and is configured to attach to and between actuator 120 and main body 50 of end stop assembly 16 and provide a bias force to move actuator 120 to the locked position in the absence of an opposing inward force (e.g., placed on button 334 by a user). In the arrangement shown, as one example, bias member(s) 236 are a pair of springs positioned in recessed channels 270 and 288 of actuator 120. However, arrangements are not so limited. Rather, in various different arrangements, bias member 236 may utilize various mechanisms to move actuator 120 to the unlocked position including but not limited to, for example, one or more springs, one or more gas pistons, one or more gas springs, one or more hydraulic pistons, one or more actuators, one or more solenoids, one or more pneumatic members, and/or any other force generating means or combination thereof.

### Cover 52:

Cover 52 is formed of any suitable size, shape, and design and is configured to connect with main body 50 to enclose locking assembly 54 within hollow interior 106. In the arrangement shown, as one example, cover 52 has a generally rectangular planar shape, when viewed from the left side, extending between a front edge 382, a rear edge 384, a top edge 386, and a bottom edge 388. In this example arrangement, cover 52 includes an opening 380 having a shape that is similar to that of button 334, which is positioned therein.
In this example arrangement, cover 52 includes a beam 392 extending rightward from an upper front corner of cover 52. In this example arrangement, beam 392 serves as a stop member for clutch plates 164 when moved to the vertical position by actuator 120 when button 334 is pressed by a user.

In this example arrangement, cover 52 is secured to main body 50 by fasteners 396 that are inserted through holes 394 in cover 52. However, the arrangements are not so limited. Rather, it is contemplated that cover 52 may be connected to main body 50 using any means and methods known in the art including but not limited to, for example, adhesive bonding, chemical bonding, welding, and/or mechanical attachment means such as frictional fitting, screws, bolts, threading, interlocks, clips, pins, or other coupling devices.

### Handle Assembly 18 (Also Known as Rear Clamp Arm Assembly):

Handle assembly 18 is formed of any suitable size, shape, and design and is configured to move forward along the length of bar 14 to facilitate clamping of a workpiece 22 between end stop assembly 16 and handle assembly 18 when a clamp mechanism 412 is actuated by a user.

In the arrangement shown, as one example, handle assembly 18 includes a clamp plate 400, a clamp arm 402, a main body 404, a handle 406, a clamp actuator 408, a release actuator 410, and clamp mechanism 412 (not shown), among other components.

### Clamp Plate 400:

Clamp plate 400 is formed of any suitable size, shape, and design and is configured to provide a clamping surface 434 to facilitate clamping of a workpiece 22. In the arrangement shown, clamp plate 400 has a generally planar shape having a clamping surface 434 and a non-clamping surface 436 and extending between an upper edge 438, a lower edge 440, and opposing side edges 442.

### Clamp Arm 402:

Clamp arm 402 is formed of any suitable size, shape, and design and is configured to connect clamp plate 400 to main body 404 in a secure manner. In one arrangement shown, clamp arm 402 has a generally planar plate 416 extending between a back edge 418, a front edge 420, angled top edge 422, and a bottom edge 424 of clamp arm 402 and a set of support members 430. Support members 430 are formed of any suitable size, shape, and design and are configured to provide structural support and/or rigidity to plate 416. In the arrangement shown, as one example, support members 430 have generally planar flanges extending outward to the sides of plate 416. In this example arrangement, clamp arm 402 includes support members 430 extending outward from plate 416 along top edge 422, back edge 418, and front edge 420. In this example arrangement, clamp arm 402 also includes support members 430 extending downward at an angle from top edge 422 to front edge 420.

### Main Body 404:

Main body 404 is formed of any suitable size, shape, and design and is configured to interconnect and house various other components of handle assembly 18 and be movable along the length of bar 14 to facilitate clamping of a workpiece 22. In the arrangement shown, as one example, main body 404 includes a top 450, a bottom 452, a back 454, a front 456, opposing sides 448, and a hollow interior 458.

In this example arrangement, back 454 and front 456 of main body 404 include openings 460. Openings 460 are formed of any suitable size, shape, and design and are configured to permit bar 14 to be inserted through openings 460 and main body 404 to facilitate connection of main body 404 to bar 14. In the arrangement shown, as one example, openings 460 have a generally rectangular shape that is similar to that of bar 14 when views from an end 36.

In this example arrangement, main body 404 also includes openings 464 in bottom 452 through which clamp actuator 408 and release actuator 410 extend. Openings 464 are formed of any suitable size, shape, and design and are configured to facilitate forward and backward movement of clamp actuator 408 during operation. In one or more arrangements, for example, openings 464 may be a generally rectangular opening having a width that is slightly bigger than a side to side width of clamp actuator 408 and a length sufficient to permit clamp actuator 408 to move between a forward position and rearward position.

Handle 406:

Handle 406 is formed of any suitable size, shape, and design and is configured to facilitate handheld carry and operation of system 10 by a user. In the arrangement shown, as one example, handle 406 is a pistol type grip extending downward from bottom 452 of main body 404. However, embodiments are not so limited. Rather, it is contemplated that handle 406 may be implemented using various different types of handles including but not limited to horizontal handgrips, vertical handgrips, and/or any other type of handle or handgrip.

Clamp Actuator 408:

Clamp actuator 408 is formed of any suitable size, shape, and design and is configured to operably connect with and actuate clamp mechanism 412 to move handle assembly 18 forward and facilitate clamping of workpiece 22 between end stop assembly 16 and handle assembly 18.

In the arrangement shown, as one example, clamp actuator 408 is a lever configured to actuate clamp mechanism 412 through reciprocal back and forth movement. More specifically, in this example arrangement, clamp actuator 408 is a lever having a generally elongated curved shape extending downward from an upper end 470 attached to clamp mechanism 412, which is positioned within hollow interior 458 of main body 404, extending through one of the openings 464 of main body 404, and extending downward and forward from such opening 464 to a lower end 472. However, the embodiments are not so limited. Rather, it is contemplated that clamp actuator 408 may be straight, curved, have a greater or lesser angle, or be any other shape. Furthermore, it is contemplated that in one or more arrangements, clamp actuator 408 may be implemented using various means or methods including but not limited to, for example, levers, knobs, wheels, cranks, slider, or any other type of actuator.

Release Actuator 410:

Release actuator 410 is formed of any suitable size, shape, and design and is configured to operably connect with clamp mechanism 412 to facilitate releasing of clamp mechanism 412 so as to permit handle assembly 18 to be moved forward or backward along bar 14 by a user. In the arrangement shown, as one example, release actuator 410 is movable between a locked position and an unlocked position. In this example arrangement, release actuator 410 is a trigger type lever positioned forward of clamp actuator 408. More specifically, in this example arrangement, release actuator 410 is a trigger type lever having a generally elongated curved shape extending downward and forward from an upper end 480 operably connected to main body 404 to a lower end 482.

In this example arrangement, release actuator 410 is configured to be moved forward to a locked position by a spring or other bias member (not shown) in absence of an opposing force. When release actuator 410 is pulled rearward by a user to an unlocked position, release actuator 410 engages clamp mechanism 412 and causes clamp mechanism 412 to release from bar 14 so handle assembly 18 may be moved forward or backward along bar 14 by the user. However, the embodiments are not so limited. Rather, it is contemplated that release actuator 410 may be straight, curved, have a greater or lesser angle, or be any other shape. Furthermore, it is contemplated that in one or more arrangements, release actuator 410 may be implemented using various means or methods including but not limited to, for example, levers, knobs, wheels, cranks, slider, or any other type of actuator.

### Clamp Mechanism 412:

Clamp mechanism 412 is formed of any suitable size, shape, and design and is configured to be positioned within main body 404 of handle assembly 18 and cause handle assembly 18 to move forward along the length of bar 14 when clamp actuator 408 is engaged by a user. In this example arrangement, clamp mechanism 412 is configured to move handle assembly 18 forward along bar 14 when clamp actuator 408 is moved rearward by a user.

In this example arrangement, clamp mechanism 412 is configured to prevent handle assembly 18 from moving rearward when clamp actuator 408 is released by the user. In this example arrangement, clamp mechanism 412 includes a spring or other bias member (not shown) configured to move clamp actuator 408 forward when released by a user to facilitate repetitive actuation by a user for clamping of workpiece 22.

In this example arrangement, clamp mechanism 412 is also configured to disengage from bar 14 and permit handle assembly 18 to move freely forward or backward along bar 14 when release actuator 410 is moved by the user to the unlocked position. In this example arrangement, clamp mechanism 412 is also configured to reengage bar 14 when release actuator 410 is released by the user and moved to the locked position, and again prevent handle assembly 18 from moving rearward.

### In Operation:

In operation, bar clamp system 10 is used to clamp a workpiece 22 by positioning end stop assembly 16 and handle assembly 18 on bar 14 with clamping surface 60 of end stop assembly 16 and clamping surface 434 of handle assembly 18 facing towards one another. In this arrangement, one end of bar 14 extends through openings 110 of main body 50 of end stop assembly 16 and the other end of bar extends through openings 460 of main body 404 of handle assembly 18.

Workpiece 22 is then placed between clamping surface 60 of end stop assembly 16 and clamping surface 434 of handle assembly 18. If end stop assembly 16 and handle assembly 18 are too close together, end stop assembly 16 is moved forward by pressing button 334 of actuator 120 of locking assembly 54 of end stop assembly 16 to cause locking assembly 54 to disengage from bar 14 as previously described. With button 334 depressed, user may move end stop assembly 16 forward to increase the distance between clamping surface 60 and clamping surface 434. When button 334 is released, locking assembly 54 reengages bar 14 and prevents end stop assembly 16 from moving further forward. In this way, end stop assembly 16 is able to be adjusted to an infinite number of positions along the length of the bar 14.

Additionally or alternatively, user may move handle assembly 18 rearward by pulling release actuator 410 of handle assembly 18 rearward to cause clamp mechanism 412 to disengage from bar 14. With release actuator 410 pulled rearward, user may move handle assembly 18 rearward to increase the distance between clamping surface 60 and clamping surface 434. When release actuator 410 is released, clamp mechanism 412 reengages bar 14 and prevents handle assembly 18 from moving further rearward. In this way, handle assembly 18 is able to be adjusted to an infinite number of positions along the length of the bar 14.

Once end stop assembly 16 and handle assembly 18 are positioned far enough apart to accommodate workpiece 22, workpiece is placed between clamping surface 60 of end stop assembly 16 and clamping surface 434 of handle assembly 18. If desired, the user may move end stop assembly 16 rearward to close any gap between workpiece 22 and clamping surfaces 60 and 434 before clamping. As previously mentioned, in one or more arrangements, if lock pin 128 of first locking mechanism 116 of locking assembly 54 is not positioned to be engaged in a recess 40 of bar 14, end stop assembly 16 may be moved rearward without depressing button 334 of actuator 120 of locking assembly 54. Additionally or alternatively, in one or more arrangements, the user may move handle assembly 18 forward to close any gap between workpiece 22 and clamping surfaces 60 and 434 before clamping. As previously mentioned, in one or more arrangements, the user may move handle assembly 18 forward without pulling release actuator 410.

To initiate clamping, the user pulls clamp actuator 408 rearward, for example, by squeezing clamp actuator 408 and handle 406 together. Pulling clamp actuator 408 rearward causes clamp mechanism 412 to move handle assembly 18 forward along bar 14, thereby clamping workpiece 22 between clamping surface 60 of end stop assembly 16 and clamping surface 434 of handle assembly 18. The user can iteratively squeeze clamp actuator 408 and handle 406 together and release until a desired amount of pressure is applied from clamping surfaces 60 and 434 to workpiece 22.

In this example arrangement, to unclamp workpiece 22 from system 10, user can press button 334 of actuator 120 of locking assembly 54 to permit end stop assembly 16 to move forward and release forces applied to workpiece 22. In this example arrangement, workpiece 22 may additionally or alternatively be released from clamped system 10 by pulling release actuator 410 of handle assembly 18 rearward to permit handle assembly 18 to move rearward and release forces applied to workpiece 22.

### Spreader Configuration:

In one or more arrangements, end stop assembly 16 and/or handle assembly 18 may be removed from bar 14 and replaced back onto bar 14 with clamping surfaces 60 and 434 facing outward from each other to facilitate spreading. Operation of system 10 in a spreading configuration is similar to operation described with reference to clamping of workpiece 22 except the direction in which end stop assembly 16 can be moved without pressing and handle assembly 18 can be moved without pressing button 334 of actuator 120 of locking assembly 54 is reversed. Similarly, the direction in which handle assembly 18 can be moved without pulling release actuator 410 is reversed.

With system 10 in a spreading position, end stop assembly 16 and handle assembly 18 are placed between two portions of a workpiece 22 that are to be pushed apart. If end stop assembly 16 and handle assembly 18 are too far apart, button 334 of actuator 120 of locking assembly 54 may be pressed and end stop assembly 16 moved closer to handle assembly 18. Once button 334 is released, locking assembly 54 engages bar 14 and prevents end stop assembly 16 from moving any closer to handle assembly 18. In this way, end stop assembly 16 is able to be adjusted to an infinite number of positions along the length of the bar 14.

Additionally or alternatively, release actuator 410 of handle assembly 18 may be pulled and handle assembly 18 moved closer to end stop assembly 16. Once release actuator 410 is released, clamp mechanism 412 engages bar 14 and prevents handle assembly 18 from moving any closer to end stop assembly 16. In this way, handle assembly 18 is able to be adjusted to an infinite number of positions along the length of the bar 14.

Once end stop assembly 16 and handle assembly 18 are positioned between the portions of workpiece 22 that are to be pushed apart, the user may move end stop assembly 16 and/or handle assembly 18 away from each other, if desired before spreading, to close any gap between clamping surfaces 60 and 434 the portions of the workpiece 22 to be spread apart.

As described with reference to clamping, in one or more arrangements, if lock pin 128 of first locking mechanism 116 of locking assembly 54 is not positioned to be engaged in a recess 40 of bar 14, end stop assembly 16 may be moved away from handle assembly 18 without depressing button 334 of actuator 120 of locking assembly 54. Additionally or alternatively, in one or more arrangements, the user may move handle assembly 18 away from end stop assembly 16 to close any gap between workpiece 22 and clamping surfaces 60 and 434 before spreading. In one or more arrangements, the user may move handle assembly 18 away from end stop assembly 16 without pulling release actuator 410.

To initiate spreading, the user pulls clamp actuator 408 of handle assembly 18 toward handle 406, for example, by squeezing clamp actuator 408 and handle 406 together. Pulling clamp actuator 408 toward handle 406 causes clamp mechanism 412 to move handle assembly 18 along bar 14 further away from end stop assembly 16. In this manner, the two portions of workpiece 22 are spread apart. User can iteratively, squeeze clamp actuator 408 and handle 406 together and release until a desired amount of pressure is applied from clamping surfaces 60 and 434 to the portions of workpiece 22 that are being spread apart.

In this example arrangement, once spreading is no longer required, tension may be released from system 10, by pressing button 334 of actuator 120 of locking assembly 54, or by pulling release actuator 410 of handle assembly 18 rearward, to permit end stop assembly 16 and handle assembly 18 to move closer towards one another. End stop assembly 16 and handle assembly 18 may then be removed from in between the two portions of workpiece 22.

### Grip Pad(s) 34:

In one or more arrangements, clamp plate 46 of end stop assembly 16 and/or clamp plate 400 of handle assembly 18 are formed of a hard or rigid material (e.g., plastic, metal, and/or composite). This combination of using a hard or rigid plastic, metal, or composite material provides a strong, durable, and long lasting tool that can handle daily use and abuse without significant wear or damage. One drawback, however, of using a hard or rigid plastic, metal, or composite material for the clamp plates 46/400 or other components of system 10 is that these materials tend to have a low coefficient of friction. Or, said another way, when workpiece 22 is clamped between clamp plate 46 and clamp plate 400, there is a low amount of friction between clamp plates 46 and 400 and the workpiece 22. This means that the workpiece 22 may slide and change position during use. It is undesirable to have the workpiece 22 move during use. Such movement can cause damage to workpiece 22 and/or injury to a user.

In one or more arrangement, system 10 includes one or more grip pads 490 positioned on clamping surface 60 of clamp plate 46 and/or on clamping surface 434 of clamp plate 400. Grip pad(s) 490 are formed of a material that is more flexible and/or more compressible than the plastic, metal, or composite material that forms the clamp plates 46 and 400 and/or other component of system 10 on which grip pads 490 are positioned. Grip pads 490 are formed of any suitable size, shape, or design and of any material that that has a higher coefficient of friction than the material of the surface in which grip pads 490 are positioned upon, to facilitate improved grip of system 10 with surfaces of other workpiece 22 and/or other objects during use. In various arrangements, grip pad(s) 490 may be formed of various materials including but not limited to, for example, a rubber material, a natural rubber material, a synthetic rubber material, a silicone material, an isoprene rubber material, ethylene propylene diene (EPDM) material, a nitrile rubber (NBR) material, a styrene butadiene rubber (SBR) material, a silicone rubber material, a butyl rubber material, a isobutylene isoprene rubber material, a polybutadiene rubber material, a foam rubber material, any compressible or high coefficient of friction plastic material, or any other material that is more-compressible than and/or has a higher coefficient of friction than the rigid materials used to form other components of the system 10 that the grip pads 490 are attached to.

The enhanced grip of the grip pads 490 helps system 10 to better stay in place during use. The enhanced grip of the grip pads 490 helps to reduce the downward pressure a user must apply to system 10 to hold system in place on workpiece 12. The enhanced grip of the grip pads 490 helps to prevent marking (e.g., scrapes or scratches) of workpiece 12 when in use. It is hereby contemplated that system 10 may include grip pads 490 on any place or portion of system 10 that comes into contact with or could come into contact with workpiece 12 during use as is further described herein.

It is hereby contemplated that system 10 may additionally or alternatively include grip pads 490 on any place or portion of system 10 to aid in holding and use. For example, in one or more embodiments, system 10 may include one or more grip pads 490 on handle 406, clamp actuator 408, and/or release actuator 410 of handle assembly 18 to facilitate secure grip on the handle assembly 18 by a user during use.

### Removable Clamp Plate Cover 492:

In one or more arrangements, grip pad(s) 490 are positioned on removable clamp plate cover(s) 492. Removable clamp plate cover(s) 492 are formed of any suitable size, shape, and design and are configured to connect with and cover clamping surface 60 of clamp plate 46 of end stop assembly 16 and/or clamping surface 434 of clamp plate 400 of handle assembly 18. In the arrangement shown, as one example, removable clamp plate cover(s) 492 have a cover plate 494, having a generally planar shape similar to clamp plate 46/clamp plate 400, a top 496, a bottom 498, and opposing sides 500, forming a hollow interior 502 configured to receive clamp plate 46/clamp plate 400 therein.

In one or more arrangements, removable clamp plate cover(s) 492 include one or more connection features 504 to engage and secure clamp plate cover(s) 492 to clamp plate 46/clamp plate 400. In one example arrangement, connection features 504 include a lip 504 extending inward from an exterior edge of top 496, bottom 498, and opposing sides 500 of removable clamp plate cover(s) 492. In this example arrangement, the lip 504 fits over non-clamping surfaces at edges of clamp plate 46/clamp plate 400 and thereby holds removable clamp plate cover(s) 492 thereon.

In the arrangement show, cover plate 494 of removable clamp plate cover(s) 492 is formed of a flexible compressible material that operates as a grip pad 490. However, the embodiments are not so limited. Rather, it is contemplated that in one or more arrangements, cover plate may be formed of a rigid material having one or more grip pad 490 positioned thereon.

In the arrangement shown, cover plate 494 has an opening 506 to facilitate insertion of and holding of a connection assembly 516. In this example arrangement, opening 506 includes a circular opening 508 and two slits 510 extending outward from circular opening 508. The slits 510 permit portions of cover plate 494 proximate to circular opening 508 to flex and facilitate insertion of connection assembly 516 therethrough.

### Connection Assembly 516:

In one or more arrangements, system 10 may include one or more connection assembly 516. Connection assembly 516 is formed of any suitable size, shape, and design and is configured to facilitate the connection of one or more tools or components to clamping surface 60 and/or clamping surface 434. In an arrangement shown, as one example, connection assembly 516 may be used to connect a jig 518 (not shown) to clamping surface 60 and/or clamping surface 434 to facilitate drilling pocket holes in workpiece 22 that is clamped between clamping surfaces 60 and 434. However, embodiments are not so limited. Rather, it is contemplated that connection assembly 516 may be used to connect any useful tool or component to clamping surface 60 and/or clamping surface 434.

In the arrangement shown, as one example, connection assembly 516 is configured to be optionally connected to or removed from clamping surface 60 and/or clamping surface 434 as desired by a user. In this example arrangement, connection assembly 516 has a generally cylindrical shaft 526, a first connection feature 522 connected to one end of shaft 526 and a second connection feature 524 connected to the opposite end of shaft 526.

### First Connection Feature 522:

First connection feature 522 is formed of any suitable size, shape, and design and is configured to be inserted into and held within a first receiver 530 positioned within clamping surface 60 and/or clamping surface 434. In the arrangement shown, as one example, first connection feature 522 has a generally cylindrical shape having a diameter greater than the diameter of shaft 526. In this example arrangement, first connection feature 522 has a shape that is complementary to first receiver 530 and is configured to fit within first receiver 530 with close and tight tolerances. In this example arrangement, connection assembly 516 is configured to attach to cover plate 494 of removable clamp plate cover(s) 492, which holds first connection feature 522 within first receiver 530 when removable clamp plate cover(s) 492 is attached to clamp plate 46 of end stop assembly 16 and/or clamp plate 400 of handle assembly 18. However, the embodiments are not so limited. Rather, it is contemplated that in one or more arrangements, first connection feature 522 may be held within first receiver 530 using means and methods known in the art including but not limited to, for example, adhesive bonding, chemical bonding, welding, and/or mechanical attachment means such as frictional fitting, screws, bolts, threading, interlocks, clips, pins, or other coupling devices.

In this example arrangement, connection assembly 516 may be attached to cover plate 494 of removable clamp plate cover(s) 492 by inserting connection assembly 516 through opening 506 of cover plate 494 of removable clamp plate cover 492 as positioning edges of cover plate proximate to opening 506 between first connection feature 522 and second connection feature 524. More specifically, connection assembly 516 is positioned so that first connection feature 522 will be inserted into first receiver 530 when removable clamp plate cover(s) 492 is thereafter attached to clamp plate 46 of end stop assembly 16 and/or clamp plate 400 of handle assembly 18. In this position, second connection features 524 extends outward from cover plate 494 of removable clamp plate cover 492.

### Second Connection Feature 524:

Second connection feature 524 is formed of any suitable size, shape, and design and is configured to facilitate connection with a second receiver 512 (not shown) positioned within a surface of jig 518 or other tool or component. In this example arrangement, second connection feature 524 includes a standoff post 542 that extends outward a distance from the end of shaft 526 a distance and connects at its outward end to a foot 544. In the arrangement shown, as one example, foot 544 is a generally hexagonal shape when viewed from the end that extends outward to the side from standoff post 542. By foot 544 extending outward from standoff post 542 this facilitates locking to other components. As one example, foot 544 may be connected to a second receiver 532 (not shown) having a complementary shaped opening in jig 518, by inserting the foot 544 into the second receiver 532 and rotating the second receiver 532 relative to connection assembly 516 to cause foot 544 to engage an interior surface of jig proximate to the second receiver 532.

However, the embodiments are not so limited. Rather, it is contemplated that in one or more arrangements, second connection feature 524 may have any shape and be held within second receiver 532 using various means and methods known in the art including but not limited to, for example, adhesive bonding, chemical bonding, welding, and/or mechanical attachment means such as frictional fitting, screws, bolts, threading, interlocks, clips, pins, or other coupling devices.

### Storage Compartment 550:

In one or more arrangements, system includes a storage compartment 550. Storage compartment 550 is formed of any suitable size, shape, and design and is configured to provide a compartment for storage of connection assembly 516 when not in use. In the arrangement shown, as one example, storage compartment 550 is a recess formed in clamping surface 60 and/or clamping surface 434 that is sized and shaped to receive connection assembly 516. In this example arrangement, with connection assembly 516 inserted in storage compartment 550, storage compartment 550 is covered by removable clamp plate cover 492 to secure connection assembly 516 within storage compartment 550. However, the embodiments are not so limited. Rather, it is contemplated that, in one or more arrangements, storage compartment 550 may be positioned in anywhere on various components of system. Similarly, it is contemplated that, in one or more arrangements, connection assembly 516 may be held within storage compartment 550 using various means and methods known in the art including but not limited to, for example, adhesive bonding, chemical bonding, welding, and/or mechanical attachment means such as frictional fitting, screws, bolts, threading, interlocks, clips, pins, or other coupling devices.

### Alternate Arrangement(s):

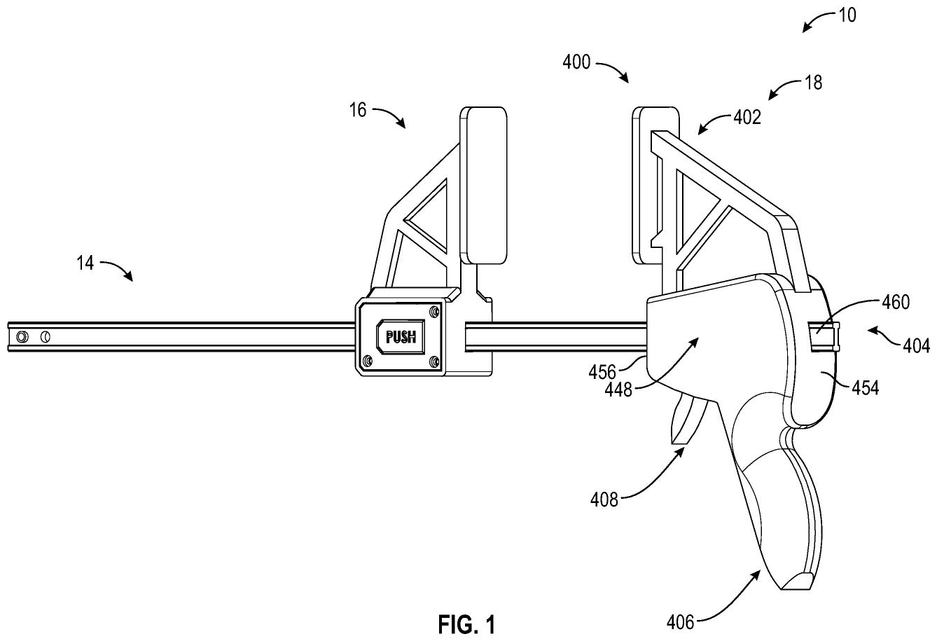

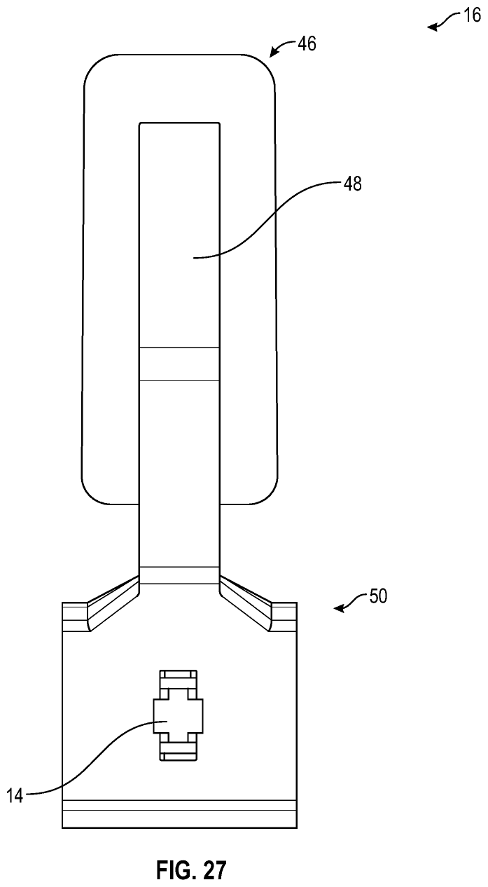

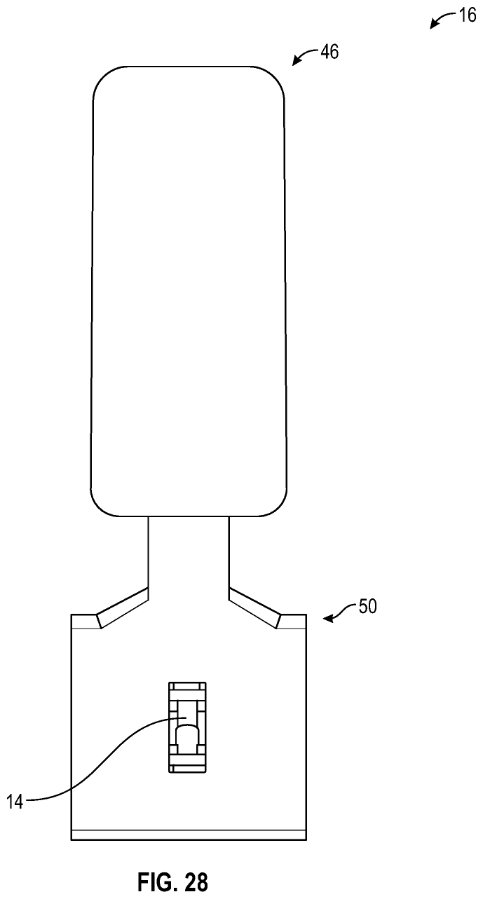

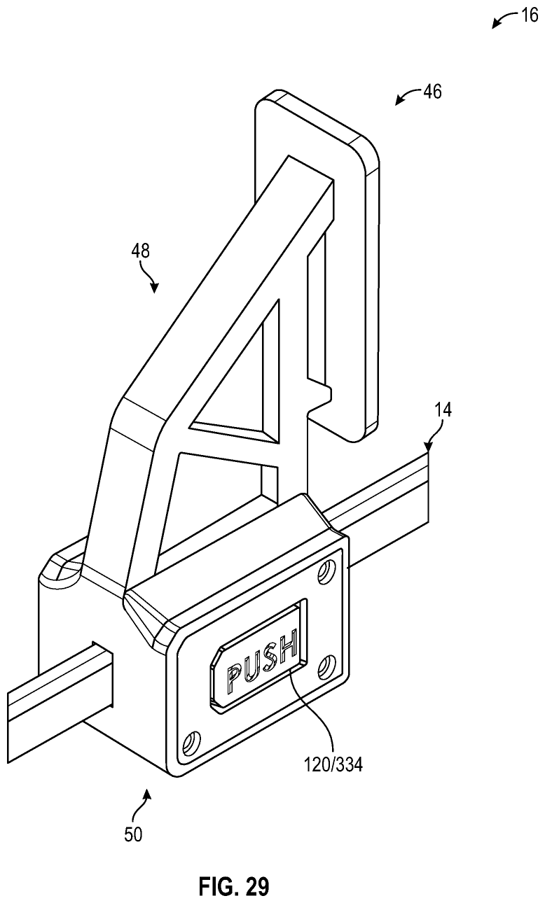

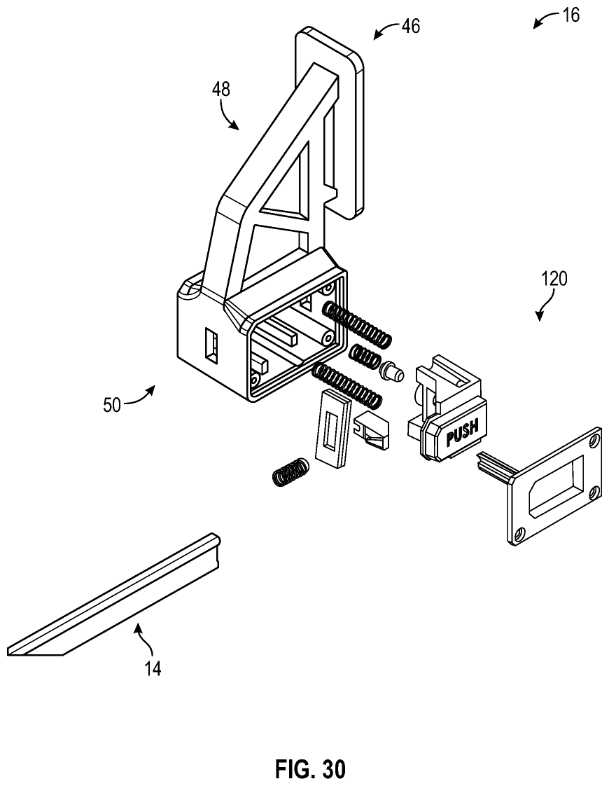

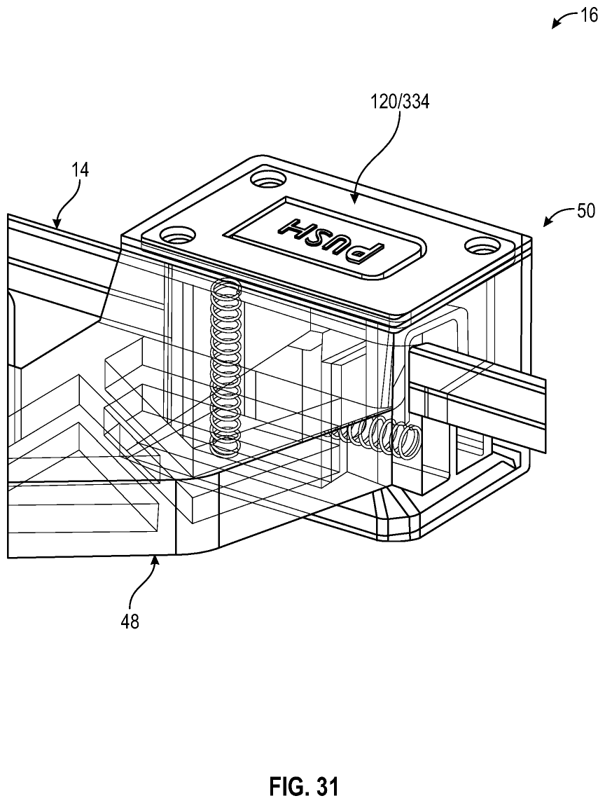

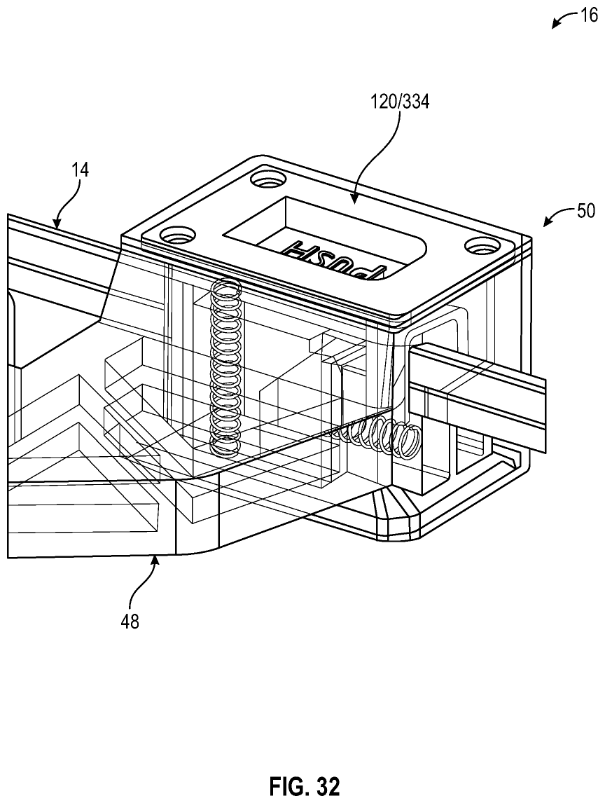

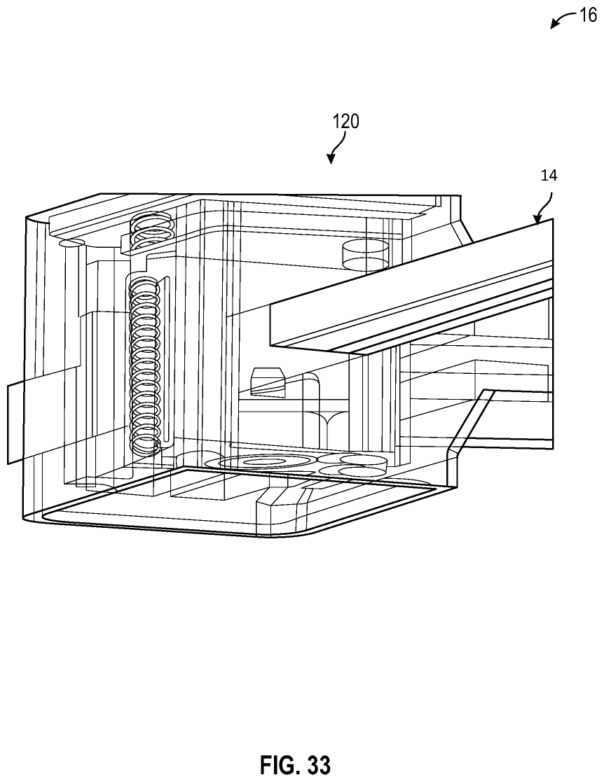

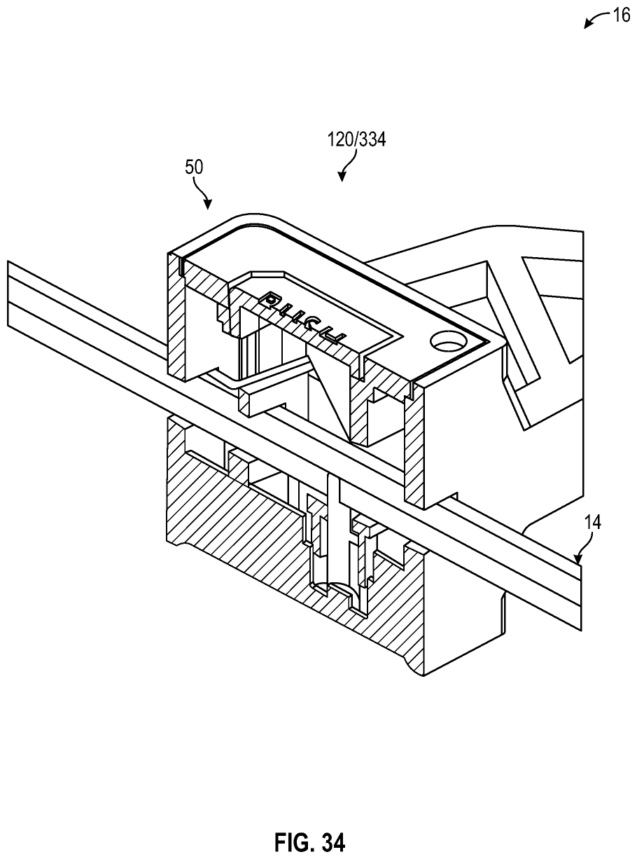

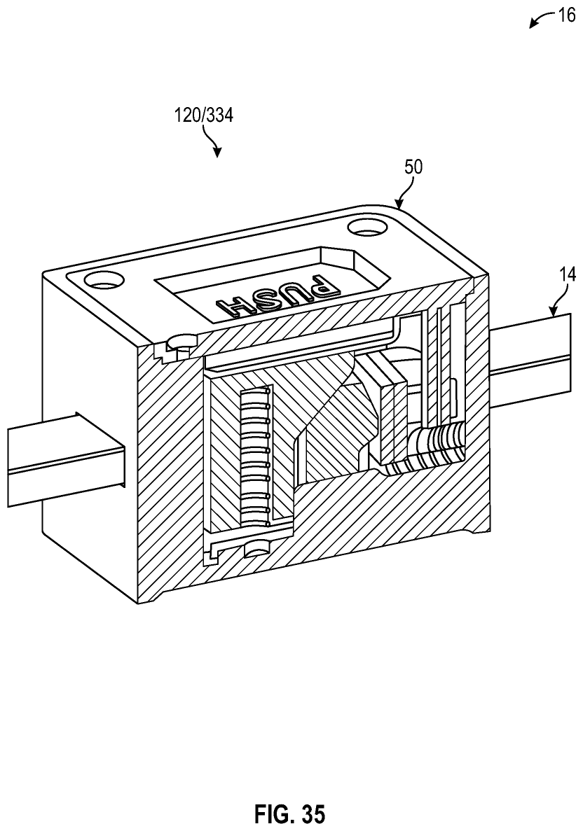

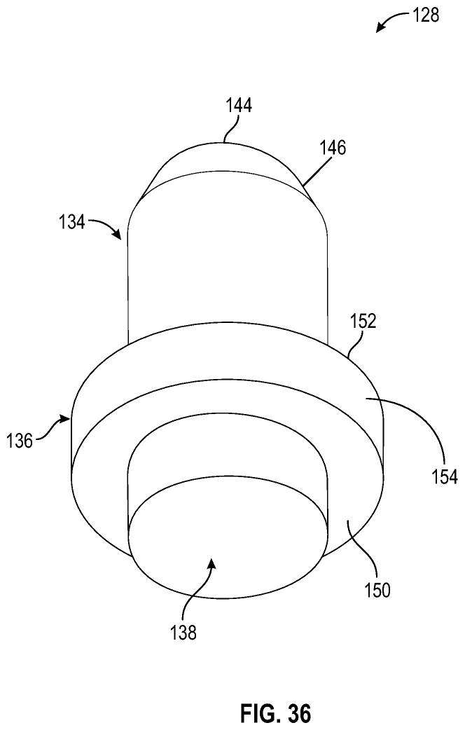

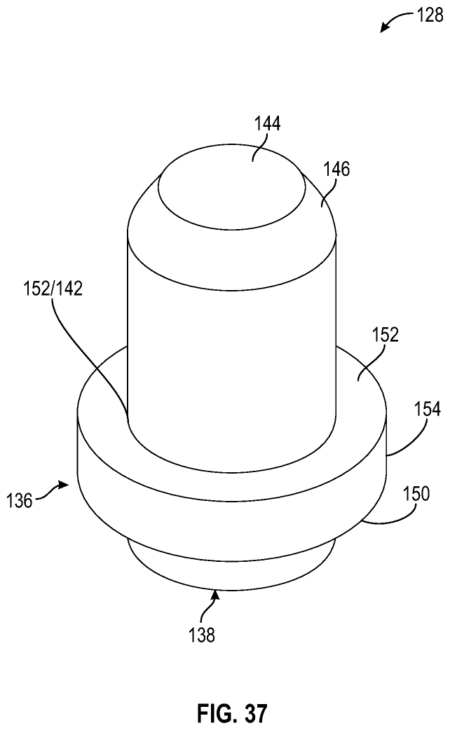

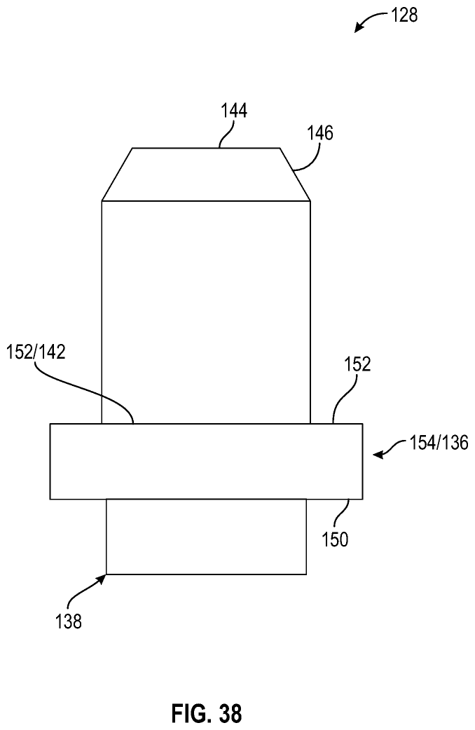

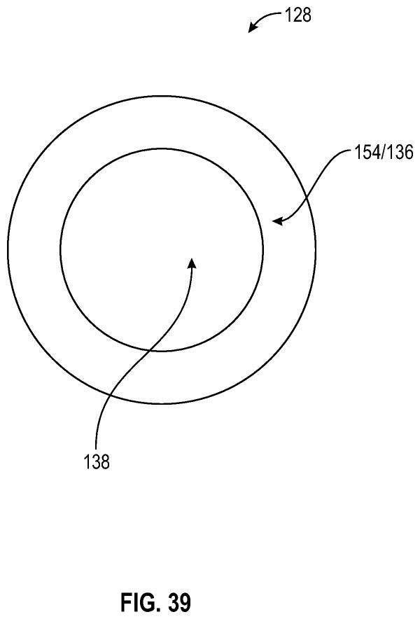

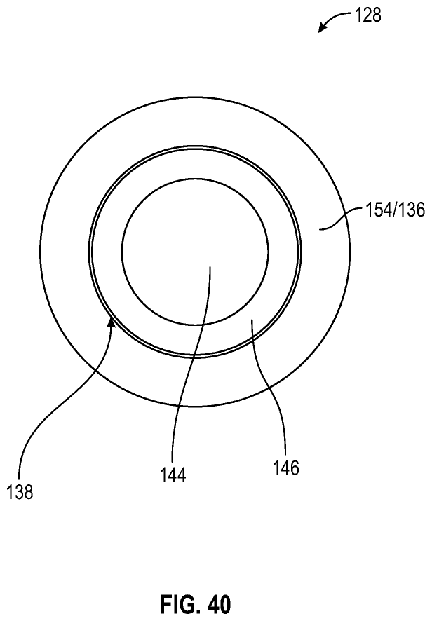

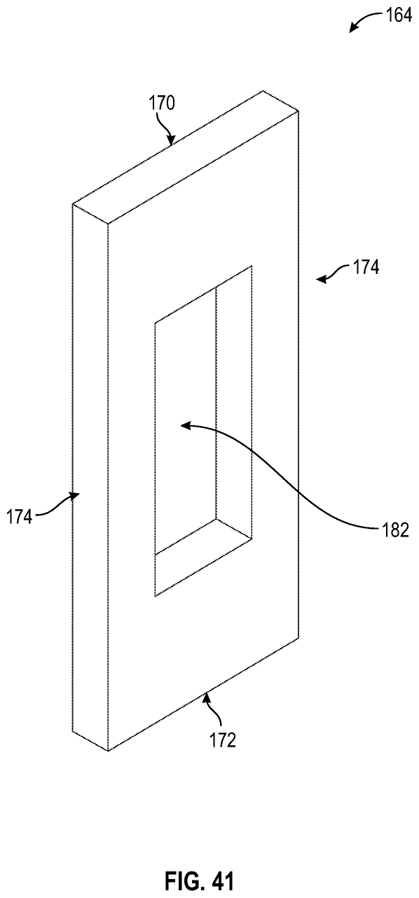

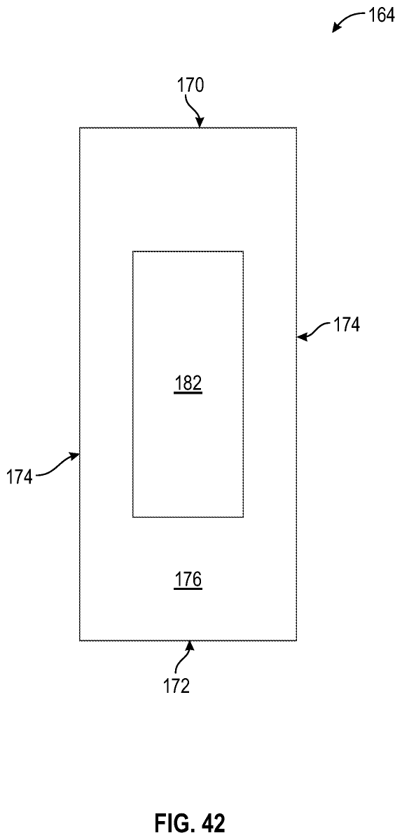

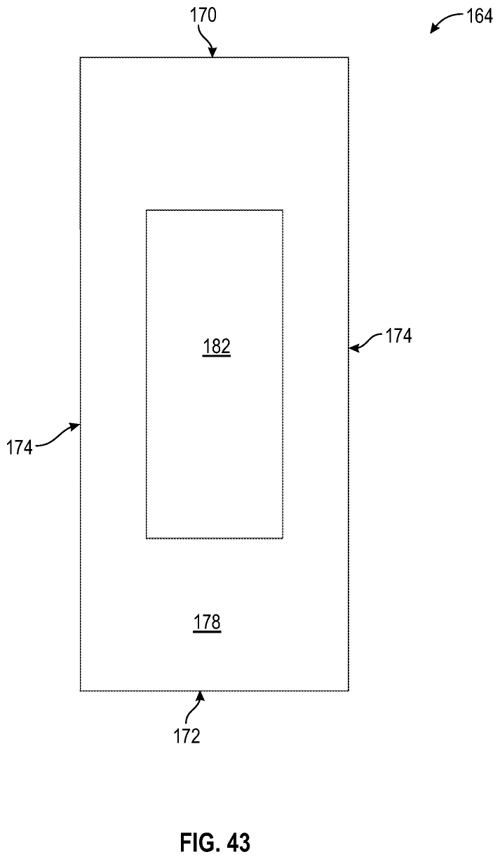

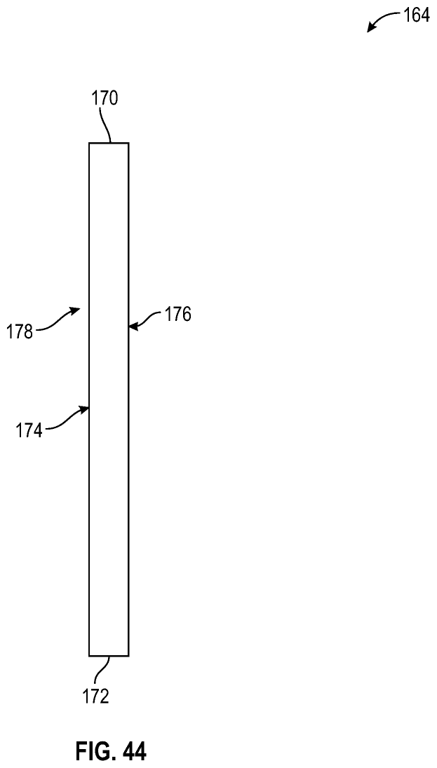

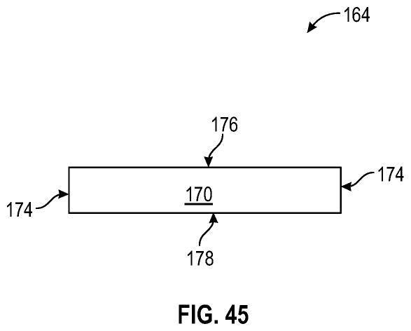

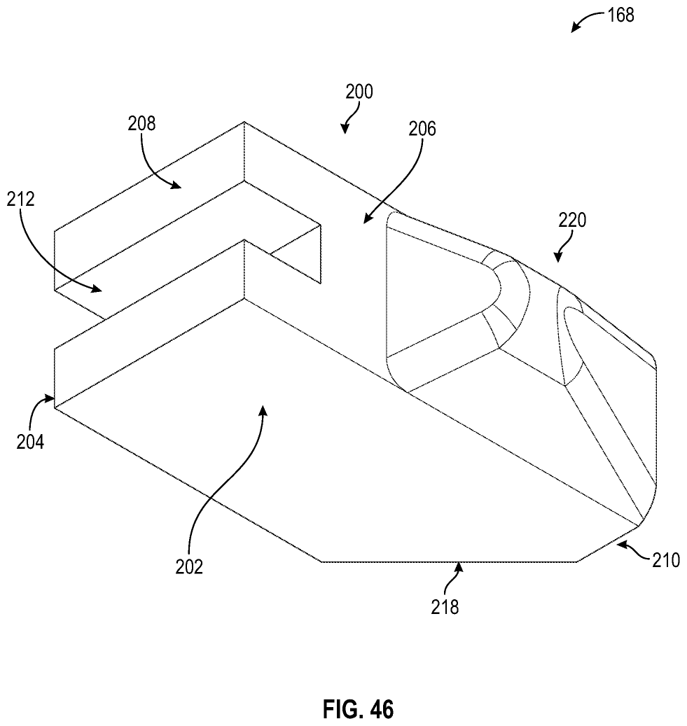

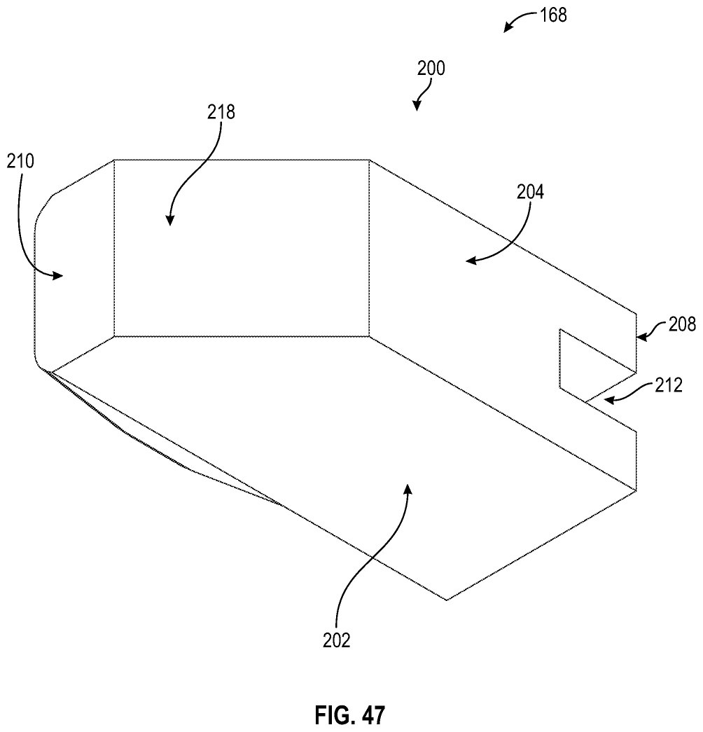

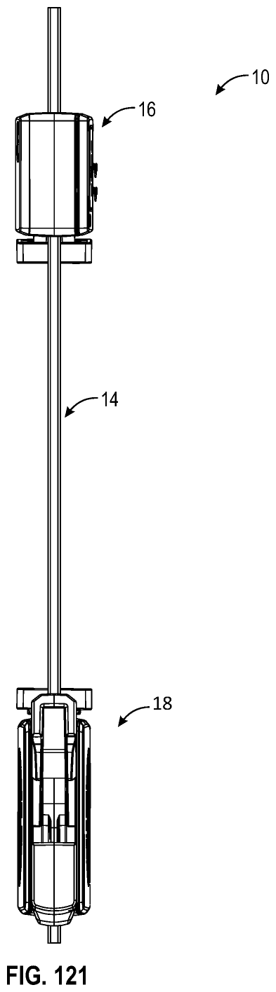

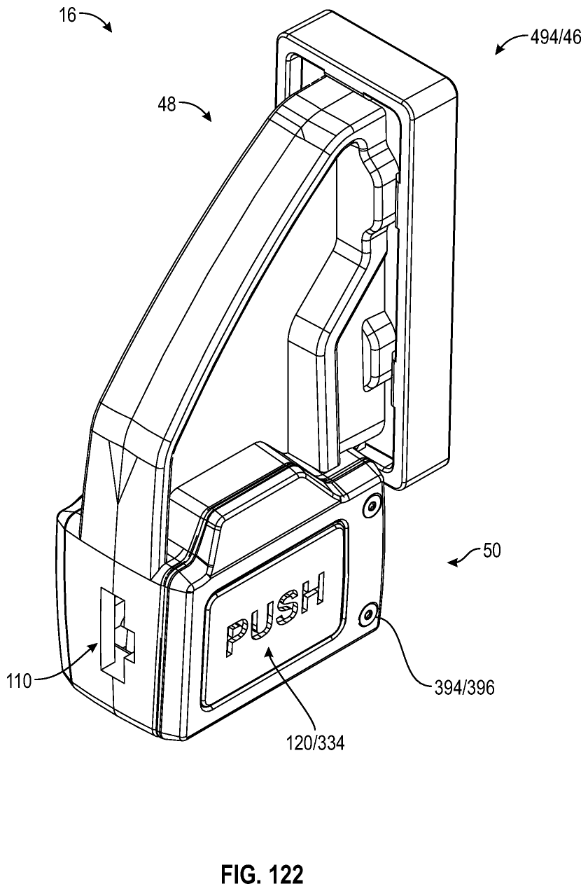

With reference to FIGS. 122-205 an alternative arrangement of system 10 is presented. The arrangement shown in FIGS. 122-205 is similar to the system 10 shown in FIGS. 1-121 and as such, the disclosure related to the embodiment shown in FIGS. 1-121 applies to the embodiment shown in FIGS. 27-47 unless stated specifically herein.

Differences in the arrangement shown in FIGS. 122-205 include the shape of button 334 of actuator 120 of end stop assembly 16, stop members 38 added to the bar 14, and the shape of openings 110 of main body 50 and opening 182 in clutch plates 164 of end stop assembly 16.

### Button 334:

Button 334 of actuator 120 is formed of any suitable size, shape, and design and is configured to facilitate movement of actuator 120 between the unlocked and locked positions by a user. In the arrangement shown in FIGS. 122-205, as one example, button 334 has generally rectangular shaped protrusion having front surface 356, rear surface 358, top surface 360, and bottom surface 362 extending outward from button-side sidewall 244 of inner portion 332 of actuator 120 to an outer side surface 366. In this example arrangement, button 334 is positioned within and extends through a similar shaped opening 380 of cover 52.

### Stop Members 38:

Stop members 38 are formed of any suitable size, shape, and design and are configured to prevent handle assembly 18 from being removed from bar 14 while permitting end stop assembly 16 to be removed from one end 36 of bar 14 and reattached on the other end of bar 14. Moving end stop assembly from one end 36 of bar 14 to the other, opposite, end 36 of bar 14 converts the system 10 from a clamp to a spreader. In the arrangement shown, as one example, stop members 38 are protrusions extending outward from one side 34 of bar 14 at each end 46. In this example arrangement, stop members 38 engage a portion of handle assembly 18, such as main body 404 and/or clamp mechanism 412, to prevent handle assembly 18 from being removed from bar 14. In this example arrangement, openings 110 of main body 50 and openings 182 in clutch plates 164 of end stop assembly 16 are shaped to avoid engaging stop members 38, thereby permitting end stop assembly 16 to be removed from bar 14.

### Main Body 50:

Main body 50 is formed of any suitable size, shape, and design and is configured to be movable along the length of bar 14 and selectably secure end stop assembly 16 in position along bar 14 to facilitate clamping of a workpiece 22. In the arrangement shown, as one example, main body 50 includes a top 96, a bottom 98, a back 100, a front 102, and a closed side 104, forming a hollow interior 106 accessible through an open side 108. In this example arrangement, back 100 and front 102 of main body 50 include openings 110. Openings 110 are formed of any suitable size, shape, and design and is configured to permit bar 14 and stop members 38 to be inserted through openings 110 and main body 50 to facilitate connection of main body 50 to bar 14. In the arrangement shown, as one example, openings 110 have a sideways T-shape that is similar to the shape of the bar 14 and stop members 38 when viewed from the ends 36 of bar 14. The sideways t-shape of openings 110 not only help to allow the first clamp arm assembly 16 and second clamp arm assembly 18 to be removed from the elongated bar 14, but also ensures that the user installs them onto the elongated bar 14 in the appropriate orientation.

### Clutch Plates 164:

Clutch plates 164 are formed of any suitable size, shape, and design and are configured to engage top 30 of bar 14 when moved to an angled locked position and disengage from top 30 of bar 14 when moved to a vertical unlocked position. In the arrangement shown, as one example, clutch plates 164 each have a generally rectangular planar shape having a front 178 and a back 176 extending between a top edge 170, a bottom edge 172, opposing side edges 174. In this example arrangement, clutch plates 164 each have an opening 182. Opening 182 is formed of any suitable size, shape, and design and is configured to permit bar 14 and stop members 38 to be inserted through opening 182, permit clutch plates 164 to slide along bar 14 when clutch plates 164 are in the vertical unlocked position, and inhibit clutch plates 164 from sliding forward along bar 14 when clutch plates 164 are in the angled locked position. In the arrangement shown, as one example, openings 110 have a sideways T-shape that is similar to the shape of the bar 14 and stop members 38 when viewed from the ends 36 of bar 14.

From the above discussion it will be appreciated that the presented bar clamp system improves upon the state of the art. Specifically, in one or more arrangements, a bar clamp system presented: that provides improved functionality over prior art clamps; that is easy to use; that is intuitive to use; that is strong and robust; that can be used in many applications; that provides unique functionality; that can be used as a spreader; that provides easy positioning of end stop and handle assemblies; that is safe to use; that is fast to use; that has a long useful life; that is high quality; that is relatively inexpensive; that improves efficiencies; that is fun to use; and/or that provides improved features over prior art clamps, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A clamp system, comprising:
an elongated bar;
the elongated bar extending a length between a first end and a second end;
an end stop assembly;
the end stop assembly operably connected to the elongated bar;
wherein the end stop assembly is movable along the length of the elongated bar;
wherein the end stop assembly includes an actuator;
wherein the actuator is movable between a locked position and an unlocked position;
wherein the end stop assembly includes a first locking mechanism;
wherein the first locking mechanism is configured to engage the elongated bar and secure the end stop assembly in position along the length of the elongated bar when the first locking mechanism is aligned with a recess in the elongated bar and the actuator is in the locked position;
wherein the end stop assembly includes a second locking mechanism;
wherein the second locking mechanism is configured to engage the elongated bar and inhibit movement of the end stop assembly along the elongated bar when the actuator is in the locked position;
wherein movement of the actuator to the unlocked position causes the first locking mechanism and second locking mechanism to permit the end stop assembly to move in either direction along the length of the elongated bar.

2. The system of claim 1, wherein the first locking mechanism includes a spring biased locking pin configured to insert into the recess of the elongated bar when the spring biased locking pin is aligned with the recess.

3. The system of claim 1, wherein when the first locking mechanism is engaged with the recess of the elongated bar, the first locking mechanism is configured to inhibit movement of the end stop assembly in a first direction along the length of the elongated bar as well as inhibit movement of the end stop assembly in a second direction along the length of the elongated bar, wherein the second direction is opposite the first direction.

4. The system of claim 1, wherein when the actuator is in the locked position, the second locking mechanism is configured to inhibit movement of the end stop assembly in a first direction along the length of the elongated bar and permit movement of the end stop assembly in a second direction along the length of the elongated bar; wherein the second direction is opposite the first direction.

5. The system of claim 1, wherein the second locking mechanism includes a set of clutch plates configured to inhibit movement of the end stop assembly in a first direction along the length of the elongated bar and permit movement of the end stop assembly in a second direction along the length of the elongated bar when the actuator is in the locked position.

6. The system of claim 1, wherein the actuator is a button.

7. The system of claim 1, wherein the actuator is a button;
wherein the button is moved to the unlocked position when pressed;
wherein the button is configured to move to the locked position when released.

8. The system of claim 1, wherein the end stop assembly includes:
a main body;
the main body having a hollow interior;
wherein the first locking mechanism, the second locking mechanism, and the actuator are positioned within the hollow interior of the main body;
a clamp plate;
a clamp arm;
the clamp arm operably connecting the clamp plate to the main body.

9. The system of claim 1, wherein the end stop assembly includes:
a main body;
the main body having a hollow interior;
wherein the first locking mechanism, the second locking mechanism, and the actuator are positioned within the hollow interior of the main body;
a clamp plate;
a clamp arm;
the clamp arm operably connecting the clamp plate to the main body;
the clamp plate having a clamping surface and a non-clamping surface;
wherein the clamp plate includes one or more grip pads positioned on the clamping surface.

10. The system of claim 1, wherein the end stop assembly includes:
a main body;
the main body having a hollow interior;
wherein the first locking mechanism, the second locking mechanism, and the actuator are positioned within the hollow interior of the main body;
a clamp plate;
a clamp arm;
the clamp arm operably connecting the clamp plate to the main body;
the clamp plate having a clamping surface and a non-clamping surface;
wherein the clamp plate includes one or more grip pads positioned on the clamping surface;
a removable clamp plate cover;
the removable clamp plate cover configured to connect with and cover the clamping surface of the clamp plate.

11. The system of claim 1, further comprising:
a handle assembly;
the handle assembly operably connected to the elongated bar;
wherein the handle assembly is movable along the length of the elongated bar;
the handle assembly having a clamp plate having a second clamping side and a second non-clamping side.

12. A clamp, comprising:
an end stop assembly;
a handle assembly;
an elongated bar;
wherein the end stop assembly and the handle assembly are operably connected to the elongated bar;
wherein the end stop assembly is removable from the elongated bar;
wherein the end stop assembly is movable along a length of the elongated bar;
wherein the handle assembly is movable along the length of the elongated bar;
wherein the end stop assembly and the handle assembly are capable of being connected to the elongated bar in a first configuration so as to facilitate clamping;
wherein the end stop assembly and the handle assembly are capable of being connected to the elongated bar in a second configuration so as to facilitate spreading.

13. The clamp of claim 12, further comprising:
a first stop member positioned at a first end of the elongated bar;
a second stop member positioned at a second end of the elongated bar;
wherein the first stop member and second stop member are configured to prevent the handle assembly from being removed from the elongated bar while permitting the end stop assembly to be removed from the elongated bar.

14. The clamp of claim 12, wherein the handle assembly includes an actuator and a clamp mechanism;
wherein the clamp mechanism is configured to move the handle assembly along the length of the elongated bar when the actuator is moved by a user.

15. The clamp of claim 12, wherein the handle assembly includes a clamp actuator, a release actuator, and a clamp mechanism;
wherein the clamp mechanism is configured to move the handle assembly along the length of the elongated bar in a first direction when the clamp actuator is moved by a user;
wherein the clamp mechanism is configured to prevent the handle assembly from moving in a second direction along the length of the elongated bar when the release actuator is in a first position;
wherein the second direction is opposite the first direction;
wherein the clamp mechanism is configured to permit the handle assembly to move in the first direction and second direction when the release actuator is in a second position.

16. The clamp of claim 12, wherein the end stop assembly includes an actuator, a first locking mechanism, and a second locking mechanism; wherein the actuator disengages the first locking mechanism and the second locking mechanism.

17. The clamp of claim 12, wherein the end stop assembly includes an actuator; wherein the actuator is a button.

18. The clamp of claim 12, wherein the end stop assembly includes an actuator, a first locking mechanism, and a second locking mechanism; wherein the first locking mechanism includes one or more clutch plates; and
the second locking mechanism includes a spring loaded pin.

19. The clamp of claim 12, wherein the end stop assembly includes an actuator, a first locking mechanism, and a second locking mechanism; wherein the first locking mechanism includes a spring biased locking pin configured to insert into a recess of the elongated bar when the spring biased locking pin is aligned with the recess.

20. The clamp of claim 12, wherein the end stop assembly includes an actuator, a first locking mechanism, and a second locking mechanism; wherein when the first locking mechanism is engaged with a recess of the elongated bar, the first locking mechanism is configured to inhibit movement of the end stop assembly in a first direction along the length of the elongated bar as well as inhibit movement of the end stop assembly in a second direction along the length of the elongated bar, wherein the second direction is opposite the first direction.

21. The clamp of claim 12, wherein the end stop assembly includes an actuator, a second locking mechanism, and a clamp mechanism;
wherein when the actuator is in a locked position, the second locking mechanism is configured to inhibit movement of the end stop assembly in a first direction along the length of the elongated bar and permit movement of the end stop assembly in a second direction along the length of the elongated bar;
wherein the second direction is opposite the first direction.

22. The clamp of claim 12, wherein the end stop assembly includes an actuator, a first locking mechanism, and a second locking mechanism; wherein the second locking mechanism includes a set of clutch plates configured to inhibit movement of the end stop assembly in a first direction along the length of the elongated bar and permit movement of the end stop assembly in a second direction along the length of the elongated bar when the actuator is in a locked position.

23. A clamp, comprising:
an end stop assembly;
a handle assembly;
wherein the end stop assembly has a first clamp plate;
wherein the first clamp plate of the end stop assembly has a first recess;
wherein the first recess is configured to store a connector assembly;
wherein the first clamp plate of the end stop assembly has a second recess;
wherein the second recess is configured to receive the connector assembly;
wherein the connector assembly is configured to connect to the second recess and to connect to a pocket hole jig assembly thereby connecting the pocket hole jig assembly to the clamp.

24. The clamp of claim 23, further comprising a removable clamp plate cover configure to connect with and cover the first clamp plate.

25. The clamp of claim 23, further comprising a removable clamp plate cover configure to connect with and cover the first clamp plate;
wherein the removable clamp plate cover includes one or more grip pads positioned on an outward facing surface.

26. The clamp of claim 23, wherein the connector assembly includes a first connection feature configured to be inserted into and held within the first recess.

27. The clamp of claim 23, further comprising a removable clamp plate cover configured to connect with and cover the first clamp plate;
wherein the connector assembly includes a first connection feature configured to be inserted into and held within the first recess;
wherein the connector assembly extends through an opening in the removable clamp plate cover;
wherein the connector assembly includes a second connection feature configured to connect with a jig assembly.

28. The system of claim 23, wherein the end stop assembly includes:
a main body, an actuator, and a locking assembly;
the main body having a hollow interior;
wherein the locking assembly and the actuator are positioned within the hollow interior of the main body;
a clamp arm;
the clamp arm operably connecting the first clamp plate to the main body.

29. The system of claim 23, further comprising:
an elongated bar;
the handle assembly operably connected to the elongated bar;
wherein the handle assembly is movable along a length of the elongated bar;
the handle assembly having a clamp plate having a second clamping side and a second non-clamping side.

30. A clamp system, comprising:
an elongated bar;
an end stop assembly operably connected to the elongated bar;
the end stop assembly having an actuator;
the end stop assembly having a first locking mechanism;
the end stop assembly having a second locking mechanism:
a handle assembly operably connected to the elongated bar;
wherein when the actuator is in a locked position the first locking mechanism of end stop assembly allows movement in a first direction and inhibits movement in a second direction;
wherein when the actuator is in the locked position, the second locking mechanism of the end stop assembly is configured to secure the end stop assembly in position along a length of the elongated bar when the first locking mechanism is aligned with a recess in the elongated bar.

31. The system of claim 30, wherein the first locking mechanism includes a spring biased locking pin configured to insert into the recess of the elongated bar when the spring biased locking pin is aligned with the recess.

32. The system of claim 30, wherein the second locking mechanism includes a set of clutch plates configured to inhibit movement of the end stop assembly in a first direction along the length of the elongated bar and permit movement of the end stop assembly in a second direction along the length of the elongated bar when the actuator is in the locked position.

33. The system of claim 30, wherein when the actuator is in an unlocked position the actuator disengages the first locking mechanism and the second locking mechanism.

34. The system of claim 30, wherein the actuator is a button.

35. The system of claim 30, wherein the actuator is a button;
wherein the button is moved to an unlocked position when pressed;
wherein the button is configured to move to the locked position when released.

36. The system of claim 30, wherein the end stop assembly includes:
a main body;
the main body having a hollow interior;
wherein the first locking mechanism, the second locking mechanism, and the actuator are positioned within the hollow interior of the main body;
a clamp plate;
a clamp arm;
the clamp arm operably connecting the clamp plate to the main body.

37. The system of claim 30, wherein the end stop assembly includes:
a main body;
the main body having a hollow interior;
wherein the first locking mechanism, the second locking mechanism, and the actuator are positioned within the hollow interior of the main body;
a clamp plate;
a clamp arm;
the clamp arm operably connecting the clamp plate to the main body;
the clamp plate having a clamping surface and a non-clamping surface;
wherein the clamp plate includes one or more grip pads positioned on the clamping surface.

38. The system of claim 30, wherein the end stop assembly includes:
a main body;
the main body having a hollow interior;
wherein the first locking mechanism, the second locking mechanism, and the actuator are positioned within the hollow interior of the main body;
a clamp plate;
a clamp arm;
the clamp arm operably connecting the clamp plate to the main body;
the clamp plate having a clamping surface and a non-clamping surface;
wherein the clamp plate includes one or more grip pads positioned on the clamping surface;
a removable clamp plate cover;
the removable clamp plate cover configured to connect with and cover the clamping surface of clamp plate.

39. The system of claim 30, further comprising:
a handle assembly;
the handle assembly operably connected to the elongated bar;
wherein the handle assembly is movable along the length of the elongated bar;
the handle assembly having a clamp plate having a second clamping side and a second non-clamping side.

40. A clamp system, comprising:
an elongated bar;
a handle assembly;
the handle assembly operably connected to the elongated bar;
an end stop assembly;
the end stop assembly operably connected to the elongated bar;
wherein the clamp system is reversible between a clamping configuration and a spreading configuration;
wherein when in the clamping configuration the handle assembly and the end stop assembly are adjustable to an infinite number of positions along the elongated bar;
wherein when in the spreading configuration the handle assembly and the end stop assembly are adjustable to an infinite number of positions along the elongated bar;
the end stop assembly having an actuator;
the end stop assembly having a first locking mechanism;
the end stop assembly having a second locking mechanism:
a handle assembly operably connected to the elongated bar;
wherein when the actuator is in a locked position the first locking mechanism of end stop assembly allows movement in a first direction and inhibits movement in a second direction;
wherein when the actuator is in the locked position, the second locking mechanism of the end stop assembly is configured to secure the end stop assembly in position along a length of the elongated bar when the first locking mechanism is aligned with a recess in the elongated bar.
